(19) United States
(12) Patent Application Publication
(10) Pub. No.: US 2025/0229457 A1
(43) Pub. Date: Jul. 17, 2025

(54) RAPID WAFERING OF WIDE BANDGAP SUBSTRATES

(71) Applicant: John Farah, Attleboro, MA (US)

(72) Inventor: John Farah, Attleboro, MA (US)

(21) Appl. No.: 18/919,632

(22) Filed: Oct. 18, 2024

Related U.S. Application Data
(60) Provisional application No. 63/591,195, filed on Oct. 18, 2023.

(51) Int. Cl. B28D 5/00

(52) U.S. Cl. CPC B28D 5/0023; B28D 5/0052

(57) ABSTRACT

This invention concerns cleaving of silicon carbide (SiC) wafers from boule to reduce the cost of manufacturing SiC substrates. We use Vickers diamond tips to initiate a crack, similar to a hardness tester, and a chisel type wedge to drive the crack at a depth of 500 micron. We use the same machine to initiate and propagate the crack. We do not use either a wire saw or a laser or ion implantation to transfer a layer. We prevent the crack from deviating from its plane and we reduce the consumption of diamond and extend the lifetime of Vickers indenters while machining SiC under high load. The rate of diamond consumption is on par or even less than the multi-wire saw. We use parallel indentation in conjunction with fast motors and actuators to speed up the cleavage process and increase the throughput which makes it competitive with the multi-wire saw.

### RELATED APPLICATION

This application claims priority under 35 U.S.C. § 119 (e) to provisional Application Ser. No. 63/591,195 filed on Oct. 18, 2023, which is herein incorporated by reference in its entirety.

### STATEMENT REGARDING FEDERALLY SPONSORED R&D

This invention was partially made with government support under contract #HQ0860-22-C-7828 awarded by the Missile Defense Agency (MDA). The government has certain rights in the invention.

### BACKGROUND OF THE INVENTION

### Field of the Invention

The present invention relates to a method for producing wafers or substrates or layers of solid materials, particularly semiconductor materials, such as ceramics, from boule or ingot or puck by fracturing. A non-abrasive technique for rapid wafering of crystals is described. The technology applies to all crystalline materials, particularly wide bandgap substrates, including SiC (of all polytypes), GaN, AlN, sapphire, oxides, and diamond among others. The instant invention also concerns designs for a fracture machine. The method for reducing diamond consumption while machining SiC under high load was done under government support, but the design of the fracture machine was done at private expense.

The biggest problem in semiconductor wafer manufacturing today is that up to 50% of the usable ingot material is lost as kerf during slicing. Also the time it takes to slice the ingot to wafers is too long. The majority of this loss occurs during wire sawing. In spite of all the advances in device miniaturization, the basic process of cutting the wafer from ingot still uses very outdated technology: sawing. And the problem gets worse as the wafers become thinner.

Wide bandgap single crystal ceramics are very hard to machine, expensive and are not produced in large quantities. More than 50% of the material is wasted as dust during the slicing and planarizing operation. A significant fraction of this cost is due to kerfloss, wafering time and consumables. There is a need to save materials, especially wide bandgap materials.

Wafers are sliced today using wire saws. These are heavy and bulky machines that weigh over a ton and cost almost a million dollars apiece. A semiconductor ingot is pushed through the wire mesh. There are several problems associated with this approach: first, it takes up to a week to cut a 6″ diameter wafer due to their hardness. Second, the diamond wire, which is consumable, is also expensive and must be replaced often because it affects the uniformity of the cut. Therefore, the current cost categories are:
Waste of expensive materials
CAPEX (expensive equipment)
Consumables (diamond wire or slurry and pure water)
Time of wafering which incurs other costs, e.g. labor, overhead, energy consumption, slurry, etc.

Thus, our goal is to replace wire sawing with a non-abrasive wafering technique, especially for expensive wide bandgap crystals.

Currently about 500 μm of material is lost in the process of making a 500 μm wafer, hence 50% loss, as shown in FIG. 1A. The wire diameter is actually 150-250 μm, however, the crystallinity of about 100 μm of material on each side of the wire is damaged due to the force of abrasion, which makes it unsuitable for fabricating high quality devices. This material must be ground away, hence the high kerf loss.

The bare SiC wafer accounts for about ⅓ to ½ of the cost of the final SiC device. By contrast, Si substrates account for only 5-7% of the cost of the power device.

### Measurement of Fracture Toughness

Cleavage is routinely used for the measurement of fracture toughness (K_{Ic}) of ceramics using a double cantilever beam specimen. A sharp notch is first created either by indentation or compression, and then the crack is propagated using three or four point bending. K_{Ic} is calculated from knowledge of the maximum force Pₘₐₓ needed to propagate the crack and the initial crack length a₀, both of which are measured quantities. This procedure is described in standard ASTM C1421. The advantage of this technique is that it allows the use of small-sized specimens and low-power test machines, and does not require initiation of a crack by fatigue. However, measurement of the pre-crack is difficult and prone to error and can only be done destructively after the piece is fractured. This leads to significant error in K_{Ic} mainly due to the inaccuracy in the measurement of the initial crack length a₀. However, the major difference between the instant wafering technique and the measurement of K_{Ic} is that they do not require nearly as much control over the propagation of the crack as we do. In fact, according to the standard (page 11, section A2.3.6 and FIG. A2.5) the crack can deviate up to 5°-10° from the notch plane and still yield accurate readings of K_{Ic}. By contrast our requirements are a lot more stringent. We need at least two orders of magnitude higher accuracy on the cleavage plane, 0.03° corresponding to a deviation of 50 μm over 4″ radius.

### Chevron Notch

A more accurate way of measuring K_{Ic} which is also described in ASTM C1421 is the use of a chevron notch because it does not require a pre-crack. Two notches are made in a block with a diamond blade saw that intersect at a sharp angle, typically 30-50°, to form an apex inside the material, as shown in FIG. 2A and FIG. 2B. The chevron does not require pre-cracking due to the extremely high stress concentration at the apex. A crack initiates at the apex under low load and grows in a series of short, stable spurts. The main advantage of the chevron is that it obviates the need to measure pre-crack length which is a major source of error in the determination of K_{Ic}.

We cleaved a block of poly-crystalline SiC measuring 30 mm×16 mm×16 mm along the central plane by applying a wedge to the chevron notch without pre-cracking, as shown in FIG. 2C and FIG. 2D. The chevron wastes more than 50% of the surface material (area of the V is <50% of the rectangle in FIG. 3A and FIG. 3B). This is not acceptable for wafering of SiC materials. The goal is to save material. We would like to obtain the benefits of the chevron without wasting so much material. It is desired to reduce the material loss to less than 10%.

### Crack Deviation

In general, the slower the crack the more controllable it is. An unstable crack propagates at very high speed (close to the speed of the Rayleigh wave, on the order of several Km/sec in hard materials) and may bifurcate or deviate from its intended path. It is necessary to slow down the crack by several orders of magnitude to control it. The crack can be driven either under controlled load or controlled displacement. Under a constant load the crack accelerates which leads to instability and catastrophic failure. The load must decrease as the crack propagates in order to decelerate the crack. This is the key to maintaining stability. FIG. 4A and FIG. 4B show examples of cracks in poly-crystalline ceramic materials that started horizontally then branched vertically under constant load.

### SUMMARY OF THE INVENTION

The instant invention concerns a non-abrasive technique for rapid wafering of crystals which are the backbone of the semiconductor industry. The technology applies to all crystalline materials, particularly wide bandgap substrates, SiC, GaN, AlN and diamond. A crack is driven parallel to the surface at a depth, typically 500 μm, to separate a wafer from a boule. Cracks are driven sequentially at the desired locations to slice the entire boule, as illustrated in FIG. 1B. We slice the crystal without sawing it. The cleaved surface has a roughness less than 50 μm, which is less than the diameter of the wire that it replaces. About 90% of the crystal that would have been lost is saved. The kerf is reduced dramatically and the throughput is doubled, i.e. twice as many wafers are obtained from the same amount of material. Furthermore, unlike wire sawing, crack propagation does not create subsurface damage. This will reduce the amount of material that needs to be removed post-cleavage to planarize the surface and make it epi-ready.

However, the highest impact is the dramatic reduction of the time it takes to wafer the boule. A stable crack propagates through solid materials at a speed of about 1 mm/sec. An entire ingot can be sliced in a few hours compared to one week with current technology. Thus, the present invention reduces all 4 types of losses that increase the costs: waste of materials, CAPEX, consumables, and time of wafering. This will have a significant impact on the bottom line of the crystal grower/wafer manufacturer because it reduces their entire cost structure.

This novel Rapid Wafering technique will save tens of millions of dollars for the semiconductor wafer manufacturer, as it will reduce the number and size of the cutting stations without impeding wafer production, and result in substantial savings in CAPEX, overhead, labor, maintenance, energy consumption, consumables, slurry, etc. This technology will replace the wire saw with a table top fracture machine which occupies 26× less area, 90× less volume, weighs 10× less and costs half the price of the wire saw.

The instant technique is very simple, does not require much capital investment or tooling. It can be done in a machine shop. The process can be automated and scaled up to process hundreds of boules simultaneously.

### Results

A SiC substrate originally 1 mm thick shown in FIG. 5A was split in two pieces 0.5 mm thick each without losing any material, as shown in FIG. 5B and FIG. 5C. This is standard thickness in the semiconductor industry. At this thickness the wafers need only minimal lapping and polishing to make the surface epi-ready. A split SiC substrate of arbitrary shape, area about 2 cm² is shown in FIG. 6. Similarly, a GaN substrate about 1 mm thick shown in FIG. 7A was split in two, as shown in FIG. 7B.

The challenge is preventing the crack from turning sideways and going vertical. The goal is to control the cleavage across 6″ or 8″ diameter wafers to reduce surface roughness and avoid breaking the wafers. The cleaved surface is very smooth with height variations on the order of 50 μm. FIG. 6 shows on millimetric paper the cleaved surfaces of two SiC pieces 0.5 mm thick each as mirror images that were split from a piece with arbitrary shape originally 1 mm thick. The two dark lines seen in the piece to the right of the picture are not in the cleaved surface, because if they were then they would appear in the piece to the left as well. These lines are on the unpolished backside but can be seen because SiC is transparent. We are able to cleave SiC and GaN substrates of arbitrary shape and size. More importantly, the original surface does not have to be prepared in any way (i.e. polished) prior to cleavage, unlike other technique such as laser slicing.

We have also cleaved Si (111) substrates of different shapes and sizes up to 4″ diameter, as shown in FIG. 8.

### Smoothness of Cleaved Surface

The cleaved surface has a smooth edge with ±5 μm height variation and Peak-to-Valley of about 50 μm, as shown in the DekTak traces in FIG. 9. The cleaved surface needs planarization and CMP to make it epi-ready. The image of the hand taking the picture in FIG. 8 can be seen in reflection.

The cleaved surface is almost atomically smooth for on-axis grown crystals. For crystals that are grown 4° off-axis, the roughness is less than 50 μm which is much less than the kerf of the wire that it will replace.

### Cathodoluminescence and Raman Spectroscopy of 4H SiC

The cleavage does not create sub-surface damage as demonstrated by cathodoluminescence (CL) and Raman spectroscopy. CL and Raman spectroscopy were measured on cleaved SiC samples using a cooled stage at 77K with energy of 20 keV having a penetration depth of 1.2 μm and compared to a reference polished state-of-the-art SiC sample from Cree. The results are plotted in FIG. 10 and FIG. 11. The width of the E₂(TO) Raman peak of the cleaved sample is narrower than the polished sample (FIG. 10), which accounts for lower surface damage, and the intensity of the CL spectrum of the cleaved sample is higher than the polished sample (FIG. 11), which indicates that the cleaved sample has fewer non-radiative recombination centers compared to the polished sample. Furthermore, the cleavage does not alter the shape of the CL spectrum, which implies that it does not create optically active defects or subsurface damage. These results were confirmed using X-ray topography, which indicates that the cleavage does not generate dislocations. This will reduce the amount of chemical and mechanical polishing needed post-cleavage to make the surface epi-ready.

### Approach

The basis of fracture mechanics is a sharp crack. The deeper the crack the less force it takes to propagate it. This is obtained by indenting with a sharp diamond tip, such as Vickers or Knoop. FIG. 12 shows a Vickers indentation in SiC under a load of 5N. A median crack about 20 μm wide and deep is obtained along each diagonal. The crack can be extended along crystallographic directions by indenting at several locations in close proximity to each other to link the cracks. It is possible to suppress the crack in any crystallographic direction and enhance the crack in the orthogonal direction by choosing the right distance between indentations, as shown in FIG. 13. A wedge is applied to the crack line to propagate the crack. The concept is illustrated schematically in FIG. 14A which shows a bar of semiconductor material indented along the top edge, as an example. The goal is to create a crack about 250-300 μm deep across the short edge of a SiC bar by indenting the top edge with Vickers in a line, as shown schematically in FIG. 14B. This will require a load up to 200N or 300N. The size of the crack C grows as the load P to the power ⅔, a=6.96 P^{2/3} for SiC where a is in μm and P is in N. This yields a spacing between indents of 500 μm corresponding to a load of 200N. The higher the force the deeper the crack. The goal is to apply the largest force possible while avoiding excessive chipping and lateral cracks at the surface. Creating the sharp crack by indenting the surface is more advantageous than notching because it saves materials.

The crack must start from a sharp indentation. There is an inverse relationship between the load that creates the crack and the load that drives it. The higher the force that creates the crack and the bigger and deeper the pre-crack a, the smaller is the load needed to propagate it.

It is desired to propagate the crack in the middle plane. Symmetry is essential. The wedge must be kept in perfect alignment with the center line of the notch opening to ensure that equal loads are applied on each side.

If the wedge is driven at a constant speed and the force is adjusted accordingly (P˜1/a) to maintain the energy release rate G constant at the critical energy release rate G_{c} equal to twice the surface energy γ, (G_{c}=2γ), then stable crack propagation is obtained. The extension of the crack a can be controlled through the displacement of the wedge. This yields a stable crack.

### Sharp Notch

The schematic in FIG. 15 shows a notch with opposite forces (red arrows) acting on the mouth of the notch to propagate the crack and separate the wafers. These represent the forces that a wedge would apply. However, this requires that the tip of the notch be atomically sharp. It is desired to make the notch as small as possible in order to minimize the waste of material. For example, the notch can be cut about 100 μm wide by 500 μm deep with a diamond disk blade. However, if the tip of the notch is not made sharp on an atomic scale, then the crack will not follow a horizontal path; rather, it will deviate and follow a vertical path of least resistance due to T-stress, and will break the lips of the notch instead of separating the wafers, as shown in FIG. 16. The challenge is making the tip of the notch sharp because the tip cannot be reached through the mouth with a sharp tool. There is no advantage to notching. A notch is not used. Instead, the surface is indented directly. Driving the crack under displacement control with a wedge slows down the crack from Km/see to mm/sec. This is key to controlling the path of the crack and obtaining a smooth cleaved surface.

### T-Stress

The force P acting on a double cantilever in the diagram of FIG. 17 creates the decaying vertical stresses σ_{yy} acting on the tip of the crack, which are responsible for opening of the crack, and at the same time the so-called tangential bending stresses, or T-stress, σ_{T} which act in a direction parallel to the the crack (Cotterell and Rice 1980). The T-stress, σ_{T}=σₓₓ causes the crack to branch off and propagate vertically rather than horizontally to separate the wafers. Expressions for the stress intensity factor K_{I} and σ_{T} are given in FIG. 17 in terms of the dimensions of the cantilevers, where a is the length of the crack, and B is the thickness of the double cantilever, i.e. the thickness of the boule. σ_{T} is proportional to K_{I} and increases linearly with the length of the crack a. Thus, at some point the cantilever will break off when σ_{T} exceeds the fracture strength σ_{fr} of the material. Ingraffea et al reported that cracks under wedge or tensile loading tend to depart from their intended fracture plane due to large positive T-stresses, rendering the data for measuring K_{lc} unusable. We have observed similar behavior in poly-crystalline and mono-crystalline materials where the crack propagated for a few millimeters then branched off vertically, as shown in FIG. 4A, FIG. 4B and FIG. 16, respectively. This caused one or both lips of the notch to break.

σ_{T} is proportional to K_{I}. So, it is not possible to have one without the other. Opening of the crack unavoidably creates T-stress, which can cause the cantilever to break rather than the crack to propagate along a horizontal path to separate the wafers. σ_{T} varies inversely as the square-root of the thickness of the boule B. Thus, the highest σ_{T} is obtained for the thinnest boule, B=1 mm. Therefore, as long as σ_{T} for B=1 mm is below the fracture strength σ_{fr} of the material, the cantilever will not break. When a stable crack propagates, K_{I} remains pinned at K_{IC}, the fracture toughness of the material, which is a known material property. For SiC K_{IC}=3.3 MPa√m and for GaN K_{IC}=0.8 MPa√m. Thus, the T-stress for SiC σ_{T}=255 MPa and for GaN σ_{T}=61.8 MPa, for B=1 mm, which are both below σ_{fr} of SiC and GaN, respectively. Therefore, it is possible to propagate a horizontal crack to split the final boule in two wafers without breaking the wafers with the application of a controlled force.

This situation can be prevented by loading the cantilever in compression along the x-axis, as shown in FIG. 18. The compressive stress σ_{c} due to axial load P_{c} cancels the tensile component of the T-stress σₓₓ at the inner tip of the crack where the crack tends to branch off vertically. This allows the crack to continue its horizontal path down the x-axis undeviated. This can be implemented by creating a stop in the wedge, as shown schematically in FIG. 19. When the wedge moves down by a distance δ the stress σₓₓ becomes=σ_{fr}. At that point the wedge compresses the cantilever axially and prevents it from breaking off. The wedge is then unloaded and the cycle repeated to extend the crack farther. Subsequent crack extensions do not reach σ_{fr}, so the design is safe.

This does not happen under displacement control because the force drops as 1/a. However, the case where the lip of the notch broke was neither force control nor displacement control. The design of the wedge with the stop provides protection and prevents breakage when the force cannot be controlled.

### Cleavage of SiC Grown On-Axis

FIG. 20 shows cleaved SiC wafers 2″ and 2.5″ diameter that were grown on-axis. The surface is smooth. The image of the hand taking the picture can be seen in reflection.

Cleavage of SiC 4″ n-Type Wafer

FIG. 21 shows cleaved SiC wafer 4″ diameter. Cleaved n-type SiC surfaces that are grown 4° off-axis exhibit roughness up to 50 μm.

### Splitting of SiC Piece in Half

The micrometer readings in FIG. 22 indicate the thickness of the original piece=1.12 mm before splitting. FIG. 23A and FIG. 23B indicate the thicknesses of each half being approximately 0.56 mm after cleavage. Thus, no material was lost. This is standard thickness for semiconductor and wide bandgap wafers that are commercially available on the market. Thus, we are able to split arbitrary shapes and sizes down to 1 mm thickness.

The instant cleaving technique works particularly well for SiC and GaN c-plane and Si(111) plane. It takes less energy to cleave GaN than SiC because it has a lower surface energy. We have cleaved all these materials and orientations.

Any defects that are on the surface of the wafer or even subsurface will propagate in the epi-layer and degrade device performance. For this reason, it is of utmost importance to avoid the creation of defects, such as dislocations. The instant crack propagation method does not introduce subsurface defects as evidenced by cathodoluminescence and Raman spectroscopy measurements.

### Advantages of Instant Invention Over Wire Sawing and Competing Techniques

The instant invention has advantages over wire sawing and laser wafering, especially in terms of CAPEX, because it does not require significant capital investment. The technique can be practiced in an ordinary machine shop using simple tools and equipment. Furthermore, it has higher throughput because, unlike laser wafering, the surface of the boule does not need to be polished after each separation and several boules can be processed simultaneously. In laser wafering a femto-second laser beam is focused inside the material at a certain depth below the surface and the beam is raster scanned across the surface of the boule to damage the material at several points on an internal plane, in order to facilitate the separation. The focal plane is a mirror image of the surface with a magnitude of (n−1), where n is the index of refraction of the material. Thus, any variations in the surface cause fluctuations in the focal plane. For this reason, it is necessary to polish the surface after each separation in order to obtain a flat focal plane, which slows the process down. Furthermore, in laser wafering only one wafer can be peeled off at a time. By contrast, in the instant invention, multiple boules can be wafered simultaneously. For example, it takes (N−1) operations to separate N wafers using a laser, whereas the instant invention uses only Log₂ (N) operations. Therefore, laser wafering ultimately may not have advantage over wire sawing, plus the significant investment in the cost of the laser. The instant invention has advantages over both wire sawing and laser wafering in terms of materials, time and cost savings.

### Example 1

Say that we want to slice a 1.6 cm thick boule into 32 wafers 0.5 mm thick each. It can be done in 5 iterations (Log₂ (32)=5) according to the teachings of the current invention, and there is no need to polish the surface, whereas it would take 31 operations to separate 32 wafers using laser wafering and the surface of the boule must be polished after each separation.

### Technical Challenges

The main challenges are reducing the wear rate of consumables and preventing the crack from turning sideways and going vertical. Our goal is to control the cleavage across 4″, 6″ and 8″ diameter wafers to reduce surface roughness and avoid breaking the wafers.

We want to guide a slowly propagating crack parallel to the surface of the wafer. The field of fracture mechanics started over a century ago. Most of the fractured materials have been poly-crystalline where there is no cleavage plane. Nevertheless, diamond has been cleaved for centuries by jewelers along the (111) plane. Luckily SiC does not have a major anisotropy. It cleaves well in the c-plane even though c-plane is not the cleavage plane in SiC. All the cleavage data presented is in the c-plane. The instant invention applies the concepts of fracture mechanics to crystalline materials in the context of wafering.

We use a single machine for initiating and propagating the crack that can operate under either load control or displacement control and has the desired force range. Also the machine must be able to indent in a straight line or around the circumference of a cylinder with a positioning accuracy of a few microns.

The time it takes to indent around the circumference can become a limiting factor for a large number of indents. The circumference of an 8″ boule is approximately 62.5 cm. At a spacing of 500 μm between indents, about 1,250 indents are needed per wafer or 50,000 per boule. At half a minute per indent this will take 6,000 minutes or about 100 hrs, which is too slow. Thus, a way of speeding up the indentation is needed for the fracture machine to compete with the throughput of the wire saw. This is what SiC manufacturers care most about.

### BRIEF DESCRIPTION OF THE DRAWINGS

The accompanying drawings are not intended to be drawn to scale. In the drawings:

FIG. 1A Schematic of cutting with metal wire and diamond particles, about 500 μm kerf loss;

FIG. 1B Schematic of cutting with cracks, less than 50 μm kerf loss;

FIG. 2A and FIG. 2B Chevron notch cut through a block of poly-crystalline SiC with a saw blade;

FIG. 2C and FIG. 2D A wedge is applied to the chevron notch;

FIG. 3A and FIG. 3B Poly-crystalline SiC block with a chevron notch cleaved in two;

FIG. 4A and FIG. 4B Unstable crack propagation in poly-crystalline ceramics that started horizontally then branched vertically;

FIG. 5A SiC substrate about 7 mm×7 mm originally 1 mm thick;

FIG. 5B and FIG. 5C SiC substrate of FIG. 5A split in two pieces 0.5 mm thick each;

FIG. 6 SiC substrate of arbitrary shape, originally 1 mm thick, area about 2 cm² split in two pieces 0.5 mm thick each, shown as mirror images;

FIG. 7A GaN substrate originally 1 mm thick, area about 2 cm²;

FIG. 7B GaN substrate of FIG. 7a split in two pieces 0.5 mm thick each;

FIG. 8 Cleaved Si pieces of different shapes and sizes;

FIG. 9 DekTak traces of cleaved SiC height variation ±5 μm, P-V 50 μm;

FIG. 10 E₂(TO) Raman spectra of cleaved sample (b) and state-of-the-art polished SiC sample from Cree (a);

FIG. 11 CL spectra of cleaved SiC sample (b) and state-of-the-art polished SiC sample from Cree (a);

FIG. 12 Vickers indentation in SiC under a load of 5N;

FIG. 13 Line indentation connect cracks along the diagonal in SiC;

FIG. 14A bar of semiconductor material indented with Vickers along the top edge;

FIG. 14B crack about 200-300 μm deep in top edge of semiconductor bar;

FIG. 15 notch with opposite forces (red arrows) acting on the mouth of the notch;

FIG. 16 crack deviated and followed a vertical path of least resistance due to T-stress;

FIG. 17 T-stress on a double cantilever;

FIG. 18 Double cantilever with axial loading causing compressive stress;

FIG. 19 Stop in wedge to prevent breakage;

FIG. 20 Cleaved SiC wafers 2″ and 2.5″ diameter that were grown on-axis;

FIG. 21 Cleaved SiC n-type wafer 4″ diameter;

FIG. 22 Original thickness of SiC piece with arbitrary shape=1.12 mm;

FIG. 23A thickness of SiC piece split in half=0.56 mm;

FIG. 23B thickness of SiC piece split in half=0.56 mm;

FIG. 24A, FIG. 24B, FIG. 24C hexagonal and square poly-crystalline SiC pieces and their dimensions;

FIG. 25 macro-hardness tester model CV400 ARS-20 Type A machine;

FIG. 26A, FIG. 26B and FIG. 26C how the hexagonal and square pieces are held in the jig;

FIG. 27 line of 10 indentations with 5 kg spaced 200 μm apart. The cracks do not always link;

FIG. 28 typical 20 kg indentation without chipping taken with a 10× lens magnification;

FIG. 29 typical 30 kg indentation without chipping taken with a 10× lens magnification;

FIG. 30 typical 30 kg indentation with chipping taken with a 10× lens magnification;

FIG. 31 cracks between adjacent 20 kg indentations link;

FIG. 32 the chipped areas border on the cracks;

FIG. 33 cracks between adjacent 20 kg indentations do not always link;

FIG. 34A two 5 kg indentations separated by 200 μm;

FIG. 34B wedge applied to 5 kg indentation causes chipping;

FIG. 35 hexagon indented with 30 kg along red dashed line near the corner;

FIG. 36A 20 kg line indentation near corner of hexagon;

FIG. 36B 30 kg line indentation near corner of hexagon;

FIG. 37 picture of wedge;

FIG. 38 picture of cleavage from the top;

FIG. 39A and FIG. 39B pictures of cleavage of corner of hexagon from different angles;

FIG. 40A indentation trace of new wedge under 5 kg;

FIG. 40B indentation trace of damaged wedge under 5 kg;

FIG. 41A, FIG. 41B, FIG. 41C and FIG. 41D schematic diagram of a cantilever acted on by a wedge;

FIG. 42 plot of the cantilever elastic energy U vs crack length a;

FIG. 43A and FIG. 43B plot of cantilever displacement and load vs crack length a;

FIG. 44A and FIG. 44B forces acting on the wedge;

FIG. 45A and FIG. 45B ratio of load on wedge to force on cantilever and displacement of wedge over displacement of cantilever;

FIG. 46 Table showing discrete values of load P on cantilever and F_{w} on wedge in Newtons, displacement of cantilever y and wedge δ in μm;

FIG. 47 line indent with 3 kg @ 130 μm pitch shows suppressed orthogonal crack;

FIG. 48A 5 kg indentation whose vertical cracks are clearly visible but horizontal does not connect;

FIG. 48B 5 kg indentation horizontal crack linked, vertical crack absent;

FIG. 49A, FIG. 49B and FIG. 49C the cracks between aligned adjacent 5 kg indentations separated by 200 μm connect;

FIG. 50 a typical 20 kg indentation in SiC;

FIG. 51 20 kg indentation at 500 μm pitch superposed over a 2 kg line indent at a pitch of 100 μm;

FIG. 52 20 kg indentation at 400 μm pitch superposed over a 2 kg line indent at a pitch of 100 μm;

FIG. 53 20 kg indentation at 250 μm pitch superposed over a 2 kg line indent at a pitch of 100 μm;

FIG. 54 The load is reduced near the edge to avoid chipping the edge;

FIG. 55 Cleaved edge of hexagon from indentation line;

FIG. 56 damage to the Vickers tip taken with a Keyence laser scanning confocal microscope;

FIG. 57A incomplete traces of indentations under 1 kg with damaged Vickers tip;

FIG. 57B barely recognizable traces of indentations under 5 kg with damaged Vickers tip;

FIG. 58A and FIG. 58B damage inside the diamond;

FIG. 59A 30 kg line indent which broke the edge of SiC;

FIG. 59B resulting damage to the oblique diagonals of the Vickers from line indentation in FIG. 59a;

FIG. 60 cost of indentation technology vs pitch;

FIG. 61A original indentation with 20 kg diagonal=125 μm;

FIG. 61B after 40 re-indentations with 20 kg diagonal=380 μm;

FIG. 61C after 200 re-indentations with 20 kg diagonal=500 μm;

FIG. 61D after 1,200 re-indentations with 20 kg;

FIG. 62A, 1 kg and 5 kg tests after 10,000 re-indents;

FIG. 62B 1 kg and 5 kg tests after 20,000 re-indents;

FIG. 62C 1 kg and 5 kg tests after 24,000 re-indents;

FIG. 62D 1 kg and 5 kg tests after 25,000 re-indents;

FIG. 63A 20 kg indentation after 200 indents @ 400 μm pitch;

FIG. 63B 20 kg indentation after 250 indents @ 500 μm pitch;

FIG. 64A 20 kg indentation after 1,000 indentations @ 500 μm pitch;

FIG. 64B 20 kg indentation after 2,000 indentations @ 500 μm pitch;

FIG. 65A 30 kg indentation after 300 indentations @ 600 μm pitch;

FIG. 65B 30 kg indentation after 600 indentations @ 600 μm pitch;

FIG. 66 a damaged Vickers can still connect the cracks;

FIG. 67A the diagonal grew to 295 μm after 1^{st} application of the 50 kg;

FIG. 67B the diagonal grew to 500 μm after 12^{th} application of the 50 kg;

FIG. 68A 1 kg test indentation after 1^{st} application of the 50 kg;

FIG. 68B 1 kg test indentation after 12^{th} application of the 50 kg;

FIG. 69A 2 kg indentations before application of 20 kg;

FIG. 69B 2 kg indentations after application of 20 kg;

FIG. 70A initial 3 kg indentations 500 μm apart;

FIG. 70B after the application of 1^{st} 20 kg in FIG. 70a;

FIG. 70C after the application of 2^{nd} 20 kg in FIG. 70b;

FIG. 70D after the application of 1^{st} 50 kg in FIG. 70c;

FIG. 70E after the application of 2^{nd} 50 kg in FIG. 70d;

FIG. 70F after the application of 3rd 50 kg in FIG. 70e;

FIG. 71A and FIG. 71B micro-wedge angle of 75° and length about 350 μm;

FIG. 72A, FIG. 72B and FIG. 72C macro-wedge;

FIG. 73A before application of the micro-wedge, after application of the 3^{rd} 50 kg load;

FIG. 73B after application of the micro-wedge, after application of the 3^{rd} 50 kg load;

FIG. 74A micro-wedge trace in brass test block new;

FIG. 74B micro-wedge trace in brass test block after 150 applications @ 20 kg;

FIG. 75 micro-wedge trace in brass test block after 400 applications @ 20 kg;

FIG. 76 micro-wedge trace in brass test block after 500 applications @ 20 kg;

FIG. 77 micro-wedge trace in brass test block after 200 applications @ 30 kg;

FIG. 78A trace in brass of new macro-wedge of length 3.35 mm;

FIG. 78B trace in brass of damaged macro-wedge of length 3.35 mm;

FIG. 79A and FIG. 79B macro-wedge made of tungsten carbide, angle 60° and length ¼″=6.35 mm;

FIG. 80 trace of macro-wedge 6.35 mm long in brass test block;

FIG. 81 cleaved line 6.35 mm long near corner of hexagon;

FIG. 82A, FIG. 82B, FIG. 82C and FIG. 82D cleaved surface near corner of hexagon;

FIG. 83 cleaved hexagon corner piece;

FIG. 84A plot of wedge displacement vs crack length a;

FIG. 84B plot of load on wedge vs crack length a;

FIG. 85 time and cost of wafering vs wafer diameter for wire saw, laser and cleavage;

FIG. 86 Radial cracks of indentation (a) median (half-penny) crack, (b) Palmqvist crack;

FIG. 87A schematic of Vickers indentation 20 kg @ 500 μm pitch, half-penny median crack;

FIG. 87B schematic of macro-wedge applied on uniform crack 250 μm deep;

FIG. 87C schematic of Vickers indentation on crack ends, effective pitch=250 μm;

FIG. 87D schematic of Vickers indentation, effective pitch=125 μm;

FIG. 87E schematic of micro-wedge 20 kg applied on diagonal flattens bottom of the crack;

FIG. 88A, FIG. 88B the cracks in single crystal SiC connect even though they are not perfectly straight;

FIG. 89 schematic in perspective of micro-wedge in Vickers diagonal pit;

FIG. 90 schematic cross-section of indentation showing straight and planar crack under the diagonal;

FIG. 91 schematic of 20 kg indentations showing exaggerated crooked crack between indentations;

FIG. 92 schematic of indentations with enlarged diagonals;

FIG. 93A Wedge in a groove;

FIG. 93B and FIG. 93C schematic of forces on wedge;

FIG. 93D horizontal force P pushes the crack open;

FIG. 94 schematic of sealed hydraulic cylinder with three holes in the bottom containing hydraulic fluid with plunger type rods carrying three Vickers tips;

FIG. 95A schematic of hydraulic actuation parallel indentation of boule shown in elevation;

FIG. 95B schematic of parallel indentation of boule showing cross-section of boule and hydraulic cylinder;

FIG. 96 schematic detail of how the holes are sealed with O-rings around the plungers;

FIG. 97 cylinder held in a jig being indented;

FIG. 98 custom fracture machine for cleaving wafers;

FIG. 99 fast z-actuator;

FIG. 100 median cracks created by indentation around the circumference of the boule;

FIG. 101A and FIG. 101B sequence of cleavages for boules in their middle planes;

FIG. 102 sequence of cleavages from 16 mm down to 0.5 mm with the last step potentially using laser;

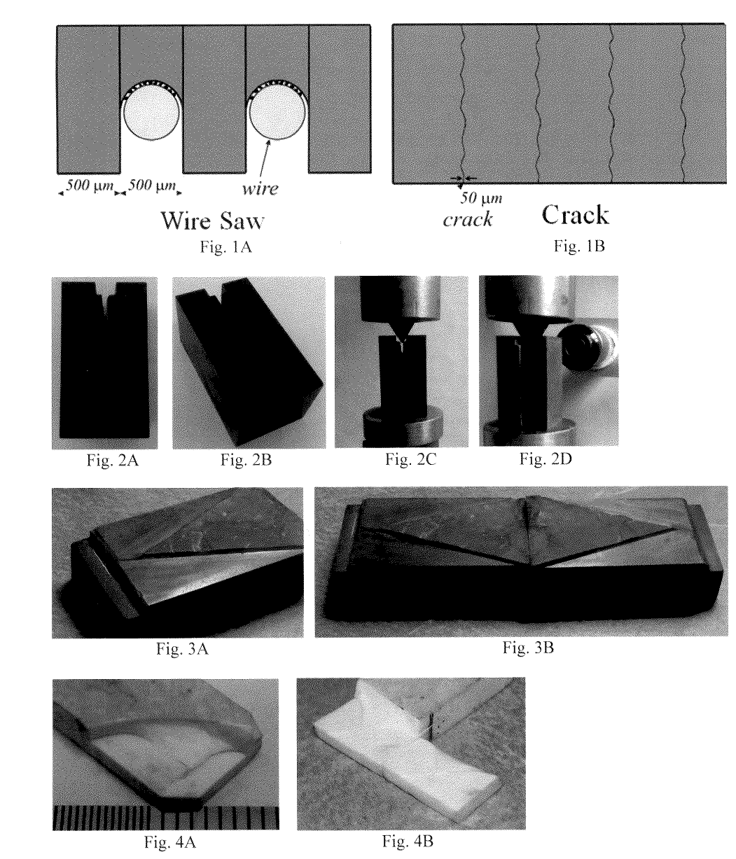

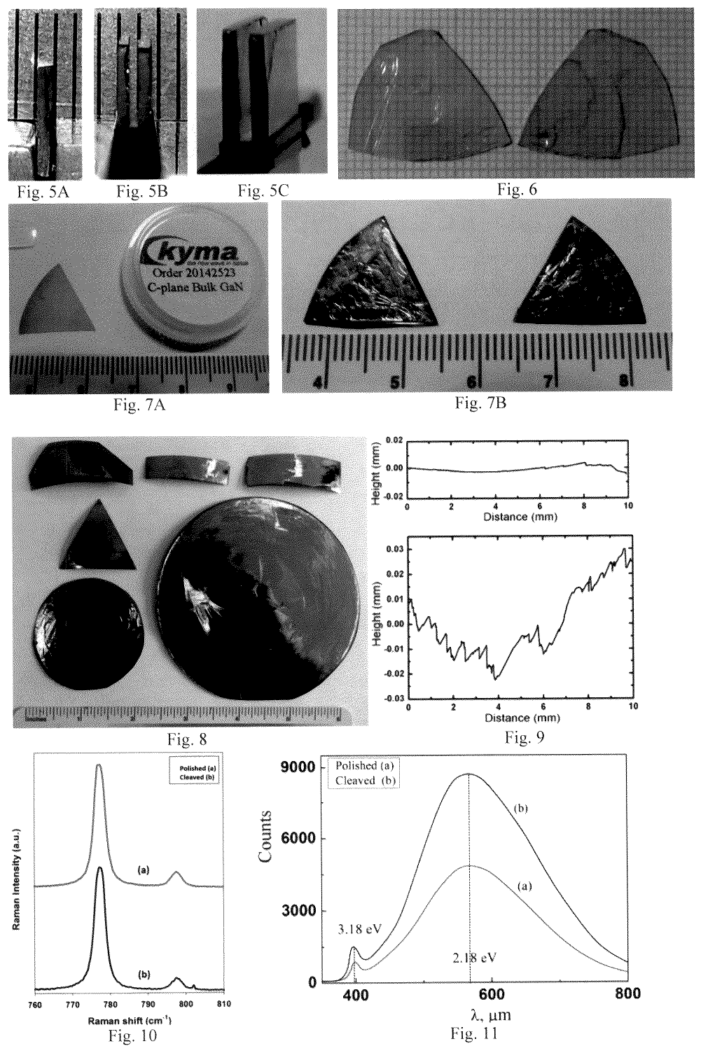

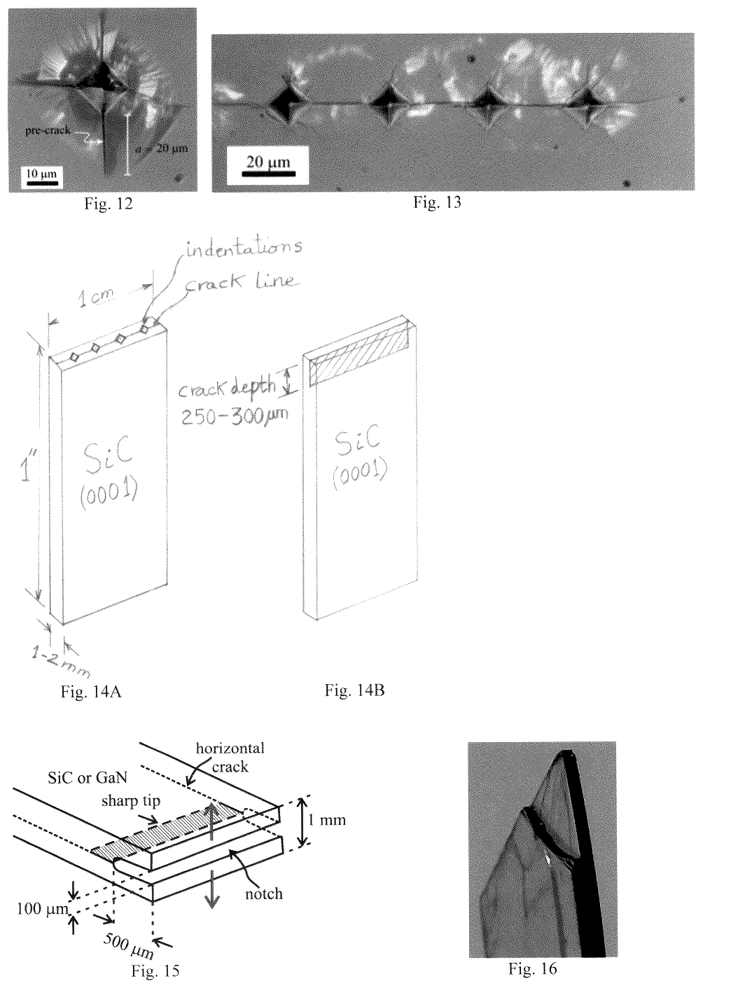

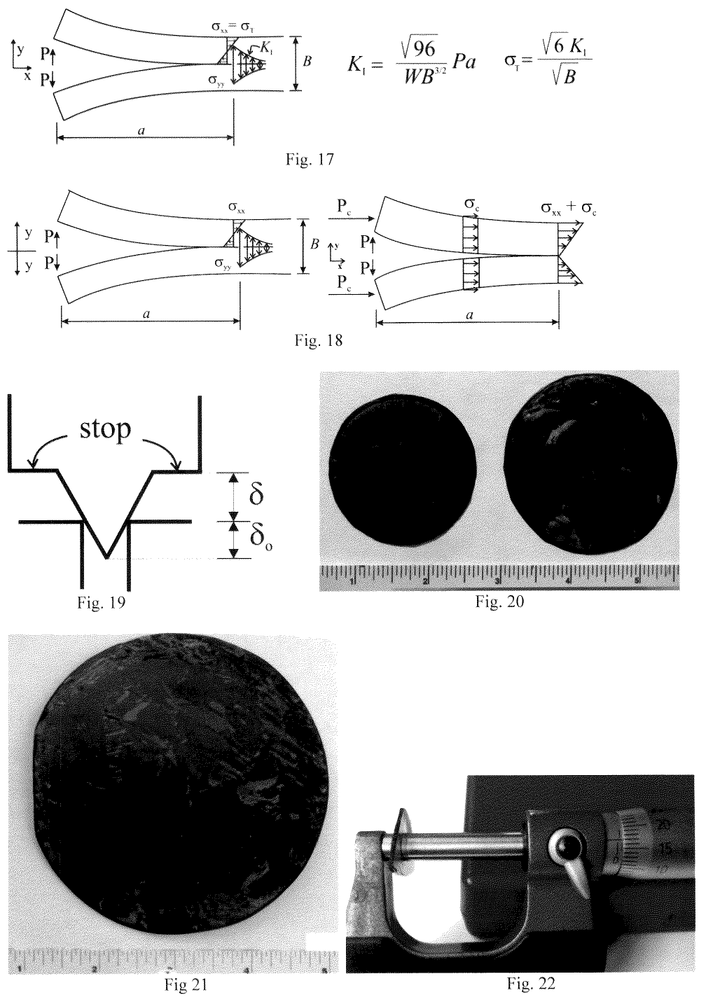

### DETAILED DESCRIPTION OF THE INVENTION

This invention is not limited to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

### Use of Hardness Tester

This project concerns the indentation of hard ceramic materials, specifically silicon carbide (SiC) with sharp four-faceted Vickers diamond tips. The first task of this project was to choose the materials and the equipment for the indentations. The goal is to machine hard and expensive materials using a hardness tester. These machines are commonly used for the measurement of hardness and fracture toughness of metals. But have not been used for machining of ceramics or any materials before. Hardness measurements are often done in the nano-regime with loads below 1 Newton. By contrast, machining of hard materials requires high loads up to 50 kg in the macro-regime. The requirements on control of the path of the crack are more stringent than the measurement of fracture toughness which mainly concerns the onset of crack propagation. It is desired to use the same machine for both steps to initiate and propagate the crack to streamline the process, reduce time and cost, and simplify alignment. Therefore, the first goal of this project was to qualify a compact and lightweight table-top hardness tester to cleave SiC.

Hardness testers are routinely used for crack initiation by Vickers indentation which leaves a square impression on the surface of the material being tested and four median or radial cracks normal to the surface jotting from each corner along the diagonals. The hardness of the material is calculated from the load divided by the area of the impression. The crack is propagated by applying a load to a wedge or chisel aligned with the diagonal. First, the indentation is made with the Vickers and then the Vickers is replaced with a wedge in the machine. The turret of the hardness tester is rotated using a feature in the software to position the Vickers or the wedge over the indentation. Theoretical calculations based on fundamental fracture mechanics indicate that the wedge must have an included (total) angle of 60° or less in order to drive the crack with a load less than 50 kg. This is within reach of the macro-hardness tester that we are using. Thus, the same machine can be used to initiate and propagate the crack. This is a first, which was demonstrated in this project.

The purpose of this project was to study the tribological interaction between diamond and silicon carbide in order to estimate the rate of diamond consumption while indenting SiC under high loads. This does not depend on the crystallinity of the material. Diamond will wear out at the same rate whether machining single or poly-crystalline SiC. For this reason we used poly-crystal because it is cheaper and yields the same results. However, poly-crystalline material does not cleave like a single crystal.

### The Materials

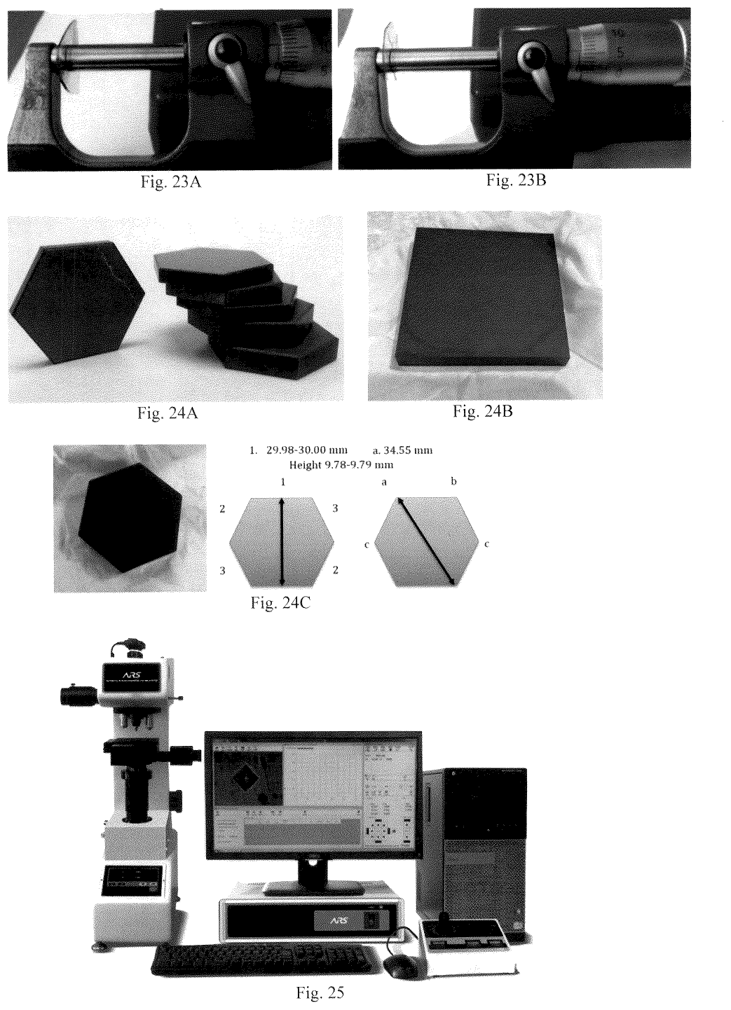

We indented α-sintered pure SiC materials with a grain size of 4-10 μm from Calix Ceramic Solutions, Inc. Sintered monolithic single-phase SiC is formed by dry pressing and then fired to achieve the highest density of 3.15 compared to 3.21 for single crystal. This yields the hardest poly-crystalline material with a hardness of 28 GPa and an elastic modulus of 410 GPa compared to 33 GPa and 473 GPa, respectively for single crystal. It has a fracture toughness K_{lc} of 4.6 MPa\sqrt{m} which is higher than that of single crystal (3.3 MPa\sqrt{m}) because it is not as brittle. We acquired a few hexagonal and square pieces which come in different thicknesses. The hexagon measures about 30 mm between flat sides and the squares are 2″×2″, as shown in FIG. 24A, FIG. 24B and FIG. 24C. We cut them to 1″×1″ pieces. The squares were 6.35 mm thick, and the hexagons 1 cm thick. Hexagonal tiles are usually used for armor. The surface as-fired is dull with a roughness about 1-1.5 μm rms, which is too rough for indentation even under high load. We polished the surface to a roughness of about 5 nm, at which point the indentations and cracks became clearly visible.

### The Equipment

We used a macro-hardness tester model CV400 ARS-20 Type A machine, as shown in FIG. 25. The machine consists of 4 modules: the hardness tester, the computer tower, the controller and the screen monitor. The entire system fits on a desk top about 48″×24″. The Vickers tips are made of natural diamonds with a length of junction of 0.5 μm suitable for indentation loads from milli-N up to 50 kg. The Type A machine uses dead weights with discrete loads of 1, 2, 3, 5, 10, 20, 30 and 50 kg, and a motorized x-y stage with a range of motion of 50 mm×50 mm. The CV-ARS machine uses Windows 10 operating system. The loading speed is 55 μm/sec with a minimum dwell time of 5 sec. The machine was fitted with three objective lenses with 10×, 20× and 40× magnifications. The turret turns to position the objective lens over the indentation. The machine can be programmed to make a series of indents in a line or matrix. After completing the program, the machine goes back automatically and takes pictures of every indentation with auto-focus. The total cycle time between indents is about 30 seconds not including taking pictures. The machine was calibrated according to ASTM E92 before shipping.

The 10× objective has a field of view of 600 μm×480 μm. The images can be stitched to provide an overview of the indented area. The machine came with a chuck vice 19 mm deep that bolts onto the stage and grips the ceramic sample horizontally from the sides, and a brass riser plate under the work piece to raise the surface above the top of the vice. The manufacturer also sent metallic test blocks that can be used to align the diagonal of the Vickers with the axes of the camera and the translation stages before indentation. The test blocks can also be used to test the damage to the Vickers after the indentations.

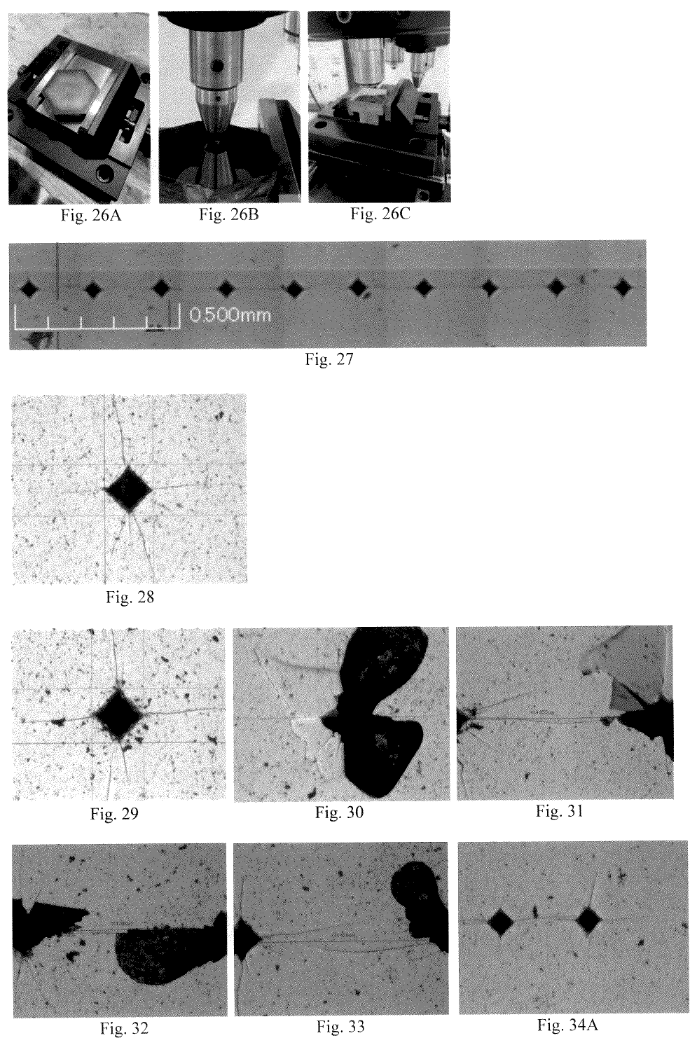

FIG. 26A, FIG. 26B and FIG. 26C show how the hexagonal and square pieces are held in the jig. The diagonal of the Vickers is aligned to the camera and to the motion of the stage. Similarly, the edge of the wedge is aligned to the camera first, then to the stage. The Vickers holder has a red dot which indicates the direction of the diagonal. The turret holds one Vickers indenter and three objective lenses 10×, 20× and 40× magnification. Making Vickers from other materials, such as BN will not reduce the price significantly because most of the cost is due to labor.

### The Indentations

We made several line indentations with 5, 10, 20, and 30 kg at different pitches for the purpose of linking the cracks along the diagonals and observing the chipping. We link the cracks of adjacent indentations to create a long crack and then apply a wedge to it to extend and propagate the crack. We measured the lengths of the diagonals and the cracks using features on the screen. The cracks in poly-crystalline SiC were actually longer than expected. Chipping of the surface occurred at loads above 10 kg even in single crystals. The incidence of chipping increased with the load. At 20 kg about half (50%) of the indentations chipped, and at 30 kg there was 60% chance of chipping. The length of the crack increases with the load, but so does the chipping. Chipping is due to lateral cracks parallel to the surface which originate from the bottom of the indentation and is unavoidable under high load. The following results were obtained:

| | | Length of crack from |
|---|---|---|
| Load kg | Length of diagonal d μm | end-to-end 2c μm |
| 1 | 24 | 65 |
| 2 | 34 | 100 |
| 3 | 41 | 130 |
| 5 | 64 | 200 |
| 10 | 90 | 300 |
| 20 | 125 | 500 |
| 30 | 150 | 600 |

The successive indentations were spaced at a pitch equal to the length of the crack (2c) so that the ends of the cracks from adjacent indentations touch. FIG. 27 shows a line of 10 indentations with 5 kg spaced 200 μm apart. The cracks between adjacent indentations do not always link.

FIG. 28 shows a typical 20 kg indentation without chipping. This picture was taken with a 10× lens magnification whose field of view is 600 μm×480 μm. The cracks are longer than expected because the material is poly-crystalline. The measurement of crack length is not reliable because the crack is not always straight or along the diagonal. For this reason, this method is not used for the measurement of fracture toughness. That is fine for us, however, because all that we care about is to link the cracks from adjacent indents.

FIG. 29 shows a typical 30 kg indentation without chipping taken with the same magnification. However, chipping often occurs under high load, as shown in FIG. 30. With 50 kg chipping becomes unavoidable.

Even though the cracks between 20 kg indents are not perfectly straight, but they manage to link, as shown in FIG. 31. The chipped areas border on cracks, as shown in FIG. 32. The width of the crack was measured with a 100× magnification to be 3.4 μm. However, they do not always link, as shown in FIG. 33, chipping occurs about 50% of the time.

Our goal was to find the best compromise between the length of the crack and the amount of chipping on the surface that can be tolerated. Both increase with the load. 30 kg causes significantly more chipping and more damage to the Vickers. So, 20 kg was chosen as the load of indentation because it causes less chipping and yields a crack about 250 μm deep which can be driven with a wedge.

Chipping is unavoidable at these loads and occurs also in single crystals. The chipping obscures the diagonal and the cracks. For this reason, the hardness and toughness of materials cannot be measured optically under high load. By contrast, this technology is more tolerant. The chipping under 20 kg is tolerable as long as a wedge can be applied to the diagonal because there is a crack under the diagonal. Since the indentation and the propagation are done in the same machine without removing the sample from the machine, the wedge can be aligned to the diagonal of the Vickers even though it is not visible. The Vickers and the wedge are mounted in the turret and aligned to the camera and the sample before the indentation. Therefore, we can still do the cracking in spite of the chipping. The chipping is shallow within 20 μm from the surface. We get rid of the chipping at the end after the cleavage by grinding the edge of the wafer.

The cracks were not always straight, and shortening the pitch did not always connect the cracks. Since the cracks on the surface are not always along the diagonal, the wedge is confined to the diagonal. Furthermore, since the diagonal pit is much wider than the crack, the tip radius of the wedge does not have to be made very sharp on the order of a few microns to fit in the crack, especially if it is coated with a nano-crystalline layer which increases the tip radius by the thickness of the layer. The wedge touches the material on its facets, rather than its tip, to pry the crack open. The wedge does not create a new crack. It merely spreads the crack that was created by Vickers indentation laterally and longitudinally. Hence, it is not an indenter. First, a micro-wedge is applied to the diagonal of each indentation to extend the crack laterally and connect the cracks between adjacent indents to create a long crack along the surface, even though it may not deepen the crack. Finally, a macro-wedge will drive the long crack longitudinally and cleave a wafer. Since 20 kg was chosen as the indentation load, then the length of the wedge was made 125 μm equal to the diagonal of the 20 kg indentation. The idea is to create a crack equivalent to that of 30 kg but with less damage to the diamond and to the SiC surface. The angle of the wedge must be sharper than that of the Vickers (136°) so that the wedge fits in the indentation without touching the surface. Ideally, the wedge should have a sharp angle between 60° and 75° to reduce the force necessary to drive the crack. But making a diamond tip with a sharp angle is more difficult than a blunt angle because it increases the risk of the diamond falling out of the matrix holding it to the metal. Practically, a wedge with an included (total) angle of 120° with a length of 125 μm was made.

The 120° wedge was applied with 10 kg to a previous 5 kg indentation. It strengthened and extended the cracks but also caused more chipping. FIG. 34A shows the original indentations consisting of two 5 kg separated by 200 μm where the cracks did not connect. Subsequently, 10 kg was applied to the right indentation using the 120° wedge, as shown in FIG. 34B. Application of a wedge over a previous indentation or re-indenting with Vickers at the same location will unavoidably cause more chipping even though the wedge is sharper than the Vickers. The chipped areas are thin flakes that break off when touched by the wedge. Even though the wedge fits in the pyramidal pit and is contained within the diagonal, but it touches the flakes at two points because the lateral cracks originate from the bottom of the plastic zone about 20 μm below the surface.

Theoretically, this can be accomplished with the Vickers. The Vickers would be acting like a wedge at that point, but it is a lousy wedge because the angle of 136° is too blunt. A sharper angle is needed to drive the crack with a reasonable force. For this reason, the Vickers cannot extend its own crack. Re-indenting with the Vickers multiple times at the same location under the same or higher load may broaden the diagonal but will not extend the crack. The distinction between an indenter and a non-indenter is whether the tip or the oblique facets touch the material. If the tip touches the material then it should be made of diamond. However, since the wedge makes contact with the corners of the crack through its slanted walls, then it can be made of a different material which has a low coefficient of friction with SiC, such as tungsten carbide (WC). The micro-wedge should be made of diamond even though it is not supposed to touch the surface. If a wedge touches the surface then it will create its own crack. This will cause premature damage and wear of the wedge because it is much longer than the Vickers (0.5 μm). When re-indenting at the same location the tip of the Vickers does not touch the material because there is an opening, the crack, at the bottom of the indentation. For this reason, the Vickers can survive thousands of re-indentations. The macro-wedge is made of WC and covers the entire line indent. However, the macro-wedge expects a long and straight crack. Otherwise, it will touch the surface. The advantage of applying the micro-wedge individually to each Vickers is that it straightens and links the micro-cracks from each indentation before applying the macro-wedge. The micro-wedge also widens the crack so that the tip radius of the macro-wedge fits within the width of the crack. This is also made easier by broadening the diagonals of each indentation through repeated application of the Vickers at the same point so that the diagonals from adjacent indentations touch.

### Cleavage

A hexagon was held in the jig as shown in FIG. 26A and indented with 30 kg along a line near the corner (red dashed line in FIG. 35) and then applied 50 kg with a wedge on the indented line for the purpose of qualifying the CV-ARS type A machine for both indentation and cleavage. The line was between 6 mm and 1 cm long and the distance from the corner was 1.5-2.75 mm. The load was increased gradually from 5 to 10 to 20 then 30 kg. First, a 5 kg line was indented, followed by a 10 kg line on top of the 5 kg line, then 20 kg and 30 kg were applied over the same line.

The pitch was originally 300 μm then it was reduced to 200 μm. The load was tapered near the ends of the line to avoid breaking the edge of the hexagon. The 30 kg line was started 1 mm from the edge, the 20 kg line 0.75 mm, the 10 kg line 0.35 mm and the 5 kg line 0.1 mm from the edge. The pitch was reduced in the last 1 mm near the edge to 150 μm for 20 kg and 100 μm for 10 kg. The goal was for the crack to reach the edge to create a continuous crack line from edge-to-edge without breaking the edge. We found that applying 20 kg and 10 kg in the last mm do not break the edge, whereas 30 kg does. The 20 kg and 30 kg line indentations are shown in FIG. 36A and FIG. 36B, respectively. The 30 kg indentation created significantly more chipping than the 20 kg indentation. The chipping tapers off near the ends of the line. This was done on purpose to avoid breaking the edge.

When the wedge was first applied with 50 kg a noise was heard but it did not cleave. This indicated that the wedge touched the surface, i.e. acted like an indenter, which it was not supposed to do. This implies that either the 50 kg was not enough to drive the crack, or that the 30 kg did not create a crack deep enough, or that the crack was not well formed, i.e., the individual cracks between adjacent indents were either not straight or did not connect, so the wedge tip encountered material rather than just fit in the crack. Any one of these possibilities could lead to the lack of cleavage. Furthermore, inspection of the wedge tip revealed a slight damage which confirmed that the tip rather than the sides touched the surface. The options were to either increase the load on the wedge beyond 50 kg or to reduce the pitch. Increasing the load on the wedge was not an option because the intent was to qualify the CV-ARS machine for cleaving which has a load capacity of 50 kg. Therefore, the only option was to reduce the pitch. The only way to obtain cleavage was to reduce the pitch from 300 μm to 200 μm.

The wedge that was used in this experiment was made of natural diamond. The length of the tip of the wedge depends on the size of the largest stone in the inventory of the Vickers maker which is embedded in the metal holder. Ideally the wedge should cover the entire line indent, i.e. 6 mm to 1 cm. However, a stone this big would cost a six-figure or even seven. Practically, the longest wedge that can be made out of diamond is 1.25 mm. The wedge, shown in FIG. 37, had an included (total) angle of 60°. This angle should be sharp enough to drive the crack with a load of 50 kg according to theoretical predictions (see Appendix 1 below).

Thus, the wedge could not be applied all at once. We had to step and re-apply the wedge several times, similar to Vickers, albeit with a longer pitch of 500 μm starting at the center of the line, then moving toward one end of the line then the other to cleave the entire piece. FIG. 38 shows the cleavage from the top. FIG. 39A and FIG. 39B show pictures of the cleavage of the corner from different angles. The cleavage was neither straight nor vertical because the material is poly-crystalline and the machine cannot be programmed to run in displacement control to yield a stable crack. Nevertheless, it was a success! we were able to cleave a piece from the indented line. Subsequently, we discovered that we could cleave starting from an indentation of 20 kg instead of 30 kg. This not only creates less chipping, but also extends the lifetime of the Vickers.

Thus, we have qualified the CV400 ARS-20 Type A machine for indentation by Vickers and cleavage by wedge which was our first goal. If more than 50 kg were needed to cleave, then we would have had to use a bigger machine with a higher load capacity, which would not have been available to us. Luckily, we were able to do both tasks with the same machine.

We cleaved but it cost us a Vickers and two wedges. The Vickers, the 120° and the 60° wedges were all damaged beyond repair. The two main culprits were the 30 kg load and the pitch of 200 μm. The crack corresponding to a load of 30 kg is about 600 μm long end-to-end. Thus, if two successive indentations are placed 200 μm apart, then the tip of the Vickers falls on the crack of the previous indentation. This seems to damage the tip. We observed that about 70 indentations of 30 kg at that pitch damaged the Vickers. FIG. 40A and FIG. 40B compare the indentations of a Vickers tip, new and damaged, in a brass testing block under a load of 5 kg.

Next, we will explore ways of extending the lifetime of the Vickers tip and the wedges.

### APPENDIX 1

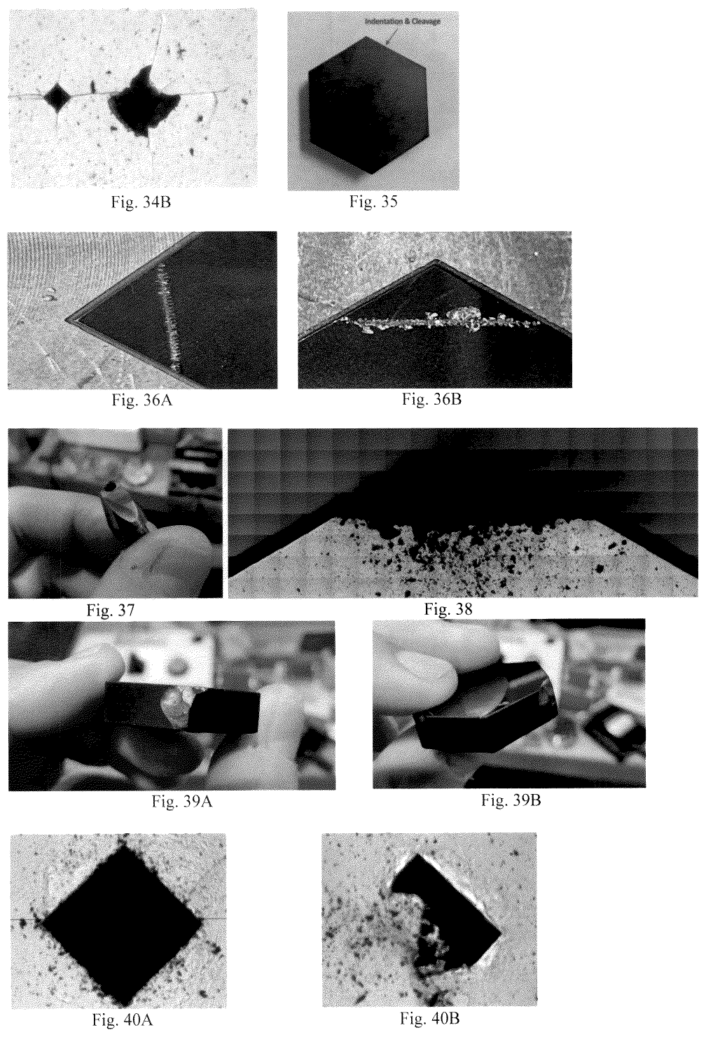

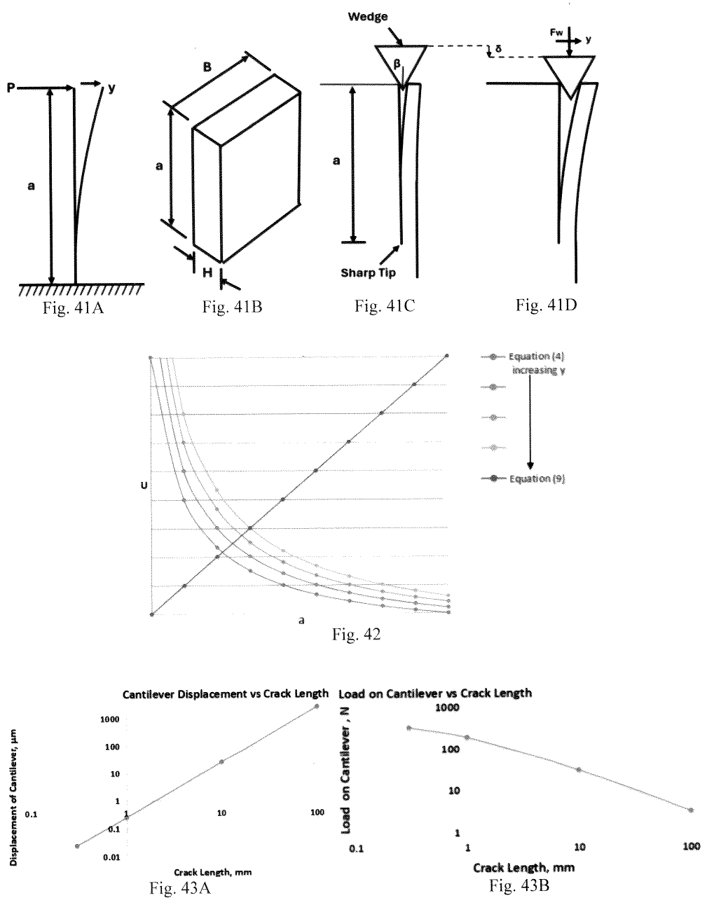

A cantilever beam having a length ‘a’ equal to the length of the crack, width B and thickness H, deflection y under load P, is shown in FIG. 41A, FIG. 41B, FIG. 41C and FIG. 41D. The tip of the crack is sharp. A wedge is pushed down under a force F_{w} by a vertical distance δ corresponding to a horizontal cantilever deflection y=2δ tan (B) where β is the half-angle of the wedge. The question is at what load F_{w} and displacements δ and y will the crack start to propagate from length a?

The displacement y is given in terms of the load P and the dimensions of the cantilever from beam theory by

$$y = \frac{P {a}^{3}}{3 EI} = \frac{4 P {a}^{3}}{E B {H}^{3}} \qquad ( 1 )$$

Where E is the elastic Young's modulus and I is the moment of inertia. Similarly, the load P can be written in terms of y and the dimensions of the cantilever as

$$P = \frac{E B {H}^{3}}{4 {a}^{3}} y \qquad ( 2 )$$

The elastic energy

$$U = \frac{1}{2} Py$$

stored in the cantilever can be written either in terms of P and a or equivalently in terms of y and a using equation (2). This represents the amount of work done by the force P to deflect a cantilever of length a by a distance y.

$$U ( P , a ) = \frac{2 {P}^{2} {a}^{3}}{E B {H}^{3}} \qquad ( 3 )$$

$$U ( y , a ) = \frac{E B {H}^{3} {y}^{2}}{8 {a}^{3}} \qquad ( 4 )$$

It is seen from equation (4) that for a certain displacement y the energy decreases with the length of the cantilever a. This means that a longer cantilever has less energy for the same displacement. The energy release rate G is the partial derivative of U with respect to a, while holding y constant,

$$G = - \frac{\partial U}{B \partial a}$$

where B is the width of the cantilever.

$$G = \frac{3 E {H}^{3}}{8 {a}^{4}} {y}^{2} \qquad ( 5 )$$

For a certain crack length, the energy release rate increases as the square of the displacement, y² When G reaches a certain critical value G_{c} the crack begins to propagate. G_{c} is related to the fracture toughness K_{lc} of the material and Young's modulus by K_{IC}²=G_{C}E. Similarly, G can be written in terms of P and a using equation (1) as

$$G = \frac{6 {P}^{2} {a}^{2}}{E {B}^{2} {H}^{3}} \qquad ( 6 )$$

In order to propagate a stable crack, G must remain pinned at G_{c}. If G drops below G_{c} the crack arrests, and if G grows beyond G_{c} the crack becomes unstable. Even though equations (5) and (6) are entirely equivalent in the sense that one can be derived from the other using equations (1) and (2), but they have major implications on how the crack will grow. It is seen from equation (5) that for a certain y, as a increases G decreases. This is known as displacement control. Whereas in equation (6) for a certain P, as a increases G increases. This is known as load control which leads to an unstable crack. Therefore, both P and y must vary with a as the crack propagates to maintain G constant. It is seen from equations (5) and (6) that P must vary as 1/a whereas y varies as a² to obtain a stable crack. Thus,

$$P = \frac{{K}_{Ic}}{\sqrt{6}} \frac{{BH}^{3 / 2}}{a} \qquad ( 7 )$$

$$y = \sqrt{\frac{8}{3}} \frac{{K}_{I c}}{E {H}^{3 / 2}} {a}^{2} \qquad ( 8 )$$

Therefore, it can be seen from either equation (3) or equation (4) above that the energy U grows linearly with the length of the crack a, and is independent of the thickness of the cantilever H.

$$U = \frac{{K}_{Ic}^{2}}{3} \frac{Ba}{E} \qquad ( 9 )$$

The graph shown in FIG. 42 plots the variation of the energy U vs a (equation (4)) qualitatively parametrically with y. The straight line represented by equation (9) intersects the curves at points where the slope is equal to −BG_{c}. Thus, as the crack propagates, y increases quadratically with a according to equation (8) and the crack jumps from one curve to the next always intersecting at the point where the energy release rate is equal to G_{c}.

Equations (7) and (8) represent the solutions for the horizontal load and the displacement required for the crack to start propagating from length a. These were derived from beam theory which assumes that the whole elastic energy is stored in bending and neglects the shear energy. For short beams (a<H) it is necessary to include the shear. The energy release rate G in equation (6) is multiplied by a correcting factor, which is obtained from numerical analysis [1].

$$G = \frac{6 {P}^{2} {a}^{2}}{E {B}^{2} {H}^{3}} {( 1 + 0.677 \frac{H}{a} )}^{2} \qquad ( 10 )$$

This equation can be solved for P and y making use of the fact K_{IC}²=G_{C}E

$$P = \frac{{K}_{Ic}}{\sqrt{6}} \frac{B {H}^{3 / 2}}{( a + 0.677 H )} \qquad ( 11 )$$

$$y = \sqrt{\frac{8}{3}} \frac{{K}_{I c}}{{EH}^{3 / 2}} \frac{{a}^{3}}{( a + 0.677 H )} \qquad ( 12 )$$

The error is small when the beam is long, i.e. when a>>H. In fact, equations (7) and (8) are the exact asymptotes of (11) and (12) when a/H→∞.

However, the shear must be taken into account when the crack begins to propagate because the cantilever is short. The crack is created by indentation. A load of 20-30 kg creates a crack 250-300 μm deep. Thus, a=300 μm.

The critical energy release rate G_{c}=2γ, where γ is the surface energy, which is related to the number of dangling bonds. For SiC γ=11.5 Joules/m2 and Young's modulus E=473 GPa. Therefore, the fracture toughness of SiC is K_{IC}=\sqrt{G_{C}E}=3.3 MPa\sqrt{m}.

According to [3], the stress intensity factor K_{I} is made up of the contributions of the residual stress intensity factor K_{II} due to indentation and K_{Ia} due to the applied stress. K_{Ii} and K_{Ia} add up to K_{I}. K_{I}=K_{Ii}+K_{Ia}. At the critical load,

$${K}_{Ii} = \frac{1}{4} {K}_{Ic} and {K}_{Ia} = \frac{3}{4} {K}_{Ic} .$$

Therefore, a more accurate estimate of the load and displacement necessary to propagate the crack is obtained by replacing K_{Ic} in equations (11) and (12) by

$$\frac{3}{4} {K}_{Ic} .$$

$$P = \frac{3 {K}_{Ic}}{4 \sqrt{6}} \frac{B {H}^{3 / 2}}{( a + 0.677 H )} \qquad ( 13 )$$

$$y = \sqrt{\frac{3}{2}} \frac{{K}_{Ic}}{E {H}^{3 / 2}} \frac{{a}^{3}}{( a + 0.677 H )} \qquad ( 14 )$$

### NUMERICAL EXAMPLE

What force P and displacement y are needed to cleave a cantilever 1 cm wide (B=1 cm), by 1 mm thick (H=1 mm), by 300 μm long (a=300 μm)?

Since a<H, we must use the correcting factor. Equations (13) and (14) yield P=327 N and y=7.5 nm for a=300 μm. The graphs in FIG. 43A and FIG. 43B plot y vs a and P vs a between 0.3 mm and 100 mm logarithmically, respectively, where P is in N and y is in μm.

The two corrections, due to shear and stress intensity factor are beneficial because they reduce the amount of force needed to propagate the crack. If it were not for these corrections, i.e. if the shear were neglected and if the applied load were to cause the cleavage on its own without assistance from the indentation, i.e. if K_{Ia} were equal to K_{Ic}, then the force needed to propagate the crack from 300 μm would be 1,420 N, a four-fold increase over the current force of 327 N. That would be bad news if we were trying to design a structure against failure. But since we want to induce cleavage then the decrease of load is in our favor.

We can formulate the theory in terms of the vertical load on the wedge F_{w} and the vertical displacement of the wedge δ. The diagrams in FIG. 44A and FIG. 44B show the balance of the forces acting on the wedge. A normal force N as well as a friction force μN act on the facets of the wedge, where μ is the coefficient of friction between the material of the wedge and SiC. The resultant horizontal force is P which pushes against the cantilever. The relationship between F_{w} and P depends critically on μ and β, the half-angle of the wedge.

$$\frac{{F}_{w}}{P} = 2 ( \frac{μ + tan β}{1 - μ tan β} ) \qquad ( 15 )$$

$$δ = \frac{y}{2 tan β} \qquad ( 16 )$$

The graphs in FIG. 45A and FIG. 45B plot F_{w}/P parametrically with μ and δ/y vs β, respectively. The load on the wedge F_{w} is very susceptible to the friction and the angle of the wedge. For example, if the half-angle is increased from 30° to 60° and the friction coefficient μ is increased from 0 to 0.2, then the load needed to drive the crack increases 6 fold to produce the same force on the cantilever. The half-angle of the wedge β must not exceed 30° (included angle of) 60° and the friction coefficient μ must not exceed 0.12 in order to maintain the load below 50 kg. Since we were able to cleave with 50 kg starting from a crack 300 μm deep, this confirms that the coefficient of friction u between tungsten carbide and silicon carbide is about 0.12 and shows that the cleavage went according to theory.

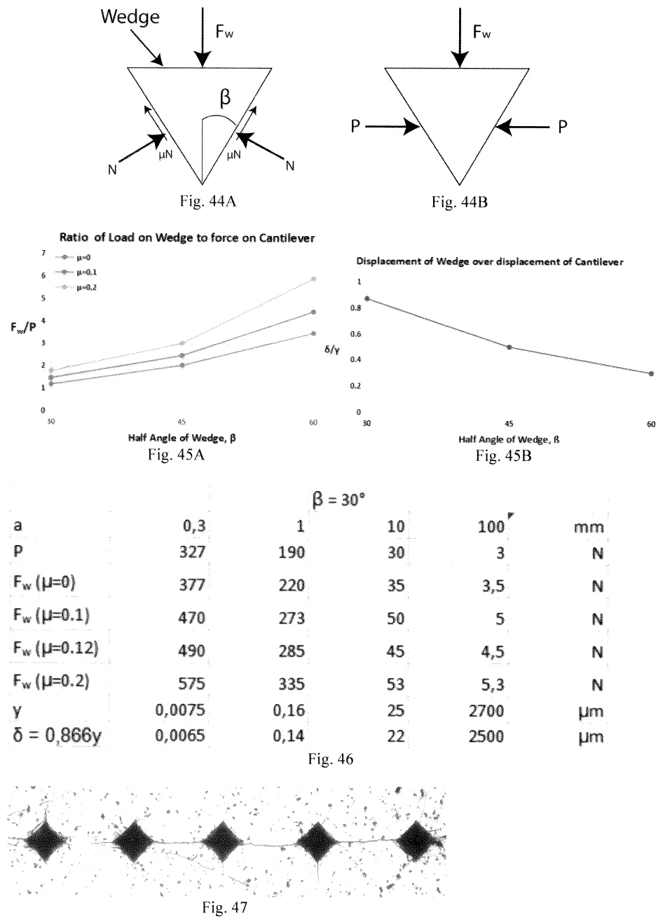

The table in FIG. 46 shows the discrete values of P and F_{w} in Newtons, y and δ in μm, for β=30°, μ=0, 0.1, 0.12 and 0.2 vs a=0.3, 1, 10 and 100 mm. The maximum load needed to propagate the crack β=30° and μ=0.12 is 490 N, i.e. 50 kg which is the capacity of the type A hardness tester. An increase in either β or μ would push the load over the 50 kg limit. The wedge moves only 6.5 nm to start the crack from 300 μm. It travels 25 μm to drive the crack to 1 cm. And a downward displacement of the wedge of 2.5 mm is needed to drive the crack to 10 cm, which is equivalent to the radius of an 8″ wafer.

It was reported [4] that the coefficient of friction u between diamond and SiC is between 0.05 and 0.15 and rarely exceeds 0.2. We confirm that we inferred the coefficient of friction from the crack propagation experiment to be approximately 0.12 corresponding to a load of 50 kg applied to the wedge.

Since the measurement of crack length and depth is not very accurate, it is desired to eliminate the crack length ‘a’ in the equations above. This would eliminate a major source of error in any technique seeking to measure fracture toughness. Since the crack is derived originally from the indentation, and the crack length is related to the load of indentation through the Antsis formula [2,3],

$${K}_{Ic} = 0.016 {( \frac{E}{H} )}^{1 / 2} \frac{{F}_{V}}{{a}^{3 / 2}}$$

where (E/H) is the ratio of the elastic modulus to the hardness and Fv is the load applied to the Vickers. The 0.016 factor corresponds to the geometry of the 4-sided pyramidal Vickers tip. This relationship can be inverted as

$$a = {( \frac{0.016}{{K}_{Ic}} )}^{2 / 3} {( \frac{E}{H} )}^{1 / 2} {F}_{V}^{2 / 3} \qquad ( 17 )$$

The hardness of SiC is 33 GPa. For SiC, K_{IC}=3.3 MPa/m E/H=14.33, equation (17) becomes

$$a = 7 {F}_{V}^{2 / 3} where Fv is in Newton and a is in μm \qquad ( 18 )$$

This expression for a can be substituted directly into equation (13) which yields P in terms of Fv and in turn substitute that expression for P into equation (15) to yield a direct relationship between the load on the wedge F_{w} and the load on the Vickers Fv.

$${F}_{W} = \frac{2 B {H}^{3 / 2} \times {10}^{6}}{7 \times {10}^{- 6} {F}_{V}^{2 / 3} + 0.677 H} ( \frac{μ + tan β}{1 - μ tan β} ) \qquad ( 19 )$$

Where F_{w} and F_{V} are in Newtons and B and H are in meters. It can be seen from equation (19) that for a load F_{w}=30 kg, F_{V}=50 kg, which proves the hypothesis that the crack can be initiated and propagated with a load not exceeding 50 kg using a table top hardness tester.

### Method of Extending the Lifetime of Vickers

We tried to understand how the damage to the Vickers occurs and to extend the lifetime of the Vickers indenter. The machine was placed on a concrete floor to reduce the effects of vibration.

Since the cracks between adjacent indentations under higher loads were not always straight and did not always connect, we shortened the pitch hoping to make it easier to cleave. The idea is that a shorter pitch will lead to a straighter crack for the wedge to sit in. It did, but at the cost of damaging the Vickers. An alternative strategy was to indent with a higher load over a line which was previously indented with a lower load. That too damaged the Vickers prematurely.

A method by re-indenting several times with 20 kg at the same location to widen the diagonal and link the cracks while extending the lifetime of the Vickers indenter was demonstrated and the lifetimes were measured for 20 kg and 30 kg.

Indenting Over Line Indent while Gradually Increasing the Load

It is desired to create a 250-300 μm deep crack equivalent to that of a 30 kg indentation. Such a high load would damage both the surface of the SiC as well as the Vickers especially when the pitch is reduced below 400 μm. We want to produce a deep crack but with a smaller load 20 kg instead of 30 kg. The problem is that the cracks are not always straight and do not always connect, which makes it difficult to seat the wedge in the crack. The tip of the wedge will damage if it encounters material because the wedge is not supposed to be an indenter. Thus, our initial strategy was to increase the load gradually from 1 kg to 2 kg then 5 kg and 10 kg to 20 kg and eventually 30 kg. But indenting over a previous line indent with a higher load and longer pitch caused chipping and proved detrimental to the Vickers.

### Suppression of Orthogonal Crack

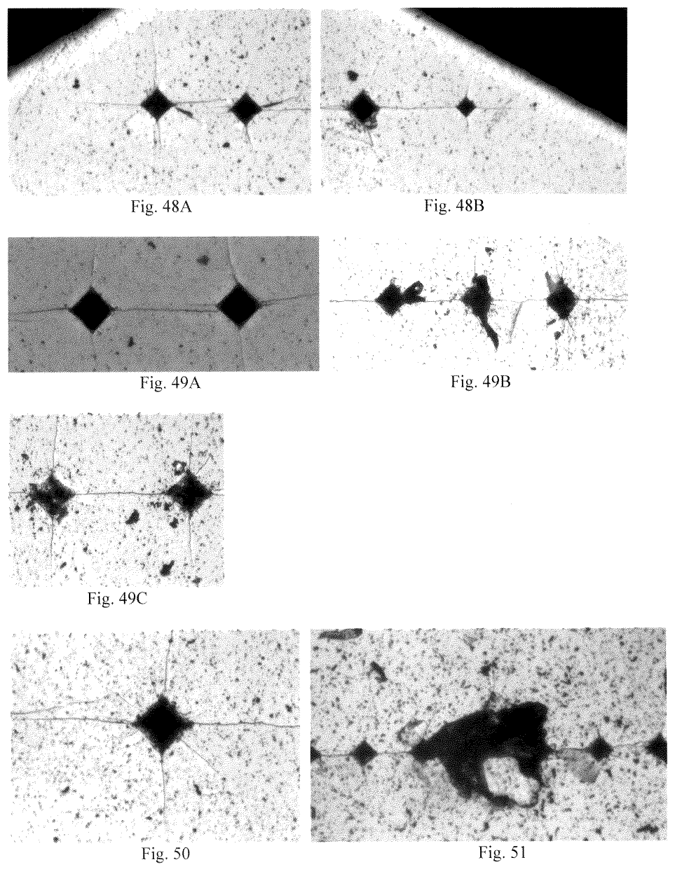

An interesting feature of the low-load line indentation at a spacing of 2c (equal to the length of the crack, 100 μm for 2 kg) is the suppression of the vertical crack. While Vickers indentation produces two equal orthogonal cracks along the two diagonals, placing the indents in proximity of each other such that the ends of their horizontal cracks touch, suppresses the vertical crack in favor of the horizontal cracks. This is beneficial for cleavage as the orthogonal crack is a nuisance and must get rid of it by grinding the edge of the wafer at the end. Furthermore, it helps guide the crack of the higher load that follows on top of it. Similarly, 3 kg indentations (2c=130 μm) produce straight cracks and suppress the orthogonal crack, as shown in FIG. 13, FIG. 27 and FIG. 47. This has also been observed with 5 kg (2c=200 μm) but to a lesser extent. FIG. 48A shows a 5 kg indentation (to the left) with clearly visible vertical cracks where the horizontal cracks did not connect. By contrast, FIG. 48B shows a similar indentation whose horizontal crack connects to another indentation but the vertical crack is absent. When the cracks link the fracture energy is sucked from the vertical crack and channeled into the horizontal crack which becomes more pronounced.

The cracks between adjacent 5 kg indentations connect when they are well aligned, as shown in FIG. 49A, FIG. 49B and FIG. 49C.

When a second line indent with a higher load is superposed over a first line with a lower load the square traces are smudged. The overlap of indentations causes chipping which obscures the cracks.

Since it is desired to use 20 kg instead of 30 kg, a 20 kg indentation has a crack length of about 500 μm end-to-end, at a pitch of 500 μm. FIG. 50 shows a typical 20 kg indentation with its unmistakably long cracks. The horizontal field of view in the picture is 600 μm.

The damage to the SiC surface becomes more pronounced as the load is raised to 20 kg and the pitch is decreased from 500 μm to 125 μm. Our initial strategy was to ramp up the load gradually from 1 kg to 20 kg. However, in the interest of rapid wafering we applied the 20 kg directly on top of the 2 kg line. In the case of 500 μm pitch each 20 kg indentation coincides with every fifth 2 kg indentation. FIG. 51 shows 20 kg indentations at a pitch of 500 μm superposed over a 2 kg line indent at a pitch of 100 μm. Since the pitch of 20 kg is an integer multiple of 100 μm the 20 kg indentation coincides with a 2 kg indentation. Otherwise it falls on the crack between indents. The 2 kg line helps guide the horizontal crack of the 20 kg indentation and suppresses the vertical crack to a certain degree compared to the 20 kg point indentations in FIG. 50 in spite of the chipping that occurs under this load.

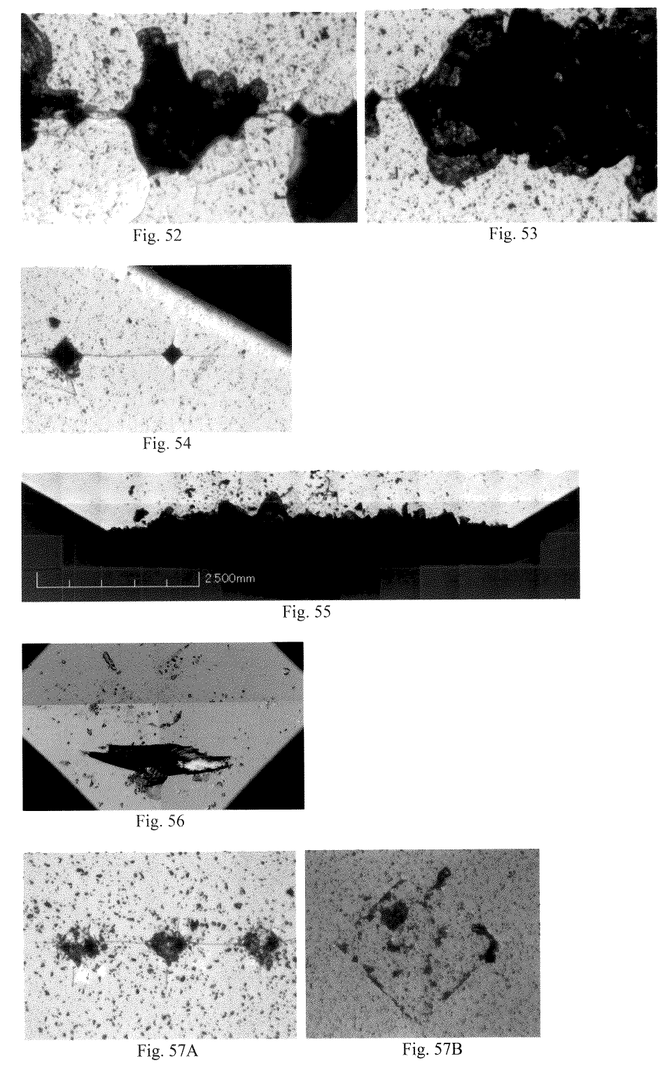

The damage to the surface increases as the pitch is decreased to 400 μm, as seen in FIG. 52. The damage increases sharply as the pitch is reduced to 250 μm and below, as shown in FIG. 53.

The edge chips sometimes. For this reason the load is reduced to 1 kg, 2 kg and 5 kg in the last 500 μm near the edge. Nevertheless, the crack reaches the edge, as seen in FIG. 54.

30 kg when applied over 1 kg indentation line produces even more damage to the surface. Both 20 kg 200 μm and 30 kg 300 μm applied on top of 2 kg 100 μm cleaved, as shown in FIG. 55. The cleavage line is straight, even though it appears curved due to chipping on the surface.

Subsequently, we indented with 20 kg at various pitches directly on the surface without a prior line indent made with a smaller load. When the pitch is reduced to 250 μm and 125 μm, significantly more damage occurred. When the pitch is below 200 μm the surface damage of the successive indents due to chipping merge and obscure the cracks and severe damage to the Vickers occurred.

The concept of indenting with a higher load over a smaller load like 1, 2 or 3 kg is that the smaller load yields a straight connected crack which helps guide the crack of the higher load. We indented over a smaller load and reduced the pitch to straighten and spread the crack between indents. It was also hoped that reducing the pitch would help the cleavage. It did. However, these measures damaged the Vickers prematurely.

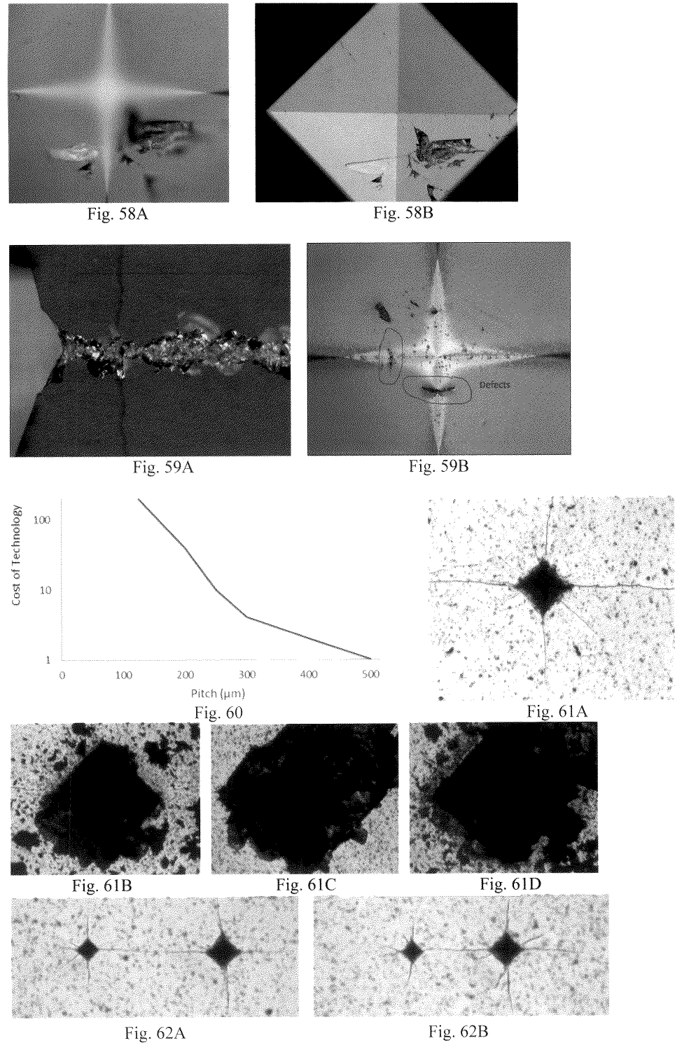

It is clear that indenting over a previous line indent or reducing the pitch of 20 kg causes significant damage to the SiC surface and to the Vickers indenter as well. The Vickers was damaged after 120 indentations at a pitch of 200 μm and after 80 indentations at a pitch of 125 μm. FIG. 56 shows the damage to the Vickers tip. The picture was taken on-axis with a Keyence laser scanning confocal microscope model VK-X 3000 with 1000× magnification. The damaged Vickers tip produces incomplete or barely recognizable traces of indentations under 1 kg and 5 kg, as shown in FIG. 57A and FIG. 57B, respectively. The inspection shows no cracks under the surface, except that the tip was flattened.

Conclusion: We need a different way of creating a straight long and deep crack for the wedge to propagate while extending the lifetime of the Vickers tip.

The extent of the damage to the tip was about 300 μm which is repairable. The Vickers can be re-sharpened and re-used several times. We have re-polished the facets of some Vickers tips 5 or 6 times thereby amortizing the cost of the Vickers over several lifetimes. Even though the Vickers tip is crushed and cannot make perfect square indentations but it still connects the cracks, as can be seen in FIG. 57A which shows the connected cracks of 1 kg tests after 20 kg and 30 kg indentations over 1 kg line indent. Thus, even though the Vickers tip is partially damaged, but it still functions which extends the useful lifetime of Vickers and reduces the cost of this technology.

However, in some cases a crack develops inside the diamond, as shown in FIG. 58A and FIG. 58B. This reduces the lifetime of the Vickers to 3 or 4 re-cuts.

The profile and depth of the damage on the facet as well as junction offset or width of the apex can also be measured using the 3D laser scanning feature of the microscope. The profile of the tip is measured along two orthogonal directions and the difference between the two lengths is the junction offset. This is how the Vickers is certified for hardness measurements. However, in our case we do not need certification, which makes this technology even cheaper.

When the Vickers is used to indent over a previous line indent or the pitch is reduced it lasts only a hundred times or so. Whereas when it is used to indent the virgin surface under the same load of 20 kg at a pitch 2c=500 μm equal to the crack length without interference from a crack or a previous indentation it lasts thousands of times. A potential reason for the observed heavy damage sustained by the Vickers could be the tip falling over a crack, similar to breaking the edge of the piece and falling off the cliff. FIG. 59A and FIG. 59B show a 30 kg line indent which broke the edge and the resulting damage to the oblique diagonals of the Vickers, respectively.

When the tip falls on a crack it damages the Vickers. We can eliminate the misalignment error by re-indenting with 20 kg over the same spot multiple times to enlarge the diagonal before moving to the next spot. An array of original 20 kg indentations is made first and then each indentation is revisited several times with 20 kg. The spacing between successive indents is made equal to 2c (500 μm for 20 kg) so that the cracks touch at their ends. In this way the crack of one indent does not interfere with the next indentation. The idea is that the diagonals of adjacent indentations touch each other at the corners. This will help straighten the cracks because the cracks underneath the diagonals are straight. This will provide better seating for the wedge to drive the crack. Thus, it would be best to keep the pitch at 500 μm and to straighten and link the cracks between adjacent indents.

### Cost of Indentation Technology Vs Pitch

A boule is an 8″ diameter disk×2 cm thick which is to be sliced into 40 wafers, 0.5 mm thick each. The perimeter of an 8″ disk is roughly 25 inches. Thus, the total length that needs to be indented to separate the boule into 40 wafers is 1,000 inches. The question is how many Vickers are needed to cover this entire length? This depends on the pitch between indentations. As the indentations are brought closer together the crack becomes fuller but the Vickers wears off faster. The graph in FIG. 60 plots the cost of the technology in terms of the number of Vickers used to indent the boule, semi-logarithmically vs pitch as a multiplier of the cost of the 500 μm pitch. When the pitch is reduced to 400 μm the cost doubles, and when it is reduced to 300 μm it quadruples. When the pitch is halved to 250 μm it is 10x. At 200 μm it is 40x and when the pitch is reduced further to 125 μm it rises rapidly to 200×. It is compounded due to faster wear rate of the Vickers plus the fact that more indentations are needed to cover a certain length as the pitch is reduced. The cost is actually steeper due to the downtime to repair or replace the Vickers. Thus, the cost is very sensitive to the pitch. For this reason, we will keep the pitch @ 500 μm. We found that a load of 20 kg at that pitch yields a crack deep enough that can be propagated with the wedge to cleave. Only one 2 kg or 3 kg indentation is needed half-way between the 20 kg indents to guide and link the cracks.

Re-Indenting with 20 kg at the Same Spot Thousands of Times Did not Damage the Vickers

We indented at the same location with 20 kg 600 times. The machine was programmed to go up and down and apply a load of 20 kg every time. The program stopped automatically every 40 indentations to inspect the Vickers. The tip was still intact after these indentations as observed from the 1 kg and 5 kg test results. The 1 kg test is particularly sensitive to damage. It left perfect square traces. Then we moved to another location 500 μm away and repeated the same sequence and then to a third spot and did the same for a total of 1,800 indents. The tip of the Vickers was still good after all these indentations, and the proof is that it was able to go from one spot to the next and originate a new crack every time. If the tip were damaged it would not be able to penetrate the material. In these 1,800 indentations there were 3 original indentations where the tip touched the surface and 1,797 re-indentations where the Vickers tip fit in the pit that it had already created. Re-indenting with 20 kg over a previous 20 kg even thousands of times does not damage the tip because the first indentation creates a crack under the diagonal. So, when the tip comes the second time, it encounters empty space at the bottom of the pit. The Vickers touches the walls of the inverted pyramid on its sides. Whereas, re-indenting with 20 kg over 2 kg did damage after a hundred times, as noted above. This is due to the higher positioning accuracy required to align the Vickers over 2 kg because the 2 kg diagonal (30 μm) is smaller than that of 20 kg (125 μm) and the crack of 2 kg is narrower than that of 20 kg. A slight misalignment causes the tip of the Vickers to touch an uneven surface which causes damage. By contrast, when the original indentation is made with 20 kg, the diagonal and the crack are wide enough to accommodate misalignment errors.

Even if the tip damages, the Vickers can keep re-indenting hundreds of times. Similarly, even if the tip of the wedge damages, it still works because the tip does not touch the surface. This is proof that this technology is economical. We can continue using the Vickers to widen the diagonal after the tip has damaged. Furthermore, the tip can be resharpened and reused several times.

The diagonal grows with every re-indentation from 125 μm initially to about 380 μm after 40 re-indentations and reaches a plateau after 200 re-indentations where the square indentation clearly emerges after it clears the lateral cracks with a diagonal of about 500 μm. At this width, the diagonals from two adjacent indentations 500 μm apart will touch at the corners, thereby providing seating for the wedge regardless of the straightness of the crack. When the wedge is well seated in the diagonal, it pushes against the walls of the inverted pyramid to spread and connect the cracks. FIG. 61A, FIG. 61B, FIG. 61C and FIG. 61D show the original 20 kg indentation; after 40 re-indents; after 200 re-indents; and after 1,200 re-indents, respectively. The horizontal field of view in the picture is 600 μm and the vertical is 480 μm.

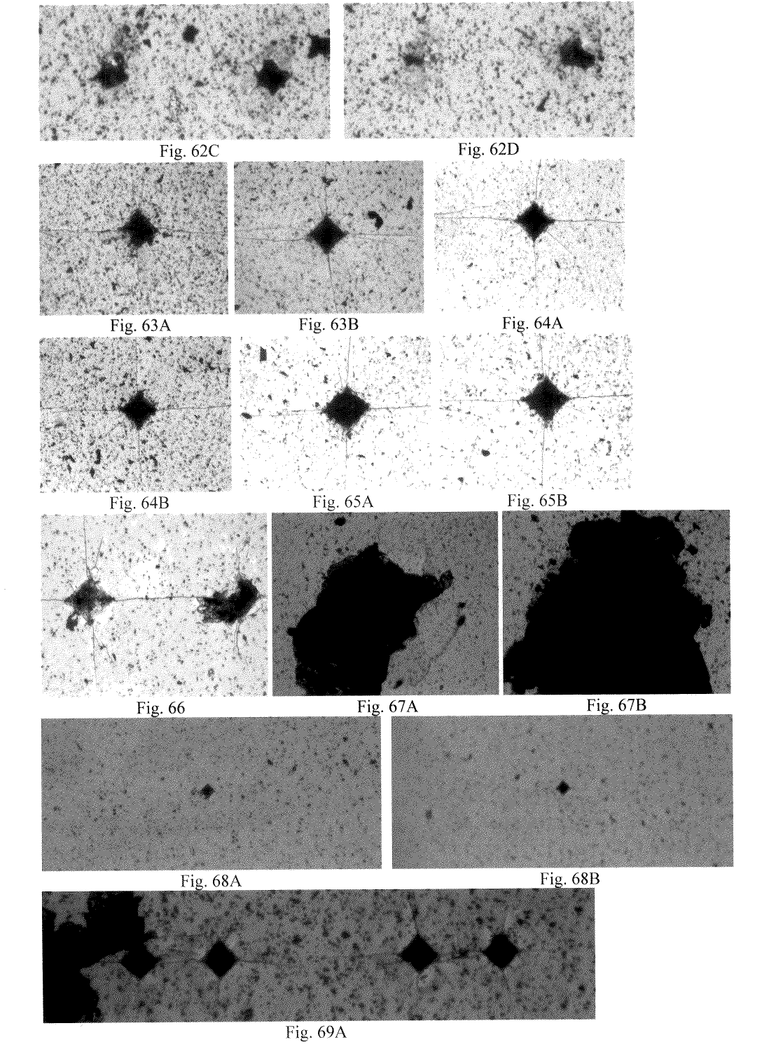

We made 615 original indentations with a load of 20 kg @ a pitch of 500 μm with a new Vickers tip. Each point was re-indented 40 times in order to test the lifetime of the Vickers. Thus, there were a total of approximately 25,000 re-indents. The machine was running non-stop for several days to make all these indentations. The Vickers survived until the end. FIG. 62A, FIG. 62B, FIG. 62C and FIG. 62D show the 1 kg and 5 kg inspection tests after 10,000, 20,000, 24,000 and 25,000 indentations, respectively. The Vickers tip started showing signs of damage at 24,000 re-indents and severely damaged after 25,000 re-indents. As expected, the 1 kg trace is more susceptible and reveals the damage before the 5 kg load. Nevertheless, it is worth noting that the Vickers can continue re-indenting thousands of times more because the tip is not involved during a re-indentation. The Vickers is still useful after it has lost its tip. It just cannot initiate a new indentation or extend the crack. However, it can be re-sharpened several times and re-used to make new indentations. Hence the economy of this technology. Therefore, our strategy is to make as many original indentations as possible (about 2,000) with a good tip first then re-indent at those locations. This will make most efficient use of the diamond tip.

### Lifetime of 20 kg @ a Pitch of 400 μm

The 400 μm pitch caused less chipping compared to the 300 μm pitch but has a significantly shorter lifetime than the 500 μm pitch. The tip started showing signs of damage after 200 indents and was completely damaged after 600 indents. FIG. 63A and FIG. 63B compare the traces of 20 kg at 400 μm and 500 μm pitches after 200 and 250 indentations, respectively. At 400 μm the indentation is affected by the previous crack to the left as the indentation line was carried from left to right because the pitch is <2c=500 μm. Whereas the 500 μm indents show no such damage even after 1,500 indents.

### Lifetime Measurements

### Lifetime of 20 kg

We programmed the machine to make an array of thousands of indentations with a load of 20 kg at a pitch of 500 μm. This took several days with the current machine. There were no re-indentations in this experiment. The purpose was to measure the lifetime of the 20 kg with no interference from the crack of the previous indentation. We were amazed how long the Vickers lasted. We stopped regularly to inspect the tip. After 1,000 indentations it still looked like new. It survived 2,000 original indentations (where the tip touches the surface) without signs of damage. We pulled the plug and stopped the experiment because it was taking too long.

The 20 kg cracks were remarkably long and straight and they linked. FIG. 64A and FIG. 64b show the 20 kg indentations and cracks after 1,000 and 2,000 indentations, respectively. Thus, the lifetime of the Vickers under 20 kg at a pitch of 500 μm is more than 2,000 indentations.

### Lifetime of 30 kg

Similarly, we programmed the machine to make an array of hundreds of indentations with a load of 30 kg at a pitch of 600 μm. There were no re-indentations in this experiment. The purpose was to measure the lifetime of the 30 kg with no interference from the crack of the previous indentation. We stopped regularly to inspect the tip. The 30 kg cracks are also straight and long and they connect, but there is more surface damage at 30 kg than at 20 kg, as expected. The cracks can be seen in spite of the chipping. The chipped areas border on the cracks. The Vickers lasted about 700 original indentations (where the tip touches the surface) under 30 kg @ a pitch of 600 μm. By contrast, when the pitch was reduced to 300 μm, the lifetime was reduced to 70 indentations, as mentioned above.

FIG. 65A and FIG. 65B show the 30 kg indentations after 300 and 600 indents, respectively. FIG. 66 shows that a damaged Vickers can still connect the cracks.

### SUMMARY

We reduced the pitch and indented over a smaller load to help the cleavage, but it damaged the Vickers prematurely. We found ways around that to link the cracks between adjacent indentations without damaging the Vickers. The cracks of 20 kg indentations are straight and they connect when separated by 2c=500 μm. 20 kg lasts 2,000 original indentations while 30 kg lasts only 700 times. We re-indented several times with 20 kg over each original indentation for a total of 25,000 re-indentations. This increases the size of the diagonal so that the diagonals of two adjacent indentations almost touch at the corner even though it does not extend the crack. This provides better seating for the wedge in the inverted pyramidal pit to spread the crack laterally between adjacent indents and extends the lifetime of the wedge because the tip of the wedge does not touch the surface. This helps the cleavage because the crack under the diagonal is straight.

Indentation with a small load, such as 2 or 3 kg lasts tens of thousands if not hundreds of thousands of indentations.

We have demonstrated that indenting over a smaller load or reducing the pitch of 20 kg was not necessary for cleavage. The original indentations are separated by a distance 2c equal to the length of the crack and the diagonals are enlarged by re-indentation. This extends the lifetime of the Vickers by two orders of magnitude which makes this technology economical. The Vickers kept creating cracks even after being partially damaged. We can cleave with a damaged Vickers as long as the original indentations were done with a sharp tip.

### CONCLUSIONS

20 kg produces a crack long and deep enough to be propagated with a wedge to cleave.
The lifetime of 20 kg is about 3× that of 30 kg. For this reason, we will use 20 kg instead of 30 kg, especially that we have demonstrated cleavage from a 20 kg indentation line.
The Vickers survives thousands of indentations under 20 kg because its angle is blunt (136°). Therefore, there is no need to coat the Vickers tip with nano-crystalline diamond (NCD) layers. This makes this technology even cheaper.

### Number of Indentations

We are proposing machining expensive materials by indentation. This will require hundreds of thousands of indentations, which will wear out the indenter. One way to extend the lifetime of the indenter is to reduce the number of indentations by increasing the distance between indents. But this will require longer cracks and higher loads which will wear out the indenter faster. We found a load/pitch combination (20 kg, 500 μm) that prolonged the lifetime of the Vickers. We enlarged the diagonal by repeated application of the load at the same point without damaging the Vickers tip. This will provide better seating for the wedge, even though it does not extend the crack. We spread the cracks laterally between indents with a micro-wedge applied to each indentation. This helped the cleavage because it created a long and connected crack. This makes this technology economical.

We do the indentations with a blunt angle (Vickers) 136° and extend the crack with a sharp angle (Wedge 60°-75°. Sharper indenters produce more strain and longer cracks under a given load, but wear out faster. For this reason, we create the initial crack with a blunt tip and drive the crack with a sharp tip. This will extend the life times of both the Vickers indenter and the wedge non-indenter because the tip of the wedge does not touch the surface, rather it drives the crack on its sides. The wedge is applied once for every 10 indentations. A single Vickers tip survived 2,000 original indentations and 25,000 re-indentations under loads of 20 kg and 50 kg. A micro-wedge survived 500 applications under loads of 20 kg and 30 kg. Thus, the Vickers does not need to be coated with a nano-crystalline diamond layer, whereas the sharp wedge could benefit from NCD coating.

Even though the cracks are straight and they connect but they are shallow at the tip. A novel technique was demonstrated by applying a micro-wedge at each indentation to deepen and spread the cracks laterally where they meet at their tips. We improved the cleavage using this technique.

In a previous experiment we re-indented 200 times with 20 kg at the same location to broaden the diagonal from 125 μm to 500 μm. For the sake of rapid wafering, we would like to reduce the number of re-indentations needed to reach 500 μm. We discovered that fewer than ten 20 kg indentations spaced at a pitch of 500 μm with only a single 3 kg indentation in between were enough to produce a straight and connected crack and extended the lifetime of the Vickers beyond 2,000 indents. The 3 kg cracks influenced and guided the 20 kg cracks. This not only reduces the cost of our wafering technology but also increases the throughput which makes it competitive with the multi-wire saw.

Increasing the Load Gradually from 2 kg to 50 kg

Even though we had previously ruled out the use of 20 kg directly on top of 2 kg because it damaged the Vickers prematurely, but we tried it just to see what happens. However, this time we increased the load gradually by re-indenting with a particular load just enough times to increase the diagonal to the next level, and so on and so forth until the desired size is reached. This turned out to be the key to extending the lifetime of the Vickers and saving time by reaching the final size of the diagonal with the minimum number of re-indentations.

The following table shows the sizes of the diagonal and the crack vs load from 2 kg to 50 kg

| | | Length of crack from |
|---|---|---|
| Load kg | Length of diagonal d μm | end-to-end 2c μm |
| 2 | 34 | 100 |
| 3 | 41 | 130 |
| 5 | 64 | 200 |
| 10 | 90 | 300 |
| 20 | 125 | 500 |
| 30 | 150 | 600 |
| 50 | 190 | 880 |

Thus, in principle, according to the second column in the table, one could indent a few times with 2 kg to increase the diameter from 34 to 41 μm, at which point one would switch to 3 kg and continue indenting, then upon reaching 64 μm switch to 5 kg and repeat the process, and so on and so forth each time going one size up in the table until the diagonal is enlarged to 190 μm at which point a few indentations with 50 kg would bring it up to 500 μm. We discovered shortcuts where we can skip some weights and reach the final diagonal in shorter time. This does not damage the Vickers, but it does not extend the crack either. Repeated indentation at the same location even with a higher load does not increase the length of the crack. So, if we start with 2 kg, then we cannot reach the final crack size of 500 μm. Furthermore, there is a big difference between the cracks of 20 kg on top of 2 kg and 20 kg alone. The 20 kg indentations produce the nicest squares and the longest and straightest cracks with the least surface damage and they connect. For this reason, we will start with 20 kg.

The load on the Vickers was increased from 2 kg to 50 kg. After 5 applications of the 2 kg the diagonal grew to 85 μm, so there was no need for either 3 or 5 kg. We went directly to 10 kg. And after one application of 10 kg it grew to 125 μm, so we went directly to 20 kg. We applied 20 kg only once and the diagonal grew to 171 μm, so we went directly for 50 kg. We skipped 30 kg. At this point we applied 50 kg 12 times to bring the diagonal up to 500 μm.

The diagonal grows fast upon application of the 50 kg. A diagonal of 400 μm is reached within a few applications of 50 kg, a total of 20 indentations starting from 34 μm. The 1 kg inspection is the best indication of whether damage occurred to the Vickers tip. FIG. 67A shows that the diagonal grew to 295 μm after 1^{st} application of the 50 kg. FIG. 67B shows that the diagonal grew to 500 μm after 12^{th} application of the 50 kg. FIG. 68A and FIG. 68B show the 1 kg test indentations after 1^{st} and 12^{th} applications of the 50 kg, respectively which indicate no damage to the Vickers after the entire sequence. This illustrates that starting from a small diagonal we can reach the final size without damaging the Vickers. The key is re-indenting with the same load to increase the diagonal ‘adiabatically’ to the next size before increasing the load. We can skip a few loads. This provides a smooth transition and reduces the wear to the diamond. This is the most efficient and fastest way to reach the biggest diagonal. Furthermore, there is no need to start from 2 kg. We can save time by starting from 20 kg and going directly to 50 kg, i.e. skip 30 kg. We discovered that with two applications of 20 kg followed by 3 or 4 applications of 50 kg we can reach a diagonal of 400 μm which is sufficient to seat the wedge and drive the crack. The length of the micro-wedge can be tailored to fit in the diagonal.

Having established that a combination of 20 kg and 50 kg was sufficient to enlarge the diagonal we proceeded to determine the minimum number of indentations needed to reach maximum diagonal. We already knew from the previous experiment that only a couple of 20 kg plus a few 50 kg indents could reach 400 μm. The crack does not grow upon successive re-indentations, only the diagonal grows. Re-indentation unavoidably causes the lateral cracks that formed during the previous indentation to chip away and obscure the surface. The original cracks are evident in spite of the surface damage. The diagonal grew from 125 μm to 200 μm after the 1^{st} 20 kg re-indent, and was 212 μm after the 2^{nd} 20 kg re-indent. So, we could apply 50 kg immediately after the 1^{st} 20 kg re-indent. The diagonal then grew to 300 μm after the 1^{st} 50 kg re-indent, 350 μm after the 2^{nd} 50 kg, 380 μm after the 3^{rd} 50 kg, and 400 μm after the 4^{th} 50 kg, and did not grow much after that. So, there was little benefit in going beyond 3 or 4x 50 kg indentations, and only one 20 kg re-indent was sufficient to start the 50 kg. Thus, a total of 5 or 6 indentations (2×20 kg+3 or 4×50 kg) are sufficient to reach the final diagonal. This is a major development which decreases the time of wafering and increases the throughput significantly, and makes our technology competitive with the wire saw time wise and cost wise, all while extending the lifetime of the Vickers indenter.

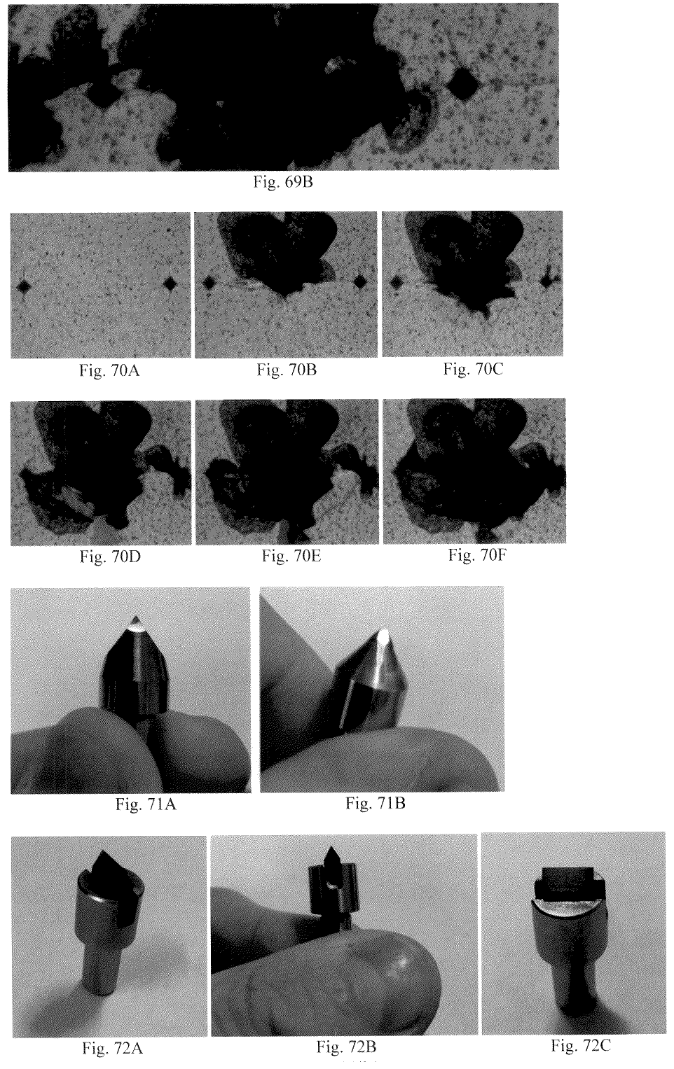

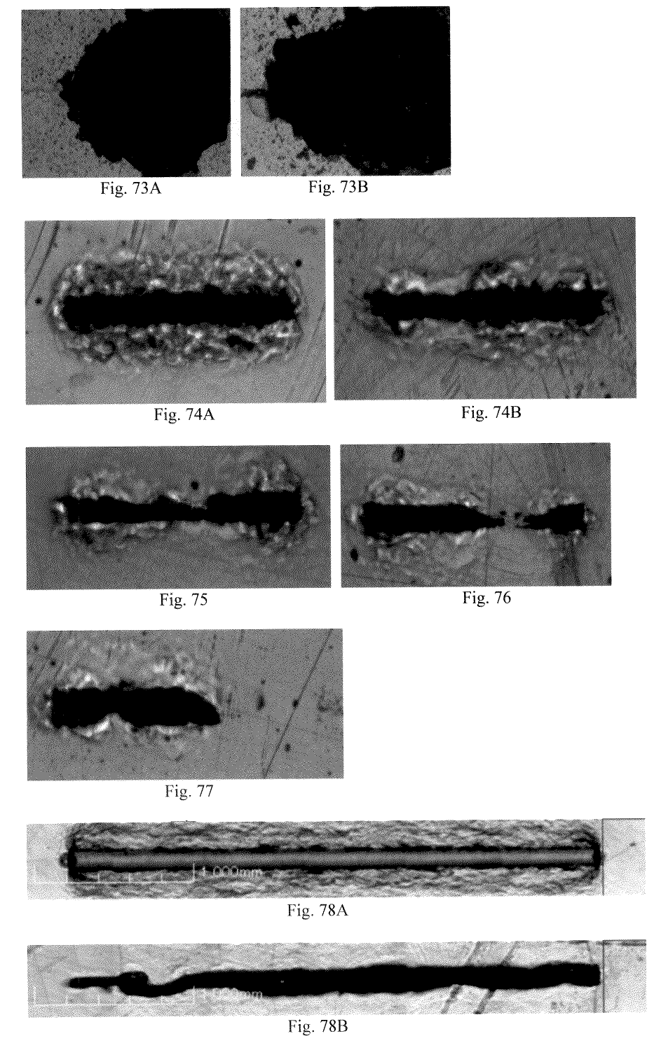

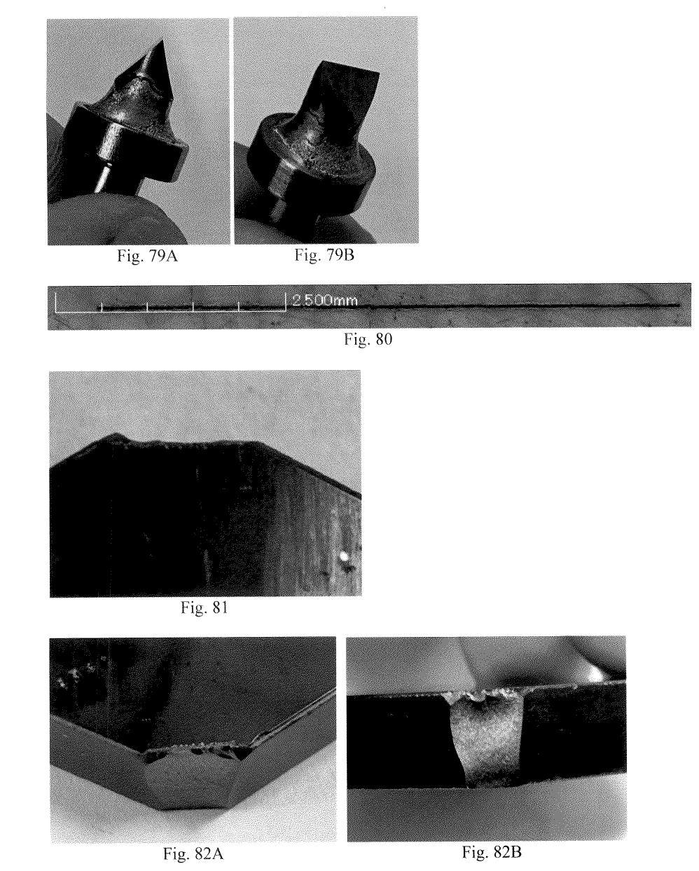

Even though we ruled out the use of 2 kg under the 20 kg indentations, but it could be useful between the 20 kg indents. The 2 kg cracks guide and connect the 20 kg cracks. The 20 kg was placed between 2 kg indentations. The distance between the inner 2 kg indentations was increased to accommodate the 20 kg indentation symmetrically in the middle without interference from the 2 kg cracks. FIG. 69A shows the 2 kg indents before, and FIG. 69B after application of the 20 kg. It can be seen by comparing the two pictures that the rightmost crack of the 2 kg which was not noticeable before the 20 kg is now longer, stronger and more pronounced. This shows that the 20 kg indentation when placed between (rather than on top of) 2 kg indentations it extends the crack. This is clear indication that the 2 kg cracks guide the 20 kg crack. The 2 kg indentations suppress the oblique 20 kg cracks in favor of the baseline crack.

The 50 kg should not be applied closer than 500 μm from the edge, otherwise it breaks the edge. In the last 500 μm near the edge the load can be tapered down to 20, 10, 5 and 2 kg to create a continuous crack that reaches the edge, as shown in FIG. 48B.

Even though the Vickers tip may be damaged and cannot make 1 or 2 kg indentations, but it could still make perfect 20 kg original indentations with long and straight cracks.

A total of 5 or 6 indentations (2 or 3×20 kg+3×50 kg) are sufficient to reach a diagonal of 400 μm which provides adequate seating for the wedge.

So, we started using only one 2 kg indent between 20 kg indentations and spaced them 500 μm apart. At this distance the cracks of the 2 kg do not affect the 20 kg indentations. We also used 3 kg. Both the 2 kg and the 3 kg connect the cracks of the 20 kg. Thus, only a single 2 kg or 3 kg indentation between 20 kg indentations is sufficient to guide the cracks of 20 kg. This reduces the total number of indentations per boule and speeds up the cleavage and extends the lifetime of the Vickers.

The sequence of pictures in FIG. 70A, FIG. 70B, FIG. 70C, FIG. 70D, FIG. 70E, and FIG. 70F show the evolution of the radial and lateral cracks after the application of 2×20 kg+3×50 kg. FIG. 70A shows the initial 3 kg indentations 500 μm apart. A lateral crack developed after the second application of 50 kg, which can be seen clearly in FIG. 70E. The chipped area broke off after third application of 50 kg, which obscured the indentation underneath.

### Application of Micro-Wedge and Macro-Wedge

Having widened the diagonal with a few applications of 20 kg and 50 kg, it is time to apply the micro-wedge. The concept of micro-wedge is explained in Appendix 2 below. We used the same trick for Vickers to extend the lifetime of the micro-wedge.

Two wedges are used for cleavage, a micro-wedge and a macro-wedge. Both have sharp angles between 60° and 75°. The micro-wedge is made of diamond and its shape and dimensions are similar to those of Vickers, except that the tip is longer. The tip of the micro-wedge is made a little shorter than 400 μm to fit in the diagonal. The angle of the micro-wedge is 75° because it is more difficult to cut a diamond at 60° and hold it in the metal matrix. The macro-wedge is made of tungsten carbide (WC) with 11% cobalt (Co) content and has an angle of 60°. The length of the macro-wedge can be 1 cm or longer and covers the entire indentation line.

First, the micro-wedge is applied at each Vickers indentation after the sequence of 20+50 kg to spread the crack laterally between indents. This is aided by the presence of the 3 kg indents half-way between the 20 kg indentations. After the cracks from adjacent indentations are linked to form a straight and long crack along the surface then the macro-wedge is applied once to the entire line to drive the crack in the depth and cleave a piece of material.

FIG. 71A and FIG. 71B show a micro-wedge which has a tip angle of 75° and length about 350 μm. This insures that the tip of the micro-wedge fits in the diagonal and avoids touching the surface. It has a metal holder which bolts to the hardness tester. The 20 kg or 50 kg load is borne by the annular area around the shaft. FIG. 72A, FIG. 72B, and FIG. 72C show pictures of the macro-wedge. Both wedges were aligned perfectly to the diagonal of the Vickers indentation using the objectives of the microscope built in the hardness tester.

FIG. 73A and FIG. 73B show before and after application of the micro-wedge, after application of the 3^{rd} 50 kg load. The extension and thickening of the crack to the left due to the micro-wedge is very apparent.

### Lifetime of Micro-Wedge

We applied the micro-wedge to each indent in an array after 2×20 kg+4×50 kg Vickers applications at each point. First, we applied 20 kg on the micro-wedge, then we raised the load to 30 kg because it has an angle of 75° instead of 60°. We stopped after a certain number of applications and inspected the tip of the micro-wedge under 2 kg in a brass test block for signs of damage. FIG. 74A and FIG. 74B show the micro-wedge traces new and after 150 applications, respectively. The micro-wedge was going strong with almost no signs of damage after 150 applications of 20 kg. So we continued to 400, inspecting every 50 applications. FIG. 75 shows the trace in brass test block after 400 applications.

Most of the trace of the micro-wedge remained at full width after 400 applications except for a short section toward the middle which became thinner. This trend continued until the trace broke off completely after 500 applications, but the overall length of the trace remained the same, as shown in FIG. 76.

Thus, the lifetime of the micro-wedge is about 500 applications @ 20 kg. It is worth noting, however, that the micro-wedge can continue doing its job of spreading the crack laterally even though the tip is damaged because it is not indenting. The tip is not supposed to touch the surface. By contrast, 30 kg shortens the lifetime of the micro-wedge considerably, like it did for Vickers. FIG. 77 shows the deformation of the trace after only 200 applications @ 30 kg. Furthermore, the length of the trace in brass also shrank indicating that the tip of the wedge lost a piece near the corner. This was confirmed by visual inspection with a loupe. Nevertheless, the micro-wedge can be repaired.

Another advantage of confining the micro-wedge to the inverted pyramidal pit is that it is guaranteed to have a crack underneath it. The crack may not be straight on the surface, but it is always straight under the diagonal. The depth of the Vickers indentation is equal to ( 1/7^{th}) the diagonal. For a diagonal of 400 μm, the depth=57 μm.

### Lifetime of Macro-Wedge

FIG. 78A and FIG. 78B show the traces in brass of a new and a damaged macro-wedge of length 3.35 mm, respectively. Similarly, the macro-wedge is not an indenter. Its tip is not supposed to touch the surface. This damage indicates that the tip did contact material at some point along the length, most likely because the crack was not perfectly straight.

FIG. 79A and FIG. 79B show a macro-wedge made of tungsten carbide whose angle is 60° and length ¼″=6.35 mm. FIG. 80 shows the trace of the macro-wedge in brass test block. The uniform width of the trace indicates perfect parallelism between tip of the wedge and its base.

### Conclusion

The micro-wedge has a lifetime of about 500 applications, whereas the Vickers has a lifetime of over 2,000 original indentations. The micro-wedge is expected to have a shorter lifetime than Vickers because it is sharper. Thus, the Vickers does not need to be coated, but the micro-wedge could benefit from coating with nano-crystalline diamond (NCD) layers to extend its lifetime. Similarly, the macro-wedge which is made of tungsten carbide can benefit from NCD coating.

At 20 kg, the micro-wedge cannot extend the crack along the depth, but it can spread it laterally between adjacent indents when it is applied in the diagonal pit. The concept of the micro-wedge is explained in Appendix 2 below. However, the effect of the micro-wedge cannot be seen at a single point. It creates a long straight and connected crack. It is only after the macro-wedge is applied that the effect of the micro-wedge becomes evident as it reduces the force needed to drive the crack and produces a smooth and controlled cleavage. Conversely, the macro-wedge should not be applied until the micro-wedge has done its job linking and straightening the cracks.

It is critical to align the micro- and macro-wedges to the Vickers, the camera and the x-y stage axes, especially that the chipping obscures the cracks. This is accomplished by aligning their traces to the axes of the screen through trial and error over a few iterations. The turret of a hardness tester can have up to six holes, three of which are used for the Vickers, micro- and macro-wedges and the other three for the objective lenses with different magnifications. The rotation of the turret places the wedges precisely over the diagonals of the Vickers indentations. This avoids misalignment errors due to replacing the Vickers with the wedge in the same hole.

### Summary of the Cleavage Process

A line indent is first made with a 20 kg load inter-spaced with 3 kg indents @ 500 μm pitch. Then every point is revisited with 2×20 kg+3×50 kg to broaden the diagonal to 400 μm. Ideally, the micro-wedge is applied with 20 kg once at every point immediately after the last 50 kg application of Vickers before moving on to the next point. After the micro-wedge has been applied to each indentation then the macro-wedge is applied once to the entire line. We have improved the cleavage using this technique.

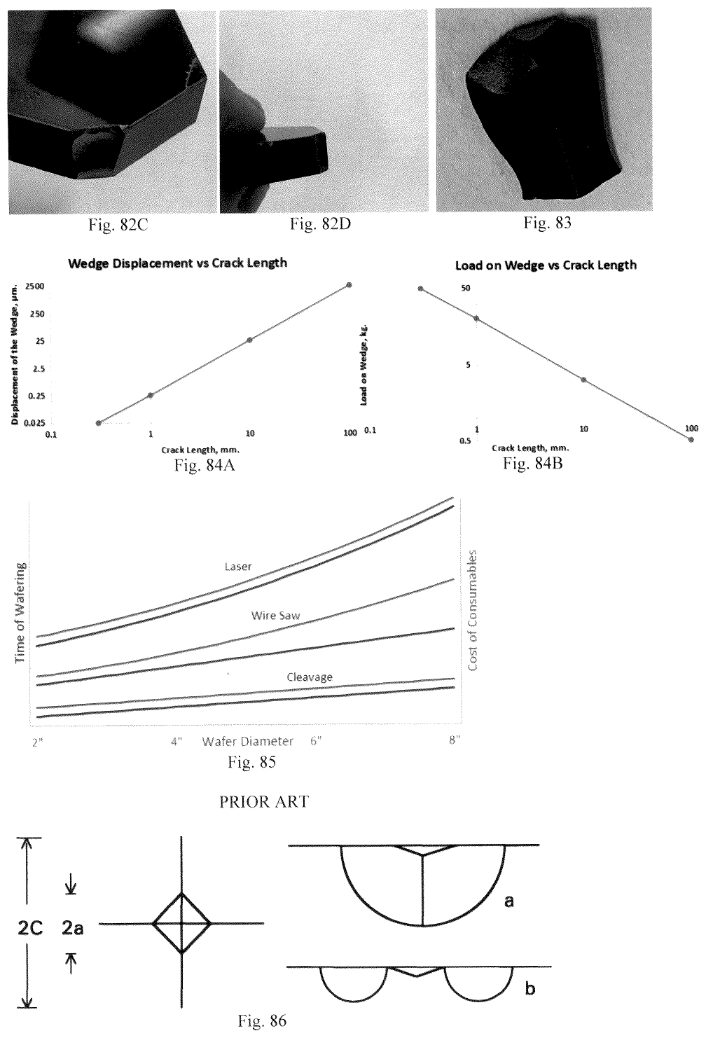

FIG. 35 and FIG. 36A show the red dotted line and the actual indentation line 6.35 mm long near the corner of the hexagon, respectively. FIG. 81 shows a top view of the cleavage along the indentation line. The indentation (and micro-wedge application) proceeded from the center of the line toward the edges alternating between left and right. The load was reduced in the last 0.5 mm near the ends to avoid breaking the edge. FIG. 82A, FIG. 82B, FIG. 82C, FIG. 82D and FIG. 83 show the cleaved surface and cleaved corner piece, respectively. The cleavage is not perfect because the material is poly-crystalline.

### Overview and Summary of Results

We cleaved a small piece of silicon carbide about 1 cm×8 mm×2 mm from the corner of a hexagon starting from the indentation line. The cleavage was not perfectly straight and vertical because it is poly-crystalline material but it proves that we can indent and propagate the crack using the same machine. This is important because we can replace the Vickers with a wedge in the machine without losing alignment. The wedge must be perfectly aligned with the Vickers to propagate the crack. A 20 kg load yields a crack about 250 μm deep that can be propagated with the wedge. The cracks along the diagonals of the adjacent indentations are linked to form a long straight and deep crack, which is then propagated by applying 50 kg on a wedge. The optimal spacing between 20 kg indentations is a pitch of 500 μm. A 3 kg indentation half-way between the 20 kg indentations connects the 20 kg cracks and yields a crack suitable for cleavage with the least number of indentations.

We cleaved the corner of the hexagonal tile along its thickness which is far from symmetrical. Furthermore, poly-crystalline materials do not cleave like single crystal. Also, the machine was not displacement-controlled which is necessary for stable crack propagation. For these reasons, the cleavage was not straight. We demonstrated the feasibility of driving the crack with a hardness tester. Our focus was to minimize the wear rate of diamond consumables and extend the lifetime of Vickers indenters.

We have demonstrated straight and vertical cleavage of single crystal substrates as thin as 0.5 mm thick. However, the maximum thickness that can be cleaved is also relevant because we have to start from a boule which can be up to 2 cm thick and cleave all the way down to a single wafer.

Referring to equation (13) in Appendix 1 above, which is reproduced here for convenience.

$$P = \frac{3 {K}_{Ic}}{4 \sqrt{6}} \frac{B {H}^{3 / 2}}{( a + 0.677 H )} \qquad ( 13 )$$

The force P needed to drive the crack goes as the product BH^{3/2} where B is the width of the cantilever and H is the thickness, as shown schematically in FIG. 41B. In the numerical example worked out in Appendix 1, B=1 cm and H=1 mm. This leads to a load on the wedge F_{w}=50 kg. For a thicker boule (H>1 mm), a higher force is needed which drives it beyond the capacity of this machine. Since the product BH^{3/2} must remain constant for a certain load, if H increases by a factor of 10, for example, then B must decrease by a factor of 30 to maintain the product constant. The highest load is needed at the very beginning when the original boule at full thickness (2 cm) is cleaved in half. In this case the thickness of each cantilever H=1 cm. Thus, B must be decreased to 330 μm to maintain the load at 50 kg. The wedge is applied at a pitch of 500 μm. This will require a load of 75 kg, which is feasible.

There is nothing special about 50 kg. It is just that the machine that we used had a capacity of 50 kg. We will build a custom fracture machine where we can easily apply a load of 75 kg or even 100 kg if needed. This can be accomplished using the same compact lightweight tabletop machine.

The energy needed to drive the crack, i.e. the product of the load times the displacement of the wedge, given by equation (9), however, is independent of the thickness of the cantilever, H.

$$U = \frac{{K}_{Ic}^{2}}{3} \frac{B a}{E} \qquad ( 9 )$$

The maximum cantilever thickness H that can be cleaved is 1 cm. This corresponds to a boule thickness of 2 cm. Thus, we can cleave a boule 2 cm thick. What is even more important is that we can cleave the thinnest “boule” consisting of 1 mm thick substrate down the middle plane into two 0.5 mm thick each.

We are able to cleave starting from an indentation load of 20 kg, instead of 30 kg, applied on a sharp diamond Vickers tip. This means that the Vickers will last longer which will reduce the cost of our technology.

A bare Vickers tip lasted more than 2,000 original indentations and over 25,000 re-indentations in SiC under a load of 20 kg, and continued to produce useful indentations even after chipping. A single Vickers tip, which costs about $100 in large quantities, can indent up to two 8″ wafers. Thus, the cost of diamond consumables is about $50/wafer. Another important finding is that the damage to the Vickers tip is repairable. Thus, the cost of the Vickers is amortized over several lifetimes. It was already established that we beat the wire saw and the laser in terms of kerf loss, speed and CAPEX. These results prove that our consumables are on par or even cheaper than the wire saw.

We can drive a crack with 50 kg starting from about 250-300 μm deep in SiC created by Vickers indentation with a load of 20 kg. This proves that initiating and propagating the crack can both be done using a single compact and lightweight tabletop machine which has a capacity of 50 kg. A picture of a hardness tester model CV400 ARS-20 with a motorized x-y stage, a computer, a controller and monitor made by Clark that we used in this project is shown in FIG. 25. This is significant because it streamlines the process. There is no need to transfer the boule from one machine to another to do the cleavage. The load necessary to propagate a crack depends only on the depth of the initial crack and is independent of the final length of the crack. It does not matter whether we cleave a 1 cm long piece or an 8″ wafer. The initial load needed to propagate the crack is the same for both. However, the wedge must be driven deeper into the material to sustain the longer crack.

The graphs shown in FIG. 84A and FIG. 84B plot the displacement of the wedge and the force on the wedge logarithmically vs crack length, respectively. These are related to the graphs shown in FIG. 43A and FIG. 43B which plot the displacement and the force on the cantilever vs crack length, respectively. A downward displacement of the wedge of 2.5 mm is needed to drive the crack 10 cm, which is equivalent to the radius of an 8″ wafer.

There is an inverse relationship between the load on the Vickers and the load on the wedge. The lesser the force used to create the initial crack, the higher the force needed to propagate it and vice versa. For example, if we use 30 kg to create the crack (instead of 20 kg) then we can propagate it with a force less than 50 kg, but the Vickers would damage prematurely. On the other hand, if we use less than 20 kg to initiate the crack, then a force higher than 50 kg would be needed to propagate it, which could damage the wedge. The 20/50 combination is optimal because it extends the life of both the Vickers and the wedge.

It was not known prior to this project that we could cleave with a hardness tester. This makes use of the same equipment that is commonly used to measure fracture toughness in ceramics by Vickers indentation and crack extension as described in ASTM standard C1421, except that the requirement on the control of the crack is more stringent. This project concerned the determination of the load, pitch, and lifetime of sharp diamond indenters. The cleavage proceeded from the indentation line according to cantilever beam theory. The cleavage along with the lifetime measurement constitute proof-of-concept.

The goal of this project was to reduce the rate of diamond consumption while indenting SiC. We discovered that reducing the load on the Vickers from 30 kg to 20 kg extends its lifetime by a factor of 3×. A bare Vickers tip lasts more than 2,000 original indentations and over 25,000 re-indentations in SiC under a load of 20 kg. It did not even reach the end of its useful life. We stopped the experiment prematurely because it was taking too long.

One of the goals was to coat the Vickers tip with a nano-crystalline diamond layer to extend its lifetime. We discovered that it does not need coating. This makes our technology even cheaper. However, the sharper angle wedge could benefit from NCD coating.

The coefficient of friction u between diamond and SiC is already low between 0.05 and 0.15 and rarely exceeds 0.2 [4]. For this reason, we were able to cleave with a reasonable force of 50 kg without the addition of any lubricant or graphene. Friction between diamond and SiC plays a central role in determining the load needed to propagate the crack. If the friction coefficient were higher then we would have needed a substantially higher force. The fact that we were able to cleave with 50 kg confirms that the friction coefficient is low.

We are proposing machining expensive materials by indentation. This will require hundreds of thousands of indentations, which will wear out the indenter and take a very long time. One way to reduce the number of indentations is to increase the length of the crack, but this will require either a higher load or a sharper angle which will wear out the indenter even faster. A 20 kg load at a 500 μm pitch yields the optimal combination. The indentation is done with a blunt angle of 136° and the propagation with a sharp wedge angle between 60° and 75°. This prolongs the life of both the Vickers and the wedge because the sharp edge of the wedge does not touch the material since it is not indenting. It fits in the diagonal and pries the crack open. This will accomplish the same goal of creating a deeper crack but with a smaller load with less damage to the diamond and the SiC. The process consists of 5 or 6 indentations with Vickers for each application of the wedge. We used a micro-wedge to spread the crack laterally between indents. This helps the application of the macro-wedge at the end to drive the crack in the depth. Furthermore, 30 kg produces more chipping on the surface of SiC which obscures the cracks and must be removed at the end. Thus, 20 kg is better for both diamond and SiC. This will minimize the amount of materials wasted which is the ultimate goal of this project.

The instant invention concerns creating the initial crack by indentation with a reduced load and then extending the crack laterally with a non-indenting wedge.

The rate of diamond consumption costs approximately $50 per 8″ wafer, which is even cheaper than the wire saw. This estimate is the same for single crystal or poly-crystal SiC. For this reason we used poly-crystal in our experiments because it is cheaper and yields the same results.

Coating of Diamond and Tungsten Carbide Tips with Nano-Crystalline Diamond Layers

The Vickers tip with a blunt angle of 136° does not need to be coated, but the diamond and tungsten carbide (WC) wedges having sharper angles of 60° or 75° could benefit from coating with a nano-crystalline diamond (NCD) layer. The idea is that NCD, being nano-crystalline, has higher fracture toughness compared to the bulk single crystal, and will have better wear resistance and extended lifetime under high loads. It would be beneficial to coat the sharp diamond tips with NCD layers and compare the performance of the coated and bare tips.

AFM tips have been coated with crystalline diamond layers, but sharp diamond tips that are used for indentation have not been coated with NCD layers before. The loads encountered during indentation of hard materials far exceed those encountered in the AFM. So, the question is whether the NCD coating would effectively protect the sharp diamond tip under high load.

Three types of diamond layers are grown by chemical vapor deposition (CVD) in a mild vacuum: Ultra NCD (UNCD), NCD and Diamond-like Carbon (DLC), which are distinguished by their grain size and surface roughness. UNCD has a grain size 5-10 nm, a surface roughness of 10-30 nm and can be grown at a temperature as low as 400° C. NCD has a grain size of 50-100 nm, a surface roughness >50 nm and is grown above 800 or even 900° C. DLC is amorphous and can be grown at room temperature and is smoother than both. It has the lowest coefficient of friction against SiC. DLC films have exceptional tribological properties similar to graphene. However, DLC is much weaker than UNCD and has much lower hardness compared to single-crystal diamond. NCD deposition on single crystal diamond anvils at a substrate temperature of 820° C. exhibited significant adhesive bond strength between the NCD and SCD to the point where the rupture occurred in the bulk SCD crystal rather than at the interface because the layer is chemically bonded to the diamond substrate [5]. However, the bond between NCD and tungsten carbide is weaker. The surface of WC must be roughened and the cobalt content near the surface removed prior to deposition because it inhibits diamond growth.

The stresses encountered during indentation as the sharp diamond tip penetrates the material are not only compressive but also shear due to friction. There is a shear stress component in indentation which is not encountered in pure compression.

NCD is more durable than DLC and would probably yield better results for this application. However, given that DLC can be deposited by laser ablation from a graphite substrate, which may be well-suited for diamond tips mounted on metal holders, it may be worthy of trying at first. DLC's smoothness and low coefficient of friction could play in its favor because the stress in the DLC would be mostly hydrostatic compression, and thus have low shear and low tensile stresses throughout the film. This could possibly lead to lesser damage to the DLC layer, and lesser possibility of delamination. Reducing friction is important because it reduces the shear stress in the film which is responsible for delamination. This leads to a higher probability of survival under high loads. However, there could be a CTE mismatch between SCD and DLC due to the fact that SCD is anisotropic while DLC is isotropic. If the diamond layer is too rough it becomes abrasive. It is desired to deposit a strong but smooth layer with minimal thickness that does not delaminate with a surface roughness <5 nm rms. The SP3/SP2 bond ratio must be increased to strengthen the mechanical properties of the NCD layer. We would like to optimize the hardness, toughness and smoothness of the film.

NCD can, in principle, be grown on diamond without seeding, but seeding is required for tungsten carbide. Seeding increases the nucleation density by three to six orders of magnitude and helps achieve a uniform and continuous film in a shorter time, resulting in a thinner coating. The nucleation density of diamond indenters has not been studied before.

CVD films have extremely high internal stresses. A thickness above 10 μm can lead to delamination. Growing NCD or UNCD on sharp diamond tips will require some optimization, whereas DLC deposition is much easier. The set up is straightforward and yields thinner coatings. A typical growth rate for NCD is about 1 μm/hr. Coatings thinner than 1 μm can be obtained on flat surfaces by timing. However, it is more difficult to control the thickness and roughness on 3D shapes like diamond indenters. This usually results in thicker coatings. The radius of curvature of the sharp tip is increased by the thickness of the film.

There is a fourth technique which uses flame hydrolysis to deposit an NCD layer at atmospheric pressure without a plasma. This promises to be a cheaper way of growing diamond films. However, the purity of the deposited films compared to those obtained by CVD is questionable due to the presence of air.

In summary, the two key questions that must be addressed are: would a DLC layer provide adequate protection of the sharp diamond and tungsten carbide tips when indenting under high load, or is an NCD layer needed? at what temperature should the deposition be? The diamond tip is brazed (glued to the metal) with a metal matrix which can shift at high temperature. What is the optimal thickness for the coating to be effective? Can this thickness be controlled precisely? Thickness uniformity is a must in order to be adopted in an industrial process. We would like to coat a few tips of each material with layers of both techniques and compare the performance of the coated and uncoated tips.

### Formation and Control of the Crack

Vickers indentation is routinely used for the measurement of hardness and fracture toughness in ceramics. ASTM standard C1421 describes the evaluation of fracture toughness by crack initiation and propagation, known as the Vickers indentation fracture or VIF method. There is a sharp disagreement among the scientific community regarding the validity of the VIF method for the evaluation of fracture toughness. There have been many thorough papers in the journal of the American Ceramic Society, mostly out of NIST, debating the validity of toughness evaluation by indentation. We are immune to this debate as we are not measuring toughness. We bypass all the discussion about the accuracy of toughness measurement. The indentation creates a crack no matter what. That is all we care about. We do not even care how long the crack is and we do not need to measure it precisely, as long as the cracks from adjacent indentations connect to form a straight long crack. We do not even need to know the load to a high level of accuracy. Most K_{Ic} methods are intended to measure the critical value of the stress intensity factor by initiating and propagating an unstable crack. The main difference between our method and the VIF method is that we need to control the crack. We do not need to resolve the controversy surrounding measuring fracture toughness, but we would like to understand the science behind crack formation.

Since this entire technology hinges on controlling the propagation of the crack, it is important to understand how the crack is formed under the indentation. When a sharp indenter penetrates a material it leaves a plastic deformation on the surface. The residual stresses associated with the plastic zone play a crucial role in evolution of the crack. The downward median crack extends below the surface during the loading phase, while the radial crack continues to grow along the surface until unloading is complete. The crack attains its maximum length and reaches its half-penny semi-circular shape upon full unloading and withdrawal of the indenter. The residual tensile component of the stress field provides the primary driving force for the median/radial crack below and along the surface and determines its final length. The terms “median” and “radial” refer to the same crack system perpendicular to the surface. Sharper indenters give rise to longer and deeper cracks but tend to wear out quicker under high load. Cleavage in poly-crystals is influenced by failure at grain boundaries.

We linked the cracks in poly-crystalline SiC materials. We also linked the cracks in single crystal SiC indented in the (0001) plane, as shown in FIG. 13 and FIG. 88A and FIG. 88B. We will indent around the circumference of the (0001) boule where all the planes are present. Indentations in different crystallographic planes give rise to cracks in different directions, but there is always a median crack normal to the surface under the diagonal. Thus, one of the objectives will be to link the cracks in the different crystallographic planes. Unlike diamond, SiC is not highly anisotropic. The <0001> axis has the highest modulus and hardness compared to the other directions. There is a 10% difference in the modulus and 7% difference in the hardness between the c- and m-planes. Thus, we do not expect the fracture behavior to vary much across the planes.

We would like to monitor the evolution of the median/radial crack system as it develops in real time. Also, we would like to understand the role that the loading rate plays in the formation of the crack. In hardness testers the indentation can only be observed from above after the crack is completely formed. The turret turns to place the camera objective over the indentation. This provides limited information on how the crack was formed. We will fit the machine with cameras on the side to observe the crack during the loading and unloading portions of the cycle. We will use fast cameras to observe crack dynamics. Also we will observe the cracks in transmission by placing cameras below the sample. Single crystal SiC is transparent, especially semi-insulating wafers that are undoped. This will allow us to observe the radial crack front as it travels toward the center.

Lateral cracks which are parallel to the surface initiate near the bottom of the plastic deformation zone and spread out laterally. The depth of the Vickers indentation is equal to ( 1/7^{th}) the diagonal. For a diagonal of 125 μm, corresponding to a load of 20 kg, the depth˜17 μm. Thus, the lateral cracks are about 17 μm below the surface. These cracks turn upwards and cause spalling and material removal. The lateral cracks occur during the final stages of unloading just prior to complete withdrawal of the indenter, along with the surface radial cracks. Under very high loads (above 20 kg) the lateral cracks cause severe chipping which obscures the indentation. This prevents the measurement of hardness optically. For this reason, hardness is usually measured under low to moderate loads in the micro- and nano-regimes using instrumented indentation. Chipping also occurs upon repeated indentation at the same point and has prevented us from observing the radial cracks and the diagonal. For this reason, observation of the median and radial cracks before initiation of the lateral cracks will be invaluable.

Indentation is neither load nor displacement control. Even though the indentation is done under a constant load and the hardness of the material is calculated to a high degree of accuracy from the load divided by the area of the indentation, but it is not exactly load control because the crack arrests. If it were truly load control the crack would not stop. It would keep going as long as the load is applied. The stress remains constant while the critical stress decreases as the crack propagates which leads to an unstable crack. By contrast, a stable crack is driven under displacement control, in this case using a wedge. There is a definite relationship between the displacement of the wedge and the length of the crack. We can arrest the crack simply by stopping the wedge. A stable crack yields a smooth cleaved surface. If the compliances of the material and the load frame are known, then in principle, load control and displacement control are indistinguishable in the sense that we can produce a certain displacement by applying the corresponding load profile and vice-versa. When the energy release rate exceeds the critical energy release rate, which is related to the fracture toughness, the crack propagates according to Griffith's criterion. The cleavage is based on first principles of fracture mechanics.

Our goal is to guide the crack radially up to 4″ without deviating from a plane to cleave an 8″ wafer. It starts from a deep median crack. We have calculated theoretically and confirmed experimentally that an initial crack 250-300 μm deep obtained with a Vickers indentation of 20 kg is sufficient to drive a long crack with a load of 50 kg. There is no limit to the crack as long as it is driven steadily. We just have to be careful to avoid lateral forces that cause the crack to deviate from its plane. Ultrasound can also be used to guide the crack and control its speed. The boule can be held with its face vertical. Even though the forces are perfectly vertical, deviation can still occur if symmetry is not maintained. That means the material to the left of the crack should be equal to the material to the right of the crack. Do not attempt to cleave a wafer from the edge of a boule. The crack will not go straight. You will lose the wafer and the boule. The boule is indented and cleaved in the middle plane to preserve symmetry. Each half boule is then cleaved along its middle plane to produce two new half boules which are cleaved along their central planes and so on and so forth until the original boule is singulated into individual wafers. We have demonstrated that a 1 mm thick wafer can be cleaved into two 0.5 mm thick wafers. This is the final thickness which is used in the semiconductor industry. Thus, a 1.6 cm thick boule can be wafered into 32 wafers 0.5 mm each in 5 iterations (Log₂ (32)=5). This distinguishes our technique from the laser which is a sequential process, only one wafer can be sliced at a time. Whereas our technique is semi-parallel. By contrast, the wire saw is a parallel process. All the wafers are sliced simultaneously. Nevertheless, we beat both in terms of throughput.

We have demonstrated atomically smooth cleavage in crystals that are grown on-axis. For crystals that are grown 4° off-axis the surface exhibits roughness on the order of 50 μm rms in the form of saw-tooth profile corresponding to the crystallographic planes. This is less than the diameter of the wire plus the embedded diamond particles. The kerf loss of cleavage is much less than that of the wire saw.

### Wire Sawing

The primary metric for wafering is the number of wafers obtained from a certain boule. As the first step in the wafering process, slicing strongly influences the subsequent lapping and polishing steps. The subsurface damage caused by slicing must be removed completely to produce an atomically smooth surface ready for epitaxy. This requires extensive CMP time to get rid of all subsurface damage. Single wafer processing is used to mitigate the risk of losing the whole batch. This exacerbates the bottleneck problem. Failure to remove all the subsurface damage causes the defects to migrate into the epitaxial layer impairing device performance and reducing device yield. Slicing is the costliest, lowest throughput, and lowest yielding step in the entire wafering process. The overall wafering cost depends on the kerf loss, damage depth profile, and wafering time.

Wire slicing using a free abrasive diamond slurry is currently the most common method for slicing SiC boules into wafers. However, the recent extension of the wafer diameter to 6″ and 8″ increases the slicing time significantly due to the difficulty of supplying the loose abrasive particles to the center of the wafer. Wire sawing is a very complicated and labor intensive process which depends on many parameters like wire tension, wire speed, vibration, wire wear, feed rate, wear of the guide roller grooves, diamond particle suspension, diamond abrasive distribution, etc. which makes it very difficult to control. Basic understanding of the wire cutting mechanism and the overall sawing performance is still lacking. The optimal slicing conditions in industrial settings are still determined by trial and error.

Wire slicing is inherently a low-yielding process. It takes 90 hours to slice a 200 mm wafer, not accounting for downtime to change the wire and the yield loss, due to the hardness of the material. A typical throughput of multi-wire saws is about 2-2.5 wafers per hour depending on the diameter of the wafer and the loading. Modern multi-wire saws can accommodate up to 15 boules. In spite of all the advancements, wire sawing is still the bottleneck in wafer fabrication. Fixed abrasive diamond wire would allow up to 2.5x faster slicing, but uses a larger grit size which greatly increases the depth of the subsurface damage. This requires slicing thicker wafers to remove the damaged layer, which decreases the number of wafers obtained from a certain boule and increases the net cost per wafer. If a smaller grit size is used, the diamond wire wears out at a faster rate requiring a higher wire feed rate and causing thickness variations in the wafer. Thus, fixed-abrasive diamond wire does not improve the yield. For this reason, it has not been widely adopted by the SiC wafer manufacturers.

The cost per wafer depends on the number of boules that can be loaded simultaneously. Slicing of 150 mm wafers with wire costs on average about $50/wafer including consumables and labor but not depreciation. About 50% of the starting material is lost to dust to form a wafer, hence 50% kerf loss. Additionally, up to 25% of the wafers do not survive the slicing and demounting process, either breaking or chipping to the point where they cannot be used. Efforts are underway throughout the industry to improve these metrics, but wire slicing is expected to remain a high-cost and low-yield process for the foreseeable future.

SiC aims for a greener economy through electrical efficiency, but the production process for growing SiC boules and slicing them into wafers is energy intensive and not environmentally friendly. It consumes a lot of energy and large quantities of ultrapure water for cooling which gets contaminated with solid particles. By contrast, this technology is more environmentally friendly because it does not use slurry.

The cleaving process has very low kerf loss because the whole material is still there on one side of the crack or the other. In addition, the subsurface damage and waviness are greatly reduced, which requires much less material removal in the subsequent steps. A much higher percentage of the starting boule material can potentially become a wafer. If the wafer breakage rate can be controlled this technology will greatly improve the yield and productivity and decrease the cost of the finished SiC wafer.

### Cost of Consumables

We have demonstrated that a Vickers tip under a load of 20 kg at a pitch of 500 μm will last at least 2,000 original indents and more than 25,000 re-indents. There are about 1,000 indentations around the circumference of an 8″ diameter wafer. Thus, a Vickers tip can indent two wafers at a cost of $100 each in large quantities, or $50 per 8″ wafer. There are at least three domestic sources for sharp diamond tools in the US.

By comparison, the average cost of wire slicing is $50 per 6″ wafer and can exceed $75/wafer depending on the number of boules that are available for slicing and that can be loaded simultaneously. Even though the diamond stone used in the Vickers tip is bigger than a slurry particle and is cut at a certain angle which does not have to be very precise, and its 4 facets are polished to a sharp point, but the cost of Vickers consumables is on par with or even cheaper and more environmentally friendly than the slurry that it replaces. The Vickers has a well characterized shape compared to the random size, shape and distribution of the slurry particles. The wire saw consumes a lot of diamond and kilometers of steel wire. About 4,000 carats of diamond particles are consumed while slicing a boule.

Consumables are a major expense for wire saw operators. For this reason, we focused on the consumables. We have demonstrated cleavage on a small scale and now we show that the operating costs of cleavage are not more expensive than slicing by wire.

The cost of cleaving increases linearly with the diameter, whereas the cost of wire sawing and the laser increase as the (diameter)². Thus, the cost of our consumables will increase by only 33% as we go from 6″ to 8″ wafer. Whereas for the wire saw and the laser the cost of consumables goes up by 78%.

The time of cleaving increases with the diameter. So does the time of wire sawing. But the time of laser slicing increases as the (diameter)².

FIG. 85 compares the time and cost of wafering vs wafer diameter qualitatively for all three technologies. The left axis represents time and the right axis cost. The red lines correspond to time and the green lines to cost. For cleavage, both time and cost vary linearly with wafer diameter. For the wire saw, the time varies linearly, but the cost quadratically, whereas for the laser both vary quadratically.

It was already established that cleaving had advantage over both wire sawing and laser slicing in terms of kerf loss and speed of wafering. It also beats both on CAPEX. Our goal was to reduce the rate of diamond consumables while cutting SiC. The results show that our consumables are on par with and even cheaper than the wire saw. These objectives were met. We have a better idea now of how much diamond is consumed by our technology.

### Speed of Wafering

The circumference of an 8″ wafer is about 25 inches. At a pitch of 500 μm this corresponds to 1,250 indentations around the circumference. A typical hardness tester takes about 30 seconds to complete a cycle, for the Vickers to go up and down in the air, penetrate the material, ramp up the load, make the indentation and then retract, and for the motorized stage to move to the next point 500 μm away to start the next cycle. Furthermore, there are 2 kg or 3 kg indentations between 20 kg indents and each point is re-indented several times with 20 kg and 50 kg to broaden the diagonal to seat the wedge. At this rate, it will take 100 hours to cleave a wafer. This is hardly competitive with the wire saw which has a throughput of 2 wafers/hour. A stable crack propagates in hard materials at the speed of 1 mm/sec. So, an 8″ wafer can be traversed radially in 100 seconds. Thus, the bottleneck of wafering is the time of indentation. Crack propagation is relatively very fast. The indentation must be sped up considerably by a factor of at least 200x to become competitive with the wire saw. The cycle time must be reduced to between 1 and 2 seconds. This can be accomplished by selecting fast motors and actuators.

A boule takes 50,000 original indentations of 20 kg plus another 50,000 indentations of either 2 or 3 kg in between plus 400,000 re-indents to broaden the diagonal to seat the wedge. This adds up to a total of 500,000 indents per boule. Even if the cycle time were dropped to 1-2 sec it will still take a prohibitively long time, 200 hours to indent a boule with a single indenter, or equivalently 5 hours per wafer. We are still off by a factor of 10x or more. Furthermore, it is desired that a Vickers tip last throughout a boule to avoid the interruption of changing the Vickers midstream. A Vickers tip lasts 2,000 original indentations of 20 kg plus 25,000 re-indents. Thus, the number of 20 kg indentations for each Vickers must be limited to 50 per wafer to cover the 40 wafers in a boule. At a pitch of 500 μm this corresponds to a length of 2.5 cm=1″ around the circumference of a wafer. Since the perimeter of an 8″ wafer is 25″, 25 Vickers are needed to indent around the circumference simultaneously. Hence, the necessity for parallel indentation. This will reduce the time to cleave a wafer by a factor of 25× to 15 minutes per wafer or equivalently 4 wafers/hour which is twice the throughput of the wire saw.

### APPENDIX 2

Indentation can produce either one of two modes of radial cracking in brittle materials, (a) the median (half-penny) crack, or (b) the Palmqvist crack depending on the sharpness of the indenter. Both of them are perpendicular to the surface, but the median crack is deeper under the indentation, whereas the Palmqvist crack only exists outside of the plastic zone, as illustrated in FIG. 86. According to [3], sharper indenters tend to produce Palmqvist cracks. For this reason, we use blunt Vickers indenter which has an obtuse angle of 136°.

The goal is to straighten and connect the cracks between adjacent 20 kg indentations to form a continuous long crack for the macro-wedge to cleave. The 20 kg cracks are not always straight and do not always connect. The presence of the 2 kg or 3 kg indents between the 20 kg indentations helps connect the 20 kg cracks, but the cracks are not deep half-way between the 20 kg indentations.

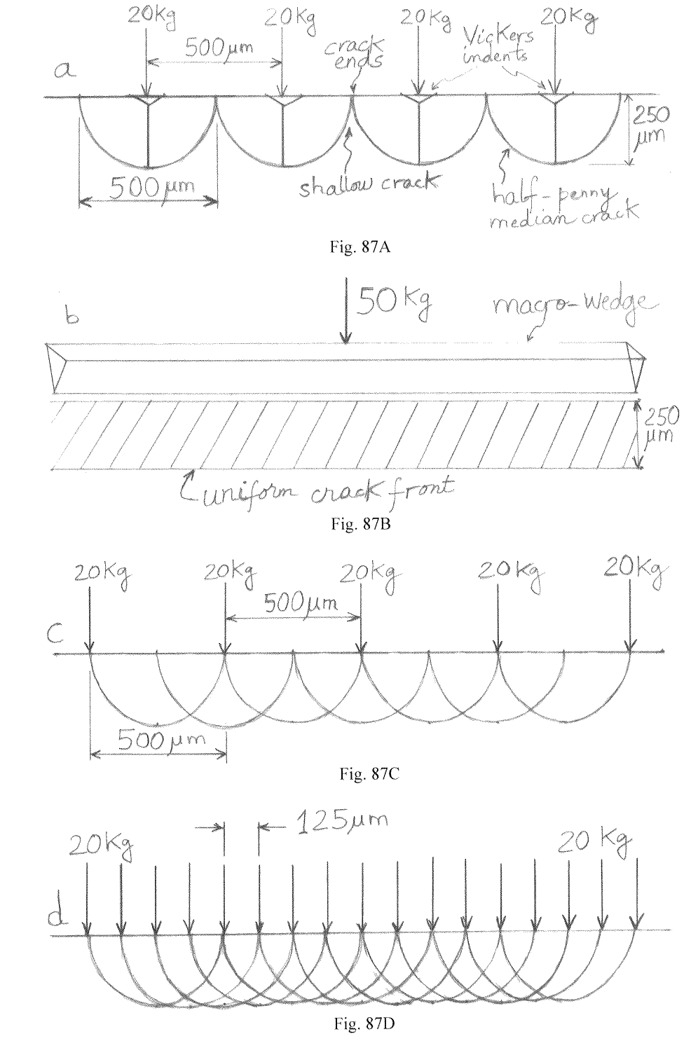

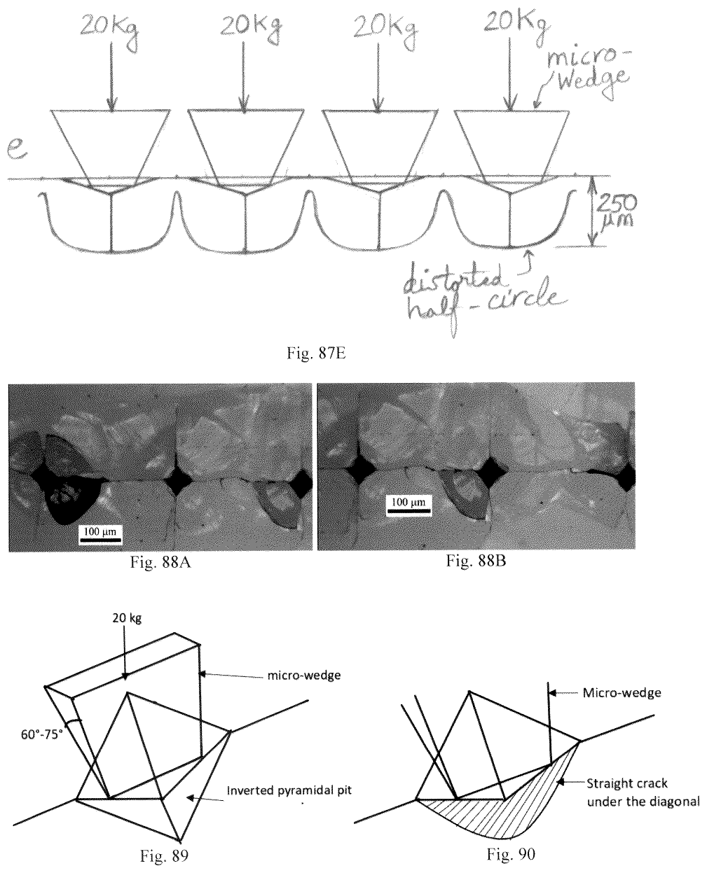

The concept is illustrated in FIG. 87A which shows a cross-section of the semi-circular (half-penny) median crack. The arrows represent the locations of the 20 kg indentations which are separated by 500 μm, and the half-circles are the fully developed median cracks after withdrawal of the indenter. The half-crack length c=250 μm. The half-circles have a diameter 2c=500 μm. The problem is that the crack is very shallow at the ends half-way between indentations where the two cracks meet.

The macro-wedge can drive a crack 250 μm deep with 50 kg, but it expects a uniform crack, as shown in FIG. 87B. Otherwise, the crack front will not be uniform.

One way to make the crack denser and fuller would be to indent with 20 kg at the crack ends, as shown in FIG. 87C, effectively shortening the pitch from 500 μm to 250 μm. We have cleaved by reducing the pitch to 200 μm, but it damaged the Vickers prematurely because the tip falls on a crack.

We can decrease the pitch even further down to 125 μm, as shown in FIG. 87D. This will create a crack front that approaches a straight line, but the Vickers will sustain a very heavy damage and the cost of the technology will increase 200× compared to 500 μm, as shown in FIG. 60. Thus, a different approach is needed to obtain a uniform crack front.

### Spreading the Crack Laterally

The diagonal is enlarged to about 400 μm by repeated application of the Vickers (2×20 kg+3×50 kg), and a micro-wedge whose length is shorter than the diagonal is applied to the diagonal with a load of 20 kg. This has the effect of spreading the crack laterally below the surface by squishing the crack toward the ends, as shown schematically in FIG. 87E. The half-circle becomes distorted in one axis, but the orthogonal crack remains semi-circular. This creates a more uniform crack front. The total depth, however, remains at 250 μm for 20 kg. The micro-wedge can be applied several times to link the cracks between adjacent indentations. Several micro-wedges can be applied simultaneously in parallel to shorten the time to connect all the cracks.

The cracks between indentations are not perfectly aligned with the diagonal, even in crystalline materials. FIG. 88A and FIG. 88B show examples of indentations in single crystal SiC under 50 N=5 kg @ a pitch of 300 μm. The cracks connect even though they are not perfectly straight and the indentations are not perfectly aligned.

The length of the micro-wedge is tailored to fit in the diagonal pit, as shown in perspective in FIG. 89. If the micro-wedge is longer than the diagonal, its edge will touch the surface and will damage because it is not supposed to indent. Similarly, the macro-wedge expects a long and straight crack, otherwise its tip will damage if it encounters a surface.

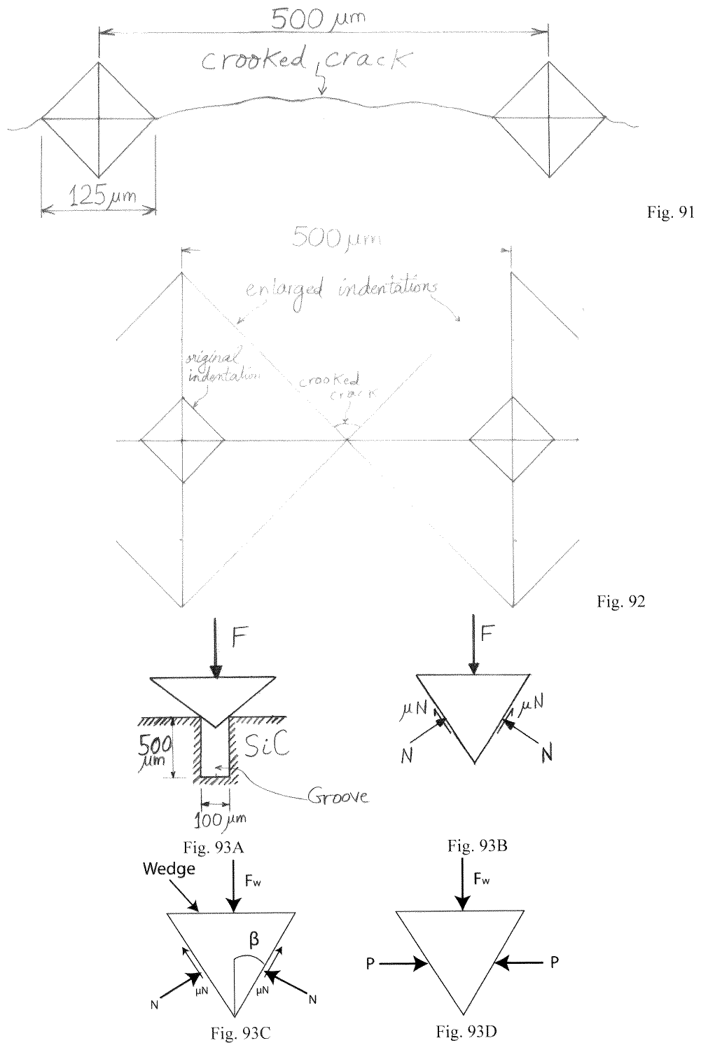

Even though the crack between indentations may not be straight, but it is straight under the diagonal, as illustrated schematically in FIG. 90.

FIG. 91 shows a schematic top view of two 20 kg indentations having diagonals of 125 μm separated by 500 μm. The crack is drawn exaggerated following a crooked path between the indentations to illustrate the concept. The macro-wedge would damage if applied directly to such a crack because its tip will touch material between the indentations.

When the diagonals are enlarged, as shown in FIG. 92, they wipe off some of the crooked crack on the surface and provide straight seating for the macro-wedge. Ideally, if their corners touch, i.e. if the diagonal is enlarged to 500 μm, then it provides complete seating for the macro-wedge.

The macro-wedge tip fits in the crack created by the micro-wedge and pushes it on its sides to cleave. The oblique sides of the wedge touch the edges of the crack in a line contact, as if it were sitting in a groove, as illustrated in FIG. 93A. The tip of the wedge does not touch the surface, hence it is not an indenter. The force F_{w} acts on the wedge from the top to open the crack. The forces on the sides of the wedge consist of the normal N and the tangential force of friction μN, as shown in FIG. 93B and FIG. 93C. The resulting horizontal force P pushes the crack open, as shown in FIG. 93D. In principle, the same thing could be accomplished with a Vickers, except that the Vickers is a lousy wedge because it has a blunt angle of 136°. It would require a much larger force to propagate the crack. It was calculated in Appendix 1 and demonstrated experimentally that the wedge half-angle β should not exceed 30°, i.e. total included angle of 60°, in order to drive the crack from 250 μm with a force that does not exceed 50 kg.

The effect of the micro-wedge is not evident on the surface. The ultimate proof of this concept is if it reduces the maximum force needed for the macro-wedge to drive the crack and produces a uniform and planar cleaved surface.

We have demonstrated the use of micro-wedge with 20 kg to spread and connect the cracks between adjacent indents formed by Vickers indentations and subsequent application of the macro-wedge with 50 kg to drive the crack. The instant invention concerns lateral extension of the crack created by indentation with reduced load using a non-indenting wedge.

Indentation is the bottleneck of wafering because hardness testers are slow. It takes about 30 seconds to complete one cycle from one indent to the next. We will build a custom machine based on a hardness tester to speed up the process and achieve a throughput twice that of the wire saw. The data presented in the instant invention indicate that it is feasible. This is very appealing to the OEM wafer manufacturer because it is much cheaper and occupies much less space than the wire saw or the laser.

### Parallel Indentation

The concept of parallel indentation, where tens of Vickers or wedges are applied simultaneously either on a flat surface or around the circumference of a boule to speed up the indentation, or launch a radial crack toward the center, is a novel concept which did not exist before. It was invented by the Author on Apr. 16, 2020 at private expense. Hardness testers use a single indenter head and apply the load at a single point on the surface of a sample. The sample is translated in the x-y plane to indent along a line or array. A typical cycle time is about 30 seconds between indents. It would take a prohibitively long time to indent a boule. The cycle time must be shortened by 20× to 1.5 second using fast motors and actuators, and parallel indentation with at least 25 Vickers around the circumference of an 8″ boule must be used to achieve a throughput 2× better than the wire saw. Thus, a new custom machine must be built with these features for the purpose of cleaving wafers. Such a machine does not exist anywhere. We will design and build this machine. The data presented in the instant invention indicate that such a machine is feasible.

However, there are a few conceptual hurdles that must be overcome before this concept can be implemented. For example, where will the force to drive all these indenters come from? And how can we make sure that all the indenters touch the surface at the same time? The indenters cannot be rigidly attached to each other and they do not necessarily have equal heights as they are manufactured with loose tolerances. When a line or array of Vickers indenters is laid over a surface they must be free to follow the contour of the surface. How can they be held together? For example, if there are 25 Vickers in the array and each Vickers is driven by a force of 20 kg, then the total force that must be supplied by the machine is 500 kg. Similarly, if the radial crack is launched simultaneously by 25 wedges spread symmetrically around the circumference each one must be driven by 50 kg, then the total force required from the machine is 1,250 kg. A machine that will provide this large force would be bulky and heavy standing on the floor. The goal is to fracture the boule using a compact and lightweight tabletop machine. The solution to this dilemma is to use hydraulics.

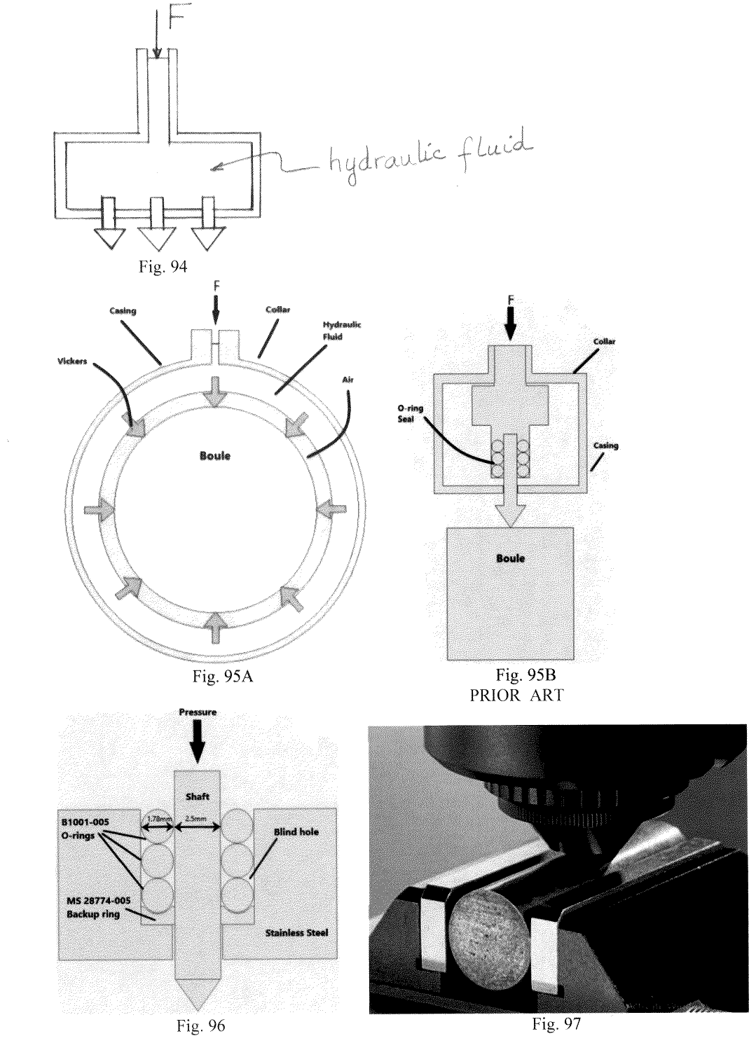

The concept is illustrated in FIG. 94 which shows an enclosure, such as a hydraulic cylinder containing hydraulic fluid. The cylinder is sealed. The hydraulic fluid does not leave the cylinder. The diagram shows three holes in the bottom of the cylinder with plunger type rods carrying three Vickers tips. A force F is applied through an opening at the top which pressurizes the fluid. If the diameter of the opening is equal to the diameter of the plunger rods then the same force F is applied on each one of the plungers. This is the principle of force multiplication in hydraulic systems according to Pascale's law. The number of plungers can be 10, 20, a hundred, the same force, equal to F, shows up on each one of them. The force is applied instantaneously because the fluid is incompressible. The machine does not need to provide a large force to drive them all. However, the displacement of the force F must be equal to the sum of the displacements of all the plungers to satisfy the conservation of energy, namely that the work in must be equal to the work out. The piece to be indented (not shown) is below the Vickers. The force F drives the plungers through the hydraulic fluid without touching them. It pushes the fluid and the fluid pushes the Vickers into the material. This is the principle of hydraulic actuation. The fluid provides hydraulic damping. The force F can impact the top of the fluid with a velocity, whereas if it were pushing the rods directly then it would have to come to a full stop when the Vickers touch the surface. This shortens the time of indentation and speeds up the cycle. The pressure is raised slightly at the beginning. This allows all the Vickers tips to make gentle contact with the surface simultaneously regardless of their heights. So, hydraulic actuation solves both problems. Also, hydraulic actuation affords higher loading rates.

### Parallel Indentation of a Boule

The schematic of FIG. 94 with three Vickers applies the load on a flat surface. If, for example the force F=20 kg, then the total load felt by the part=60 kg. The part to be indented is held by precise motion stages with micron or sub-micron resolution which move on ball bearings. The very high load due to the amplification of the force by the number of Vickers puts significant pressure on the ball bearings and may cause them to fail prematurely due to fatigue. Thus, it is important to shield the precise translation and rotation stages from the forces experienced by the part, or to counteract the force somehow. This results naturally in the case of a cylindrical boule which is indented radially around the circumference. The force applied at any point along the periphery is counteracted by an equal and opposite force from the diametrically opposite point. This yields a net zero force on the boule and alleviates the pressure on the ball bearings. The boule can be held gently with suction cups at the center from both sides which allows turning of the boule around its axis. The weight of a SiC disk 8″ diameter×2 cm thick is about 2 kg which can be easily supported by the suction cups. This allows use of smaller, lighter, and cheaper translation and rotation stages. The Vickers are held in holes sealed with O-rings in a circular collar or ring made of stainless steel that surrounds the boule and contains the hydraulic fluid. The concept is illustrated with 8 Vickers around the circumference in FIG. 95A in elevation and in FIG. 95B cross-section.

The detail of how the holes are sealed with O-rings around the plungers is shown in FIG. 96. The friction between the O-rings and the plunger rod and the contact with the surface prevent the rods from sliding through the holes and ensures that the Vickers are perpendicular to the surface. When the force F is applied at the top, the plungers are deployed and when the force is removed they retract into the collar ring. If the force of suction is not sufficient, miniature springs around the shafts of the plungers can be used to return the plungers to their original positions. They are confined to the holes and the fluid inside the ring remains sealed at all times. Since the fluid never leaves the ring, it does not need a pump or valves. This simplifies the hydraulic design considerably.

The motor driving the vertical z-stage from above pushes a rod into the fluid. It does not have to move slowly because the fluid cushions the shock. The rod with a 2.5 mm diameter has negligible inertia and can be driven with a high acceleration. This shortens the time of indentation and speeds up the cycle. If the motor were driving the Vickers directly, then it would have to come to a full stop to avoid a collision. The hydraulic fluid does not touch the material. The contact between the Vickers and the SiC is in the air (gray shaded annular area in FIG. 95A). When the rod touches the fluid, it pushes the plungers and the Vickers to make gentle contact with the surface. The motor then ramps up the pressure until full load is reached as the Vickers perform the indentations. There is no need to measure the force to a high degree of accuracy with an expensive load cell. A simple strain gage can be used. In fact, we used a dead-weight hardness tester which did not have a load cell. After the indentations are made, the collar containing the Vickers is replaced with a collar containing the wedges. There is no need to mount the Vickers or the wedges precisely in the rings. The fluid will push them to make gentle contact with the surface at the beginning of the cycle and the holes will make sure that they are perpendicular to the surface.

If 25 Vickers are deployed in parallel around the circumference of an 8″ boule, then each Vickers covers 1″ of the perimeter. This corresponds to 50 indentations @ a pitch of 500 μm. The boule must turn by 50 steps of 0.3° each for a total angle of 15°. For a 6″ boule the steps are 0.4° and the total range 20°. At this rate the time of indentation is 15 minutes per wafer or 10 hours per boule. We can increase the throughput by using more Vickers. For example, if we use 50 Vickers instead of 25, then each Vickers makes 25 indentations per wafer, and spends half the time. The lifetime of each Vickers is still 2,000 original indentations so it can last 80 wafers, i.e. two boules. The time per boule is cut in half to 5 hours at the cost of doubling the amount of diamond. So, there is a trade-off between the cost of consumables and the time of indentation. However, the cost of consumables per wafer remains the same at $50/wafer. We can increase the throughput by using more diamond.

### Design of the Machine

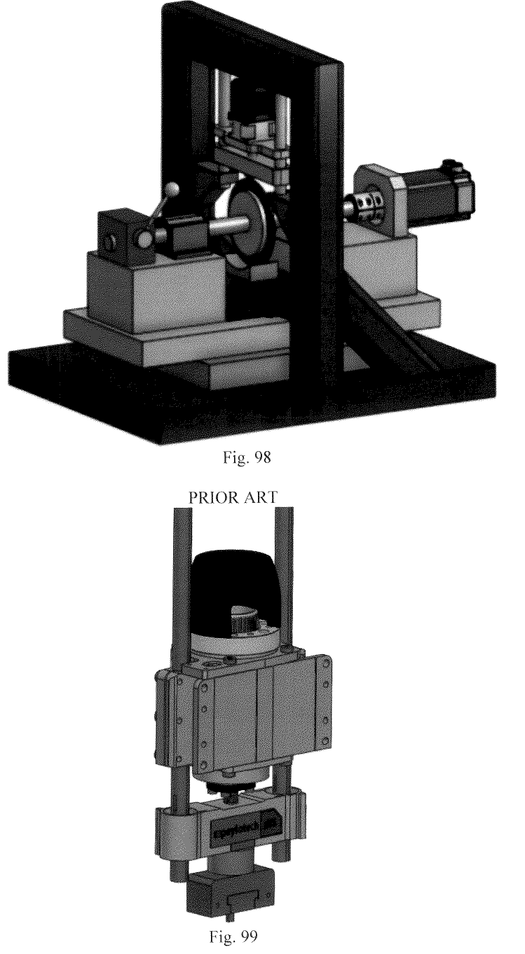

FIG. 97 shows a cylinder held in a jig being indented. In our case the cylinder is more like a disk whose diameter varies between 2″ and 8″ and the thickness is 2 cm. The indenter moves vertically along the z-direction. The disk is translated longitudinally along its x-axis in steps of 500 μm and rocked around its 0-axis in steps of 0.3° for a total of 15°, except that it cannot be held rigidly. It must be free to rotate as shown schematically in FIG. 98. The boule represented by the dark gray disk is held either by friction between the two light-blue disks or by suction cups around its center from both sides. This is the custom fracture machine that we will build for cleaving wafers. The frame is two-column made of steel with an inverted-U shape for rigidity and is kept short to minimize its compliance. It occupies a space of 20″ wide×30″ long x 30″ tall and weighs less than 100 kg. The loading is kept in the central plane to minimize out-of-plane bending moments. It has three motors, one each for x, θ and z, two linear actuators for x and z, and one rotary actuator for θ. The θ axis could also use direct drive. The light blue and light gray blocks at the bottom of FIG. 98 represent the x and y stages, respectively. A boule takes up to 500,000 indentations. Current hardness testers are too slow. We want to speed up the cycle time to 1.5 second between indents. For linear travel, an acceleration of 3.5 m/s² takes 25 milli-second for a 500 μm sprint from start-to-stop. The maximum velocity reached is 41.8 mm/see which is below the maximum velocity of the stage. Similarly, for rotation the goniometer must have an angular acceleration of 35 rad/s², and maximum angular velocity greater than 0.418 rad/sec. These requirements can be easily met with standard servo-motors for the inertias involved. Only the x, z and e motions need to be fast. The y-axis can be driven manually for alignment.

### Example 2

These actuators are commercially available from multiple vendors. For example, the 400XR series linear actuators from Parker Hannifin which use ball screws driven with servo motors have the load capacity and can provide the required acceleration and weigh only 2-3 kg. Similarly, the 200RT series rotary stages meet the angular acceleration requirement. These can be used for the x and @ axes, respectively. Their small form factor and high precision would be a great fit for this application. They come pre-loaded to reduce backlash and improve repeatability within 1.3 μm. This allows re-indenting at the same point multiple times. However, for the z-motion it is desired to have a 10 nm resolution at the beginning of the cycle when the wedge applies 50 kg to drive the crack. Ballscrews that use gearboxes do not typically have this high level of resolution. And linear motors are limited in their force capacity. However, direct drive ballscrews, such as the one made by Psylotech, Inc. see FIG. 99, are very fast, offer the required load capacity and have a resolution in the nanometer range and large stroke up to tens of millimeters. The crosshead carrying the Vickers tip slides on two vertical rigid posts which provide stable motion. It measures about 22 cm×9 cm×2 cm and weighs 5 lbs. The z-actuator can be rigidly attached to the frame either through the vertical posts at the top or bolted to the frame. This actuator can operate under either load control or displacement control and can specify the loading and unloading rates or the displacement rates. Displacement control is easier and faster to implement than load control because the motor naturally wants to turn at a constant speed.

The 10 nm vertical resolution can be obtained either with a 16-bit rotary encoder or with the use of a linear encoder, such as the Renishaw Tonic optical incremental linear encoder which has a resolution of 1 nm independent of the load. It is important to minimize the number of moving parts and the number of parts that feel the 50 kg load to achieve this resolution. The use of hydraulic actuation is advantageous because it offsets the load and reduces the size and weight of the linear and rotary stages and the motors that drive them considerably. The linear encoder will be used to measure the compliance of the frame under a load of 50 kg.

Once the linear and rotary stages are chosen, then the servo motors can be specified based on the inertias, torque curves, and the target velocities and accelerations to achieve the desired positioning speed and accuracy. These motors are able to provide the torque necessary to drive the Vickers 20 μm deep inside the material in 0.5 second, i.e. at a speed of 40 μm/sec to meet the overall cycle time goal of 1.5 sec. The horizontal motion can happen simultaneously as the Vickers goes up and down in the air to save time. The custom software that controls the multi-axis motions will be either developed in-house or outsourced. The machine will have a touchscreen multi-axis controller with the ability to jog each axis at a configurable speed. The servo drives and controllers will be housed in a panel.

Thus, it is possible to select fast motors and actuators to achieve a cycle time of 1.5 sec and provide a 10 nm vertical resolution under 50 kg load. The custom machine has a short frame and can be packaged in a volume 20″×30″×30″ and weighs less than 100 kg.

We can mitigate the risk of breaking the wafer during cleaving and subsequently during handling. The boule is held with suction cups from both sides around its center. It is mounted on a motorized goniometer (rotation stage) which turns it by 15-20° around its axis for indentation along the circumference. The goniometer is mounted on a motorized X-stage that translates the boule for indentation along its axis. The whole assembly is mounted on a manual Y-stage for alignment.

The suction cups serve as robotic arms which hold the two half-boules after separation and loads them onto cassettes underneath. This protects the fragile wafers and prevents breakage. The simultaneous axi-symmetrical indentation and loading around the circumference alleviates the load on the ball bearings of the rotation and translation stages and prevents slippage of the boule between the suction cups. The net resultant force in any radial direction is zero because at any point around the circumference the 50 kg load is counteracted by an equal and opposite force from a diametrically opposite point. The sequential splitting of a boule in two halves at a time is advantageous because it can be handled using robotic operators. By contrast, wire saws require human operators to receive all the wafers that fall out simultaneously, hence a higher risk of breakage. Wire saws are labor intensive. The sequential cleavage is compatible with robotic automation.

### Technical Objectives

The main goal is to cleave a wafer without breaking it. We want to observe how the loading parameters influence the formation and control of the cracks. An important issue is how the cracks in different crystallographic planes around the circumference and how the individual cracks from each Vickers will combine constructively to produce a radial overall crack front propagating from the periphery toward the center without deviating from the plane of the crack. In this regard, we would like to evaluate whether coating of the sharp wedges will be effective at extending their lifetimes and conduct a benefit/cost analysis.

Another objective will be to demonstrate the concept of hydraulic actuation and parallel indentation.

Another objective will be to demonstrate the savings in wafering costs due to cleavage.

Another objective is to interface with customers to develop realistic yield and cost models and statistical process controls.

### Work Plan

We will design and build a custom machine and add a proprietary piece of hydraulic equipment. We will select the motors and actuators that give the desired accelerations and will fit a Vickers tip on the load frame. The machine will have cameras on the side to observe formation of the crack in real time and a special camera to display a panoramic view. We will indent around the circumference of a (0001) boule to observe the cracks in different crystallographic planes. We will build a holder for a round boule or wafer. We will cut and polish samples made of single crystal SiC along crystallographic planes. We will coat a few sharp wedges with an NCD layer deposited by CVD and compare the performance of the bare and coated tips. We will cleave rectangular and cylindrical shapes.

We will demonstrate the concept of hydraulic actuation using a hydraulic cylinder for single and multiple Vickers. We will design and build a hydraulic ring carrying up to 25 Vickers. The holders of the Vickers will be designed to fit in the holes of the ring according to the size of the O-rings. The maximum force reached in the cleavage process is 50 kg which allows use of a simple, compact and lightweight fracture machine. However, the pressure inside the hydraulic cylinder can be significant depending on the diameter of the rod used. The diameter of the plunger rod is chosen based on the ID of available O-rings. For example, if we use a rod with a diameter of 2.5 mm corresponding to the smallest O-ring, as shown schematically in FIG. 96, the pressure inside the cylinder is 14,000 psi, which is manageable. Hydraulic cylinders made of grade B steel have a yield strength of 35,000 psi and those made of grade 100 steel have a yield strength of 100,000 psi. Those cylinders operate continuously under this pressure without leaking.

We will send some cleaved wafers for polishing and CMP to evaluate the quality of the cleavage and demonstrate the robustness and structural integrity of the cleaved wafers toward further processing and the reduction in polishing and CMP time due to reduced subsurface damage, and ascertain the resulting savings in wafering costs.

The customer wants to know the specifications of the cleaved wafers, such as wafer thickness, kerf loss, TTV, warp, bow and roughness with a 95-99% confidence level to assess potential replacement of current wafering technologies (wire saw and laser split) in their production lines. They also want to know the yield loss to develop cost models for manufacturing. For example, if for every 1000 wafers produced, we expect 62 to break and 17 to fail for wafer thickness. Based on this they can calculate how much material is needed to produce a certain number of wafers. The customer also wants to know the requirements on boule shape, grinding and tolerances on the diameter. They want assurances that guarantee success if the process is ramped up. We will develop statistical process controls in conjunction with our customers.

Cleaving is not a novel invention. But the equipment or method used for cleaving can be an invention, such as the high throughput fracture machine which uses hydraulic-assisted parallel indentation.

### APPENDIX 3

The ultimate goal is to slice a boule into many wafers. The following example is for a typical SiC or GaN boule having a thickness of 1.6 cm=16 mm to be sliced into 32 wafers 0.5 mm thick each. This number was chosen because Log₂(32)=5, as mentioned in Example 1 above. This is the near-final thickness which is standard in the semiconductor industry. At this thickness the wafers need only minimal material removal to make the surface epi-ready because the cleaved surface is free from sub-surface damage. The wafers are not peeled-off from the end face of the boule one at a time. Rather the boule is cut in half and each ensuing boule is subsequently cut in half until the boule is finally singulated to 32 separate wafers. The boules can be processed in parallel. Thus, it takes only 5 iterations to wafer the boule. In general, it takes Log₂(N) iterations to separate N wafers, where Log₂ is Log base 2. Hence, cleaving is a semi-parallel process. This distinguishes this technique from other techniques, such as laser slicing which peel off one wafer at a time and which require (N-1) iterations to separate N wafers, i.e. 31 iterations to make 32 wafers. After the fourth iteration, the final boule is 1 mm thick which must be split in two wafers. We have demonstrated splitting of a 1 mm thick SiC substrate of arbitrary shape by driving a crack down the middle plane as shown in FIG. 5, FIG. 6, FIG. 7, FIG. 22 and FIG. 23.

The wafering process starts by grinding the cylindrical surface of the ceramic boule. No high degree of tolerance is needed because the hydraulic ring can accommodate variations in the diameter across the boule and from boule to boule. It can also accommodate the flat on the side of the boule that indicates the crystallographic orientation. The end surfaces are also ground to allow holding the boule between metal cylinders in a lathe without creating pressure points. Following the grinding, the boule is indented around the circumference with 20 kg and 3 kg loads at 500 μm intervals according to the protocol outlined above, to create radial median cracks. This creates 31 rings of indentations around the circumference.

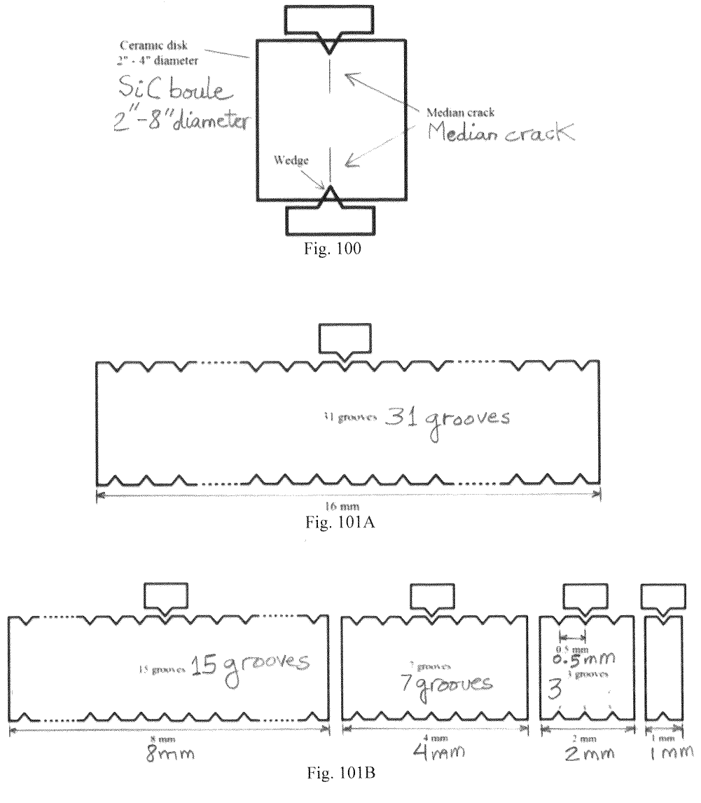

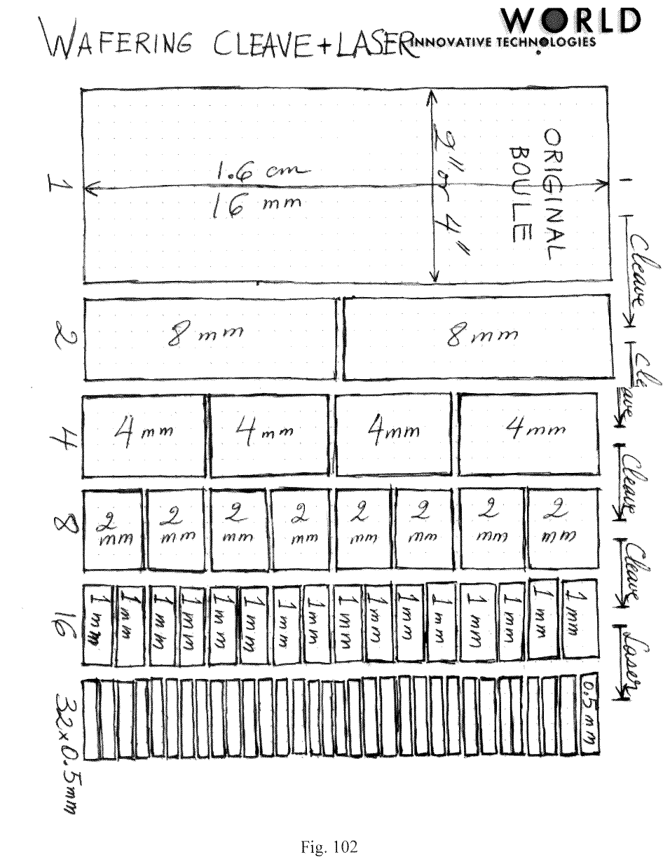

After the indentation is complete a hydraulic ring with 25 micro-wedges is placed in the middle plane of the 16 mm long boule, as shown in FIG. 100, as this is the plane where the mode II stress intensity factor, Ku=0. The criterion for crack stability requires that K_{II}=0. The boule is originally split in two halves along its central plane. Each half-boule is in turn split along its middle plane sequentially and so on and so forth until the last boule 1 mm which yields two wafers 0.5 mm thick each, as shown in the diagrams of FIG. 101A and FIG. 101B. These diagrams illustrate the sequence of cleavages for boules in their middle planes as their length is cut in half after each step. Once a boule is cut in two, the ensuing two boules can be processed simultaneously in parallel to obtain 4 boules and so forth, hence the number of operations goes as Log₂(N). For a 16 mm thick boule the first step yields two boules 8 mm each. The process is repeated to result in 4 boules of 4 mm then 8 boules of 2 mm then 16 boules of 1 mm. Thus, 16 machines must operate in parallel to yield 32 wafers in 5 steps. Alternatively, it will take 31 iterations to separate the 32 wafers with a single machine.

We offer the customer two options: space efficiency and time efficiency, and anywhere in between. Under space efficiency, we reduce the CAPEX investment significantly compared to current technology. This frees up factory space to be used for other purposes. Under time efficiency we reduce the time of cutting the boule from one week to a few hours, so that slicing does not impede wafer production. Even though space efficiency is attractive because it frees up factory space, but crystal growers opt for time efficiency because it provides quick feedback on the quality of their growth.

The diagram in FIG. 102 illustrates a process that combines cleaving with laser slicing as the last step. The diagram shows a typical boule 1.6 cm=16 mm long, in elevation, which can have a diameter of 2″, 4″, 6″ or 8″. The boule is cut into 32 individual wafers 0.5 mm thick each, in 5 successive iterations. We split a boule of any diameter in half by driving a crack down the middle plane because symmetry dictates that the type 2 (shear) stress intensity factor vanishes (K_{II}=0) in that plane. Everywhere else K_{II}≠0. Thus, it is expected that the crack will propagate undeviated in this plane from the perimeter of the boule toward the center. No material is lost. All 5 steps can be obtained by cleaving. Alternatively, the laser can be used to obtain the final thickness of 0.5 mm if the 1 mm thick boule is too fragile to cleave. It can also be used to make thinner wafers down to 350 μm as this is the desired final thickness in the SiC industry for 8″ wafers. This is the fastest way of wafering the boule.

### REFERENCES

1. Zhigang Suo https://imechanica.org/files/Applications % 202014%2002%2018_1.pdf
2. A Critical Evaluation of Indentation Techniques for Measuring Fracture Toughness: I, Direct Crack Measurements G. R. Anstis, P. Chantikul, B. R. Lawn, and D. B. Marshall, Journal of the American Ceramic Society Vol. 64, No. 9, pp 533-538, September 1981
3. A Critical Evaluation of Indentation Techniques for Measuring Fracture Toughness: II, Strength Method, P. Chantikul, G. R. Anstis, B. R. Lawn, and D. B. Marshall, Journal of the American Ceramic Society, Vol. 64, No. 9, pp 539-543, September 1981
4. S. Jahanmir, et al, Tribological characteristics of synthesized diamond films on silicon carbide https://www.sciencedirect.com/science/article/abs/pii/0043164889901142
5. Rapid Growth of Nanocrystalline Diamond on Single Crystal Diamond, Samuel L. Moore, Gopi K. Samudrala, Shane A. Catledge & Yogesh K. Vohra www.nature.com/scientificreports (2018) 8:1402
6. Fracture Toughness Evaluation and Plastic Behavior Law of a Single Crystal Silicon Carbide by Nanoindentation, Amit Datye, Udo D. Schwarz and Hua-Tay Lin, Ceramics 2018, 1, 198-210)

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed:

1. A method for cleaving a semiconductor wafer from boule using the same machine to initiate and propagate the crack,
wherein said machine uses sharp diamond tips, such as Vickers, to initiate a crack in a plane perpendicular to the axis of said boule, by indentation at certain intervals around the circumference under a first load, similar to a hardness tester, and a chisel, such as a wedge, applied on said crack in the same plane under a second load to propagate the crack toward the center of the boule,
wherein said wedge contacts the material on its facets rather than its tip,
wherein said wedge replaces said Vickers tip in the machine without removing said boule from said machine.

2. The method of claim 1 wherein the indentations are made in a line along the diagonal to create a long crack on the surface.

3. The method of claim 2 wherein the spacing or pitch between adjacent indentations is about equal to the length of the crack (2c).

4. The method of claim 3 further including the step of re-indenting with a Vickers tip under a third load at the same spot multiple times to enlarge the diagonal before applying said second load on said wedge.

5. The method of claim 4 wherein the corners of said enlarged diagonals from adjacent indentations almost touch.

6. The method of claim 5 further including the step of applying a micro-wedge under a fourth load at each Vickers indentation site to spread the cracks laterally and connect the cracks between adjacent indents, wherein said micro-wedge fits within the enlarged diagonal.

7. The method of claim 6 further including the step of applying a macro-wedge under said second load once to the entire crack line, wherein said macro-wedge having a length that encompasses several cracks, preferably the entire crack length.

8. The method of claim 7 wherein said semiconductor is single crystal silicon carbide (SiC), said first load is between 10 kg and 30 kg, preferably about 20 kg, said spacing or pitch is about 500 μm, said third load consisting of about 2 indentations of 20 kg each followed by 3 or 4 indentations of 50 kg, said fourth load is between 20 kg and 30 kg, said second load is about 50 kg,
wherein said micro-wedge is made of diamond having a length less than 400 μm and a half-angle between 30° and 40°, and said macro-wedge is made of a material that has a low coefficient of friction with SiC, such as tungsten carbide (WC), having a half-angle of about 30° or less.

9. The method of claim 8 wherein prior to application of said first load and said indentation with 20 kg, indentations under a load of 2 kg or 3 kg are made at a pitch 2c=500 μm, half-way between the 20 kg indents.

10. The method of claim 8 wherein said micro-wedge and said macro-wedge are coated with a nano-crystalline diamond (NCD) layer grown by either UNCD, NCD or DLC.

11. A method for wafering a semiconductor boule including
Creating an array of indentations around the surface of said boule using sharp diamond tips, such as Vickers, to initiate cracks in a plane perpendicular to the axis of said boule, by indentation at certain intervals axially and around the circumference under a first load, and a chisel, such as a wedge, applied on said crack in the same plane under a second load to propagate the cracks toward the center of the boule,
wherein said wedge contacts the material on its facets rather than its tip,
wherein said wedge replaces said Vickers tips in the machine without removing said boule from said machine,
wherein the cracks are linked along the diagonal to form a crack on the surface around the circumference,
wherein the spacing or pitch between adjacent indentations is about equal to the length of the crack (2c),
re-indenting with a Vickers tip under a third load at the same spot multiple times to enlarge the diagonal before applying said second load on said wedge,
wherein the corners of said enlarged diagonals from adjacent indentations almost touch,
applying a micro-wedge under a fourth load at each Vickers indentation site to spread the cracks laterally and connect the cracks between adjacent indents, wherein said micro-wedge fits within the enlarged diagonal,
further including the step of applying a macro-wedge under said second load once to one line of cracks around the circumference in the middle plane bisecting the boule, thus cutting the boule in half.

12. The method of claim 11 wherein each ensuing boule is subsequently cut in half using the same method until the boule is finally singulated to separate wafers at the desired thickness, The boules can be processed in parallel.

13. The method of claim 12 wherein each Vickers tip is used to make at least 2,000 original indentations under a load of 20 kg, then used to re-indent at those locations at least 25,000 times under loads of 20 kg and 50 kg to enlarge the diagonals.

14. The method of claim 11 wherein there is no need to flatten the end faces of said boule prior to cleavage or after separation.

15. A fracture machine for cleaving semiconductor wafers from boule
having a robust frame, such as at least two-column made of steel with an inverted-U shape for rigidity which is short to minimize its compliance, wherein the loading is kept in the central plane to minimize out-of-plane bending moments,
capable of exerting a force in the range up to 100 kg or more, that can cleave a boule having an initial thickness of about 2 cm or thicker,
that can operate in either load control or displacement control mode wherein the loading and unloading rates or the displacement rate can be specified,
that can hold a cylindrical boule by the end faces, such as with suction cups, wherein said boule is mounted on a motorized goniometer (rotation stage) which turns it by angular steps within a certain angular range around its axis for indentation along the circumference, wherein said goniometer is mounted on a motorized x-stage that translates the boule longitudinally in steps for indentation along its axis,
wherein for SiC boules having a diameter of 6″-8″ said step is about 500 μm for 20 kg indentation load and said angular step is about 0.3°-0.4° and said angular range is about 15°-20°,
wherein said machine provides about 10 nm vertical resolution under a load of 50 kg for vertical motion along the z-axis under controlled displacement of the macro-wedge,
that uses fast motors and actuators to achieve an indentation cycle time between 1 and 2 seconds, preferably 1.5 sec,
wherein said linear actuators are capable of reaching an acceleration of about 3.5 m/s² to run a 500 μm sprint within 25 milli-seconds from start-to-stop, corresponding to a maximum velocity of about 41.8 mm/sec, and said goniometer is capable of reaching an angular acceleration of about 35 rad/s², and a maximum angular velocity of about 0.418 rad/sec.
that can initiate and propagate a crack without removing the boule from said machine,
that is compact and lightweight, substantially smaller than a multi-wire saw, that can fit on a tabletop,
that uses a turret or mechanism to hold Vickers and wedges and microscope objective lenses,
that can position the wedge over the indentation made by the Vickers,
that is fitted with fast cameras to view crack formation from the side in real time, and cameras underneath the boule to allow observation of crack propagation in transmission through the boule.

16. The fracture machine of claim 15 wherein the steps of crack initiation by indentation with Vickers, diagonal enlargement and micro-wedge application are done under load control where the load remains constant,
whereas the step of crack propagation by macro-wedge application is done under displacement control where the velocity of said macro-wedge is controlled, such as remains constant.

17. The fracture machine of claim 15 wherein a first ring containing hydraulic fluid and a multitude of Vickers tips passing through holes sealed with O-rings around the circumference of the boule intitiate the cracks simultaneously, also called “parallel indentation”,
wherein said machine pushes a rod through a hole on top of said first ring to pressurize said hydraulic fluid, which in turn applies the pressure on plungers holding the Vickers tips,
wherein the boule is rotated around its axis to complete the cracks around the circumference,
wherein said Vickers tips and wedges are located such that at each point where a load is applied there is an equal load applied on the diametrically opposite point,
wherein the total load applied on the boule is the load provided by said machine multiplied by the number of Vickers in said first ring according to Pascale's law,
wherein a second ring containing hydraulic fluid and a multitude of micro-wedges is used to spread the cracks laterally and connect the cracks between adjacent indentations,
wherein the number and locations of the micro-wedges in said second ring is equal to the number and locations of Vickers in said first ring,
wherein said first ring containing the Vickers is removed and replaced with said second ring containing the micro-wedges after the indentations are completed,
wherein a third ring containing hydraulic fluid and a multitude of macro-wedges is placed in the middle plane of the boule and used to propagate the crack after removal of said second ring,
wherein the number of macro-wedges in said third ring is substantially smaller than the number of micro-wedges in said second ring,
wherein each macro-wedge covers several cracks,
wherein the edge of a macro-wedge is curved to follow the contour of the boule,
wherein said macro-wedges are located such that at each point where a load is applied there is an equal load applied on the diametrically opposite point.

18. The fracture machine of claim 17 wherein the number of Vickers in said first ring is at least 25 for an 8″ diameter SiC boule in order to achieve a throughput twice that of the multi-wire saw, thereby increasing the throughput by using more Vickers around the circumference.

19. The fracture machine of claim 17 wherein said suction cups hold the two split halves of the boule after separation and load them gently onto cassettes underneath, thereby reducing the risk of breakage and improving the yield,
wherein the sequential splitting of a boule in two halves can be handled using robotic operators.

20. The fracture machine of claim 17 wherein a process for wafering a SiC boule that combines cleaving with laser slicing as the last step.
